(19) United States
(12) Patent Application Publication
(10) Pub. No.: US 2005/0257045 A1
(43) Pub. Date: Nov. 17, 2005

(54) Secure messaging system

(76) Inventors: M. Benjamin Bushman, Fullerton, CA (US); Scott M. Volmar, Fullerton, CA (US); Richard A. Lee, Alpharetta, GA (US); Jean-Yves Gresser, Paris (FR); John R. Spain, Anniston, AL (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/104,290

(22) Filed: Apr. 12, 2005

Related U.S. Application Data
(60) Provisional application No. 60/561,557, filed on Apr. 12, 2004.

(51) Int. Cl. H04L 9/00

(52) U.S. Cl. 713/156

(57) ABSTRACT

A method for secure data transactions over a computer network is described. In one embodiment, the act of generating at the first party a document, which authorizes the data transaction to proceed is performed. In one embodiment, the document content is signed using a computer network with audit-level encryption digital certificates. In one embodiment, a signed digital message (and/or document) is sent from the first party to the network transfer system electronically, and can be authenticated via the ICN certificate authorities to demonstrate the authorities of the signer of the signed document in assent to the transaction. In one embodiment, a copy of the signed digital document can be stored in a database associated with the transfer network system. In one embodiment, the system uses rules (patterns) of exchange agreed upon within and between organizations. These rules enable the exchange to progress smoothly and drive systematically the attention of participants to demands and problems etc. as a given transaction goes along.

### REFERENCE TO RELATED APPLICATION

The present application claims priority benefit of U.S. Provisional Patent Application No. 60/561,557, filed Apr. 12, 2004, titled “SECURE ELECTRONIC PAYMENT SYSTEM” the disclosure of which is incorporated herein by reference in its entirety.

### FIELD OF THE INVENTION

The present invention relates to the management of security in a computer network messaging system.

### DESCRIPTION OF THE RELATED ART

Electronic messaging and document exchange provides the convenience of sending data between parties without the need to have some form of physical access. In non-electronic messaging, this physical access can be provided by having the parties meet in person.

In a non-computer environment, maintain security is relatively straightforward, as the transacting parties can verify identities, transfer of data, etc. through physical controls. In the computer network environment, such security is difficult because the parties are not in direct contact. Thus, exchanging data or documents over a computer network increases the possibility of fraud, theft of trade secrets, etc.

### SUMMARY

The present invention solves these and other problems by providing a method for secure data transactions over a computer network.

One embodiment includes generating a document, which authorizes the data transaction to proceed is performed. In one embodiment, the document content is signed using an InterComputer Network (ICN) audit-level encryption digital certificate.

In one embodiment, a signed digital message (and/or document) is sent from the first party to the network transfer system electronically, and can be authenticated via the ICN certificate authorities to demonstrate the authorities of the signer of the signed document in assent to the transaction.

In one embodiment, a copy of the signed digital document can be stored in a database associated with the transfer network system.

In one embodiment, the system uses rules (patterns) of exchange agreed upon within and between organizations. These rules enable the exchange to progress smoothly and drive systematically the attention of participants to demands and problems etc. as a given transaction goes along.

In one embodiment data are seen by all authorized parties. When and if required, assurance are given to validity of permissions/requests/orders from other and own parties, guaranteed and binding information regarding the progress of the transaction are distributed to all parties incl. proof of delivery, as well as multilateral notifications, alerts and reports. In one embodiment, every participant in a given transaction knows when progress is made and is thus in a position to anticipate any further action or problem to be solved.

### BRIEF DESCRIPTION OF THE DRAWINGS

The above-mentioned and other features will now be described with reference to the drawings of the present system.

FIG. 1 schematically illustrates an overview of the embodiment of a system providing secure electronic messaging.

FIG. 1a illustrates an alternative schematic representation of the components illustrated in FIG. 1.

FIG. 2 illustrates a schematic representation of the NTS client of FIG. 1.

FIG. 3 illustrates a schematic representation of the NTS of FIG. 1.

FIG. 4 is a schematic representation of the Gateway component illustrated in FIG. 3.

FIG. 5 is a schematic representation of the Message Server component illustrated in FIG. 3

FIG. 6 is a schematic representation of the Workflow Engine component illustrated in FIG. 3.

FIG. 7 is a schematic representation of the Validation Server component illustrated in FIG. 3.

FIG. 8 is a schematic representation of the Abuse Management Server component illustrated in FIG. 3.

FIG. 9 is a schematic representation of the Audit Server component illustrated in FIG. 3.

FIG. 10 is a schematic representation of the End to End Transaction Manager component illustrated in FIG. 3.

FIG. 11 is a schematic representation of the Status Server component illustrated in FIG. 5.

FIG. 12 is a schematic representation of the Message Receiving component illustrated in FIG. 5.

FIG. 13 is a schematic representation of the Message Sending component illustrated in FIG. 5.

FIG. 14 is a schematic representation of the Message Archiving component illustrated in FIG. 5.

FIG. 15 is a schematic representation of the Message Control Process component illustrated in FIG. 5.

FIG. 16 is a schematic representation of the Workflow APIs and Interchange component illustrated in FIG. 6.

FIG. 17 is a schematic representation of the Workflow Interfaces component illustrated in FIG. 6.

FIG. 18 is a schematic representation of the Identity Management Server component illustrated in FIG. 7.

FIG. 19 is a schematic representation of the Directory Services component illustrated in FIG. 7.

FIG. 20 is a schematic representation of the Public Key Infrastructure component illustrated in FIG. 7.

FIG. 21 is a schematic representation of the Violation Management component illustrated in FIG. 8.

FIG. 22 is a schematic representation of the Abuse Identification component illustrated in FIG. 8.

FIG. 23 is a schematic representation of the Alert Send/Receive component illustrated in FIG. 8.

FIG. 24 is a schematic representation of the Event Manager (Countermeasures) component illustrated in FIG. 8.

FIG. 25 is a schematic representation of the Audit Data Collection component illustrated in FIG. 9.

FIG. 26 is a schematic representation of the Audit Reports component illustrated in FIG. 9.

FIG. 27 is a schematic representation of the Transaction Channel control component illustrated in FIG. 10.

FIG. 28 is a schematic representation of the LDAP component illustrated in FIG. 19.

FIG. 29 is a schematic representation of the Digital Signature Server component illustrated in FIG. 20.

FIG. 30 is a schematic representation of the Directory Validation Services component illustrated in FIG. 20.

FIG. 31 is a schematic representation of the Comparator component illustrated in FIG. 26.

FIG. 32 is a schematic representation of the Filtering component illustrated in FIG. 26.

FIG. 33 is a schematic representation of the Transaction Pattern Adherence Monitoring component illustrated in FIG. 10.

FIG. 34 is a schematic representation of the Transaction Script Manager component illustrated in FIG. 10.

FIG. 35 is a schematic representation of the Comparator component illustrated in FIG. 22.

FIG. 36 illustrates a schematic display of the status of a transaction in the process of Flowcharts 1 and 3.

FIG. 37 illustrates a schematic display of the integration of instant messaging in the application screen of an NTS client workstation of FIG. 2.

FIG. 38 illustrates the delegation of authorities derived from hierarchical key and certificate management.

FIG. 39 is a high level process diagram for message creation and transmission.

FIG. 40 is a high level process diagram for message creation and transmission with approval.

FIG. 41, consisting of FIGS. 41a and 41b, is a high level process diagram for message reception.

FIG. 42, consisting of FIGS. 42a and 42b, is a high level process diagram for message reception with approval.

FIG. 43, consisting of FIGS. 43a, 43b and 43c, is a process diagram for message creation, authentication and transmission.

FIG. 44, consisting of FIGS. 44a and 44b, is a process diagram detailing the LOGON process part of FIG. 43.

FIG. 45 is a process diagram detailing the LOGIN process part of FIG. 43.

FIG. 46, consisting of FIGS. 46a and 46b, is a process diagram detailing the LOCAL AUDIT FILE PREPARATION and TRANSMISSION process part of FIG. 43.

FIG. 47, consisting of FIGS. 47a and 47b, is a process diagram detailing the start of the RECEIPT and PROCESSING OF WORKSTATION AUDIT FILE-process part of FIG. 43.

FIG. 48, consisting of FIGS. 48a and 48b, is a process diagram detailing the Actual Initiation of Business Transaction and Echo Back (Workflow Initiation ) in the RECEIPT and PROCESSING OF WORKSTATION AUDIT FILE process part of FIG. 43.

FIG. 49 is a process diagram detailing the Acknowledgement of the message in the RECEIPT and PROCESSING OF WORKSTATION AUDIT FILE process part of FIG. 43.

FIG. 50, consisting of FIGS. 50a, 50b and 50c, is a process diagram detailing the Decryption and Data Integrity Resolution, Identity Management and Identity Abuse Management in the Message Data Reception process part of FIG. 43.

FIG. 51, consisting of FIGS. 51a and 51b, is a process diagram detailing the Comparator process for either Audit or Abuse Management in the Message Data Reception process part of FIG. 43.

FIG. 52, consisting of FIGS. 52a and 52b, is a process diagram detailing the MESSAGE TRANSMITTED TO RECIPIENT and ACKNOWLEDGED WITH RECEIPT process part of FIG. 43.

FIG. 53, consisting of FIGS. 53a and 53b, is a process diagram detailing the Pattern Execution and Response process, as part of the Pattern Management process run by the Workflow engine of FIG. 6, the End to End Transaction Management of FIG. 10 and the Audit server of FIG. 9.

FIG. 54, consisting of FIGS. 54a, 54b, 54c and 54d is a process diagram detailing the Pattern Receipt and Response process, as part of the Pattern Management process run by the End-to-End-Transaction-Management of FIG. 10.

FIG. 55 is a process diagram of the Login, proof of presence process run by the End to End Transaction Management of FIG. 10

FIG. 56 shows the Certificate Hierarchy (chain as dashed lines).

FIG. 57 shows the Composite Logical Certificate.

FIG. 58 redraws the certificate hierarchy of FIG. 39 with both user and enterprise attributes.

FIG. 59 illustrates the CA Hierarchy and Business Relationships.

FIG. 60 illustrates the Core Certificate Authority Structure.

FIG. 61 shows the fields of the quality attribute.

FIG. 62 shows the Certificate Chain Composition.

### DETAILED DESCRIPTION

Overview

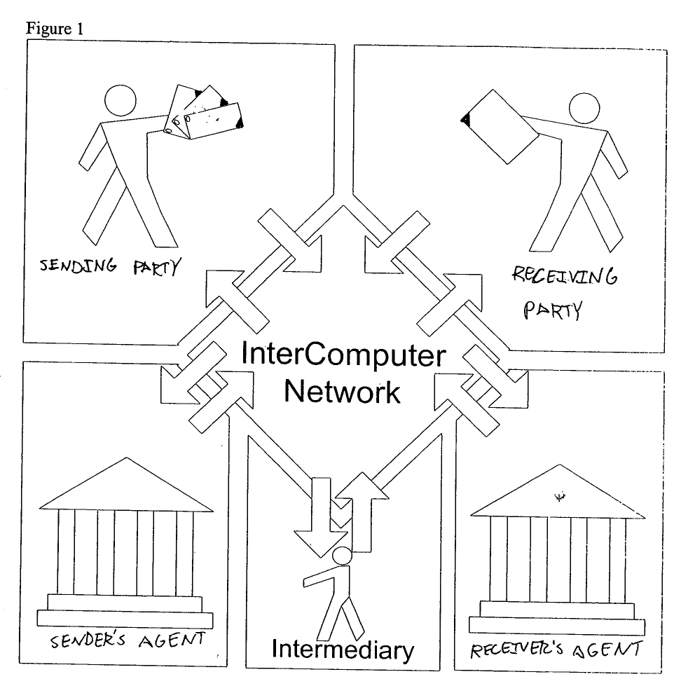

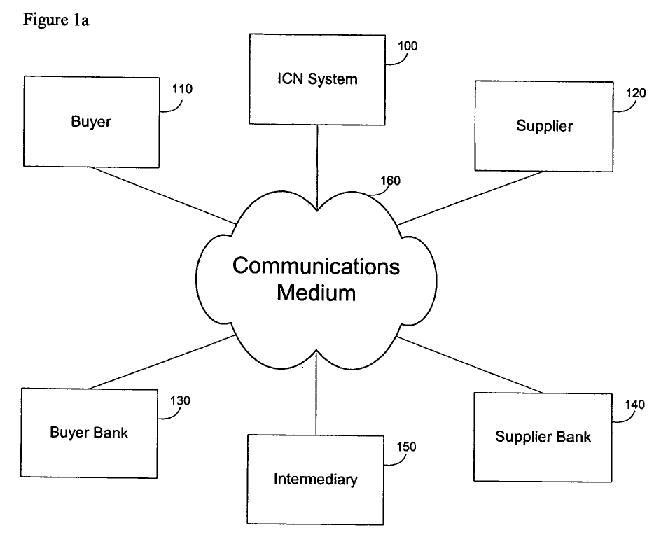

A Network Transfer System (NTS) 100 for providing communications between a sending party 110 and receiving party 120, their respective agents 130, 140 and intermediaries 150 is illustrated in FIG. 1. This transfer network system, also referred to interchangeably herein as an InterComputer Network (ICN), or Network Transfer System (NTS) is a system which is can be used to mediate and facilitate the secure verifiable transactions between parties.

As shown in FIG. 1, a sending party 110 can be a corporation or other entity that is going to be involved in sending data or documents to a receiving party 120. As the Figure shows, both the sending party and the receiving party can have a number of security functions, which are normally involved in a transaction between two parties. In small companies, these functions can be performed by the same individual within the organization. For instance, sending data (e.g., a trade secret, a purchase order, etc) and authorizing such action (e.g., corporate counsel, accounts payable functions) can both rest with the same person at a small organization. In a larger organization, it would not be uncommon for these functions to be handled by separate people, or even separate departments. Similarly, the functions of the receiving party can be handled by one or more individuals as appropriate to the size and structure of the receiving party.

In one embodiment, both the sending party 110 and the receiving party 120 are connected to the Network Transfer System 100 via a communications medium 125, represented by the arrows in FIG. 1. Most typically, this connection is by both the sending party and receiving party having an appropriate Network Transfer System client which is connected to the Internet. The NTS is also connected to the Internet. In this way, both the sending party and the seller can communicate with the Network Transfer System. The client system is described in greater detail below. In addition to the Internet, other possible communication media include without limitation: cellular phone networks, pager networks and telephone networks.

In addition to the Network Transfer System 100 being connected to the sending party 110 and the receiving party 120 via the communications medium 125, the Network Transfer System 100 is also in communication with the respective agents of both the sending party and the receiving party. The sending party agent 130, the receiving party agent 140 are illustrated as being separately connected to the Network Transfer System 100, however, it are understood that this connection can also be via the Internet. Although multiple connections are illustrated in FIG. 1, it are understood that a single communications network such as the Internet can provide communications between all of the illustrated elements of FIG. 1. A schematic representation illustrating the use of a central communications medium such as the Internet is shown in FIG. 1a.

Additionally, the Network Transfer System 100 can also be in communication with other entities that facilitate the transaction between the sending party 110 and the receiving party 120. One such example, as illustrated in FIG. 1, is that one or more intermediaries 150 can be in communication with the Network Transfer System 100. This allows the Network Transfer System to mediate and audit the communications between the parties to the transaction and the facilitating entities.

As are described in greater detail below, the Network Transfer System 100 is used in combination with the Network Transfer System client at the sending party 110 and receiving party 120 in order to provide an architecture that allows for the real-time processing of electronic transactions between the sending party and receiving party, including the real-time transfer of funds between the sending party agent 130 and receiving party agent 140 which is electronically inspectable and which can be guaranteed and insured.

The NTS provides VPN-like channels of communications, between parties over telecommunication networks, such as, for example, the Internet. In one embodiment, the system provides: audit, abuse detection, and countermeasures; and real-time end-to-end process visibility.

Abuse Management uses information to detect abuse or misuse of the system during the phases of initiating, transmitting, storing, processing and/or retiring of information. It identifies in real-time or near real-time the unauthorized creation, disclosure, theft, modification, or destruction of information. Abuse Management leverages both Identity Management and Integrity Management to determine if attempts have been or are being made by internal or external individual(s) to access materials or processes outside of their established role. In one embodiment, abuse management includes identification of abuse in real-time. In one embodiment, abuse management includes real-time or delayed countermeasures. In one embodiment, abuse management includes continuous auditing. In one embodiment, abuse management includes error messaging for transmission and display to appropriate users.

Digital Signatures provide, inter alia, secure representation of the originator of an electronic message. Digital Certificates provides unique representation of an identity. Digital Certificates refine limits of acceptable actions by authorized companies and their employees. Certificate checking allows for error messaging, alerting, reporting, or halting of the transaction. One or more Quality attributes allow the parties to use commercially available equipment. Key Protection allows for protection of machines and the operating system. In one embodiment, Digital Signature are also used to provide unique representation of the content of a message. In one embodiment, the use of Encryption provides protection for the data traveling and/or stored in the NTS 100.

In one embodiment, Audit controls are used to identify a party or process that may attempt a change to the data in a message. In one embodiment, Audit controls are used to compare input with output thereby identifying abuse attempts and preventing data loss. In one embodiment, Real time end-to-end process visibility is achieved via a transaction managing system supporting the real-time exchange of text message(s) and forms in a multi-lateral mode between participants.

Parties can interact using agreed preset rules, such as, for example:
Monitoring of obligations between the parties to deal with the messages according to an agreed (fast) schedule (pattern, script, scenario etc.) derived from the agreed “set of rules”;
Communicating and exchanging documents electronically in confidence and trust;
Providing status updates on transaction progress and message status to the parties;
Converting Message and data formats between processes and participants;
Controlling the channels established between transaction participants;
Monitoring of transaction patterns (scripts), the management of the pattern (script) description records, the consistency checks between “adjacent” processes, the management of insurance, which can also follow different patterns (scripts); and
Commanding and overlooking the channel lifecycle from creation of a first path between the initiator and the NTS, at the start of a transaction, to closure at the end or the termination of the transaction.

Overall Architecture of a Network Transfer System

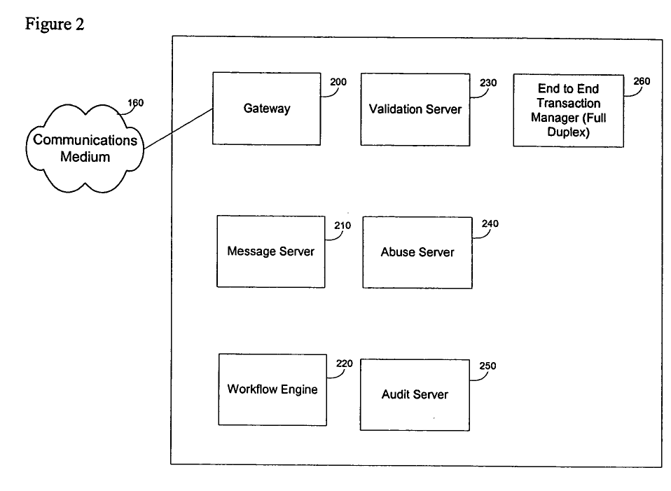

Various functional components of the Network Transfer System 100 will now be described with reference to FIG. 2. These components are illustrated as separate functional blocks within the Network Transfer System 100. However, it will be understood by those of skill in the art that these individual functions can be implemented in a variety of ways within the Network Transfer System 100. For instance, these functions can be separate hardware devices, connected to one another by appropriate networking means, or can be software processes in communication with one another running on one or more pieces of general computing hardware. In general, any of the functions or modules identified within this disclosure can refer to any combination of software, firmware, or hardware used to perform the specified function or functions.

The modules described herein are preferably implemented as software modules, but can be represented partially or entirely in hardware or firmware. It is contemplated that the functions performed by these modules can also be embodied within either a greater or lesser number of modules than is described in the accompanying text. For instance, a single function can be carried out through the operation of multiple modules, or more than one function can be performed by the same module. The described modules can be implemented as hardware, software, firmware or any combination thereof. Additionally, the described modules can reside at different locations connected through a wired or wireless network, or even distributed across the Internet.

As shown in FIG. 2, the Network Transfer System (NTS) 100 is connected to the communications medium 125. The Network Transfer System 100 includes a Gateway 200 configured to store and forward messages between one or more remote clients; a Validation Server 230 configured to authenticate users that are sending information using the Network Transfer System; a Workflow Engine 220 configured to script activity and provide exchange of internal messages between components of the NTS 100, and an End-to-End Transaction Manager (EETM) 260 configured to manage secure message routing between users of the Network Transaction System. In one embodiment, the Network Transfer System 100 also includes an Abuse Server 240 configured to detect abuse of the NTS 100, a Message Server 210 configured to provide instant messaging authorized participants through the Network Transfer System according to a level of authority for each participant, and/or an Audit Server 250 configured to audit data transactions between users.

Transactions through the NTS 100 only need to wait for the approval by appropriate individuals at the client site with the appropriate authority, the transaction can proceed as fast as the available communications and authentication systems are able to handle the necessary processing.

In one embodiment, the electronic transactions are related to purchase transactions, where the sending party sends a purchase order to the receiving party. In such case, the sending party agent would typically be the sending party's bank, and the receiving party's agent would typically be the receiving party's bank.

Network Transfer System Client

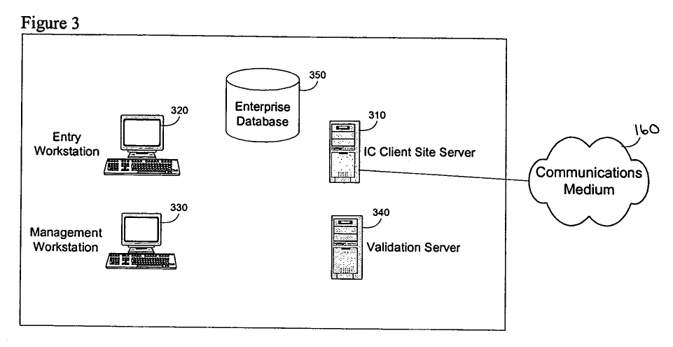

In order to carry out transactions with the Network Transfer System 100, appropriate Network Transfer System clients (e.g., computer platforms and/or client workstations) are made available to the sending party 110 and receiving party 120. These Network Transfer System computer platforms and client computer workstations will provide the appropriate hardware and software for a commercial user to transact through the Network Transfer System 100. An exemplary Network Transfer System 300 is illustrated in FIG. 3.

The illustrated Network Transfer System client of FIG. 3 is representative of the system that would reside at a sending party 110 or receiving party 120. A similar client system would also be used for an intermediary, a financial institution or agent, such as the sending party agent 130 or receiving party agent 140. Although there are several components illustrated, as with the Network Transfer System 100 described above, it should be understood that these functional modules can be separate physical pieces of hardware, or can be implemented as software modules running on one or more systems.

A client site server 310 is illustrated as part of the Network Transfer System client 300. The client site server 310 sends, receives and processes the messages to and from the Network Transfer System 100. The appropriate processing logic required to evaluate and route information received from the Network Transfer System 100 is also contained within the client site server.

The Network Transfer System client 300 can also include one or more client workstations: The illustrated exemplary Network Transfer System client 300 includes an entry workstation (entry WS) 320 and a management workstation (management WS) 330. The workstations 320, 330 form the user interface through which people who are part of an electronic transaction take part. The workstations are used to initiate transactions, request proposals, respond to requests, approve or reject terms of a potential transaction, authorize payment, acknowledge receipt, and communicate with the other users in a transaction.

A Remote Validation Server (RVS) 340 is also part of the Network Transfer System client 300. This server is used to provide functions related to the authentication and identification of users initiating and opening and responding to messages for the Network Transfer System 100. This is a complementary purpose to the validation server 230 of the Network Transfer System 100 itself.

The RVS 340 can be composed of separate or combined components. It responds to System 100 WF Directives as well as pass it a RAS 3XX.

The RVS 340 is also an electronic gateway and controls the path through which a participant organization's representative (or services) can gain access to the Network Transfer system. Thus, the RVS 340 is a gateway to the ICN Host Gateway through which messages enter or leave.

One of ordinary skill in the art will recognize that the IC Client Server 310 can serve several organizations. Thus, the communications medium 160 can connect the entry workstation 320, the management workstation 330, and the enterprise database 350 to the IC Client Server 310. The IC Client Server 310 and the validations server 340 can communicate with the NTS through the communications medium 160, or directly with each other.

A participant organization's database can interact with the System 300 RAS 310 for updates and data uploads.

In one embodiment, the system provides liability-bearing and/or insurable or risk-managed traits (for business or personal use) that can be represented in digital attributes, as for example, in an X.509V3 non-critical or critical attributes representation for use in digital certificates. The attribute “traits” can be used for Identity Management, for a Constraint-on-electronic-processes, or for use in electronic business transaction methods.

This system links the responsible parties, a legal entity, like an organization to the legal obligations and responsibilities in providing employees with roles and responsibilities in their business activities and to the individuals and their identities as its employees or representatives. In one embodiment, a digital certificate can be measured for the strength (Rating) of the representations contained as part of an attribute subcomponent or the strength of a business processes engaged in as part of the attribute formation. An End-User and the user's Company's electronic systems can consume a digital certificate for subsequent examination of the attribute and to validate the creation process in such ways as described herein. The system provides independent and inspectable references to third-parties with liability-bearing capability. It allows liability allocation to the company for the representations made and linked to the individual representatives (employees), to the organizational responsibilities assigned, and to risk mitigation (e.g., evidential trustability, insurability, etc.) with policy, procedure and practice components in a self-referencing attribute creation process.

The system can link independent, commercial, financial, or government organizations to inspectable, discernable and reference-able identity traits in their digital electronic credentials. Organizations can rely on the electronic messages/requests/transactions or any of the various electronic communications which use the electronic credentials, like digital signatures (with or without accompanying digital certificates). The system allows an organization and its End-Users to implant one or several numerical measures with independent digital signatures to link the Identity of the organization, individual and attribute together. Specific combinations of signed attributes provide “trustability” referenced within the digital certificate attribute representations and as made by these digital certificate originator(s) and for their End-Users when making representation via digital credentials, like digital signatures.

In one embodiment, the system provides single or multiple references into a self-referencing attribute model, in that, it allows a number of independent reviewers or multiple independent reviewers to judge governance methods, technology policies, hardware configurations, network configurations, deployments and practices and make numerical assignments, which are digitally signed by the examiner or examiner organizations and included within the digitally signed attribute component, as used in the formation of a digital certificate or certificate extension.

The numerical Rating assignments can be in various forms as required by systems' participants, regulators and consumers, and/or as provided by standards as implemented by vendors. The assignments can be indicative of a scale of credibility or a metric of inspection, review, or evaluation. The numerical assignments can cite a level of independent computer systems evaluations, such as, for example, US DOD 8211.1 specification, or the US Government TCSEC or TNI. The assignment of inspectable metric correspondent to Identity and linked to traits can be specific to an implementation or alternative implementations or set configurations. Here, “reviewer” inspections or evaluations allows individual numerical assignment to Policies, Practices and Procedures of a Participant organization, as well as, assignment of computer specific evaluation metrics to process and sub-process components describe herein.

An End-User or certificate-consuming organization can make an analytical computation. Allocation of liability can be associated with social processes by written (and physically verifiable) policy constraints with inspectable statements of practice and verifiable procedures imposed upon the individuals making, creating and invoking organizational representations via digital activities, such as creating digital certificate attribute extensions and for using digital certificates. The linking associated with the social context and practice, can be combined with other “degree(s) of evaluation” assigned to the electronic components, the sub-components, operating upon commercial hardware of various configurations and platforms (processors and operating systems).

The Extension thus created can be inspected in order to establish the individual accountabilities or as such to allocate responsibility to the organizations as independently introduced to the digital certificate via the Extension.

In one embodiment, an “identifiable” electronic “Quality Attribute,” e.g., an Extension to a digital certificate with associated “degree(s) of trust” based upon the cumulative numerical measures assigned to Policy, Practice and Procedures and technology is used to implement digital certificate attribute extension creation and can include “site evaluation” metrics determined by an inspector reviewing the components and practices encompassed by the method and as practiced by an organization and individuals.

To form an attribute extension, some amount of Data—an Individual's or Company's data, the Identity provided by external references, sub-process components, such as digitally-signed code-segments, the Individual constraints, etc.—are made available to the computer and sub-system components for processing. Elements can include, for example, Identity Elements, Quality Elements, Constraint Elements, Integrity Elements, etc.

A Social Procedure allows for various numbers of individuals to bring Identity components, data, computer programs or computer components, along with other data, such as digital trust components (signing keys). Individuals can attest (and validate) in an appropriate social context, e.g., electronically via digital signatures or with paper documents to the method used in creation of the Extension (and the identity).

A Practice Statement, like a CPS (certificate practice statement) or CPPS (certificate provider practice statement), can be used as a basis for establishing what social procedure is needed.

The Electronic Processing used to create an Extension can be a computer program—a computer compiler or such as a code-segment—to compose the data components, introduce the Quality components and perform the independent digital signature of the digital hash of the combined (and completed) Extension attributes, as noted above to link identity with mitigation or allocation factors. Various digital hash signings can occur. In one embodiment, the computer program translates the Identity Data and other data and can introduce the Quality Data as provided by an external authority. The combined components—Data Entry from individuals present, External Authority Data, including if used individual Quality Attributes as attested to by the presence of an electronically signed create an attribute extension. The data, a computer entry, can be performed by one or more individuals or even by the computer machine. The entry is formed into electronic bits. The electronic bits become part of the Extension and the Extension receives additional bits in the form of electronic signatures. Some signature can exist with the bits represented, yet link the identity attestation—the identity of the examined Organization or Identity—with the quality and numerical attested to by the examining entity.

The electronic process for creating the Extension can be independent of the digital certificate creation process. In one embodiment, the system uses “data entry” identifiable to the individuals making entry, e.g. independent from the formation of the digital certificate.

One embodiment provides for creation of the Quality Attribute Extension in many form or types of digital attribute. The sub-system components within the Attribute Extension (a format) can be inspected and evaluated to some machine discernable degree of non-repudiation for each attestation to the attribute (elements) placed in the Extension, similar to the X.509v3 (or TLS) extension to the digital certificate.

The system provides for the creation of a liability-bearing (e.g., “insurable”) digital certificate. Traceability to individual actions performed upon the hardware, via audit and electronic “Proofs-of-Presence” aid in the establishment of responsibility and can attest to allow legal liability allocation back to the individual's and organizations, and even to the individuals making representation via digital signature using the private key pair represented by the certificate. This method allows creation (and inclusion) of the quality attribute in the digital certificate.

For example, the X.509 type of digital certificate standard allows for any of several “extensions,” which can be added to the body of the digital certificate, prior to “certificate signing.” These “additions” become a intrinsic part of the complete digital certificate—separable and inspectable, yet are required to validate the integrity of the complete certificate and complete with integrity components of its own for separate inspection and validation. The system herein allows an independent reviewer, like an insurance reviewer, to establish a metric for consumers of the digital certificate to use in establishing their own parameters for acceptance of the digital certificate based-upon observable “degree of trust” within the Extension.

In Version 3 of the X.509 Standard (X.509v3) these extensions follow a specific format and this format carries within it a label marked “critical” or “non-critical.” Whether marked Critical or Non-Critical the Quality Attribute can be formed using the process described later on

A specific version of the X.509v3 extension was addressed by the Black Forest Group for use in business-to-business (b2b) Identification (Identification-Authentication) over an “Open” Internet is shown in Appendix A. The system herein can use standard or even proprietary extensions which in combination and in concert allow independent inspections of the data incorporation.

The Quality Attribute is a digital extension—critical or Non-Critical extension. In practice, an X.509v3 Extension is a Binary Object—a string of digital bits, like the electronic 0s (zeroes) and 1s (ones) that the computer operate upon.

In one embodiment, the system makes use of various physical components, such as physical security, which can have a physical audit or receive a review and in some manner receive some numerical status correspondent with a knowable scale of capacity, integrity or security, whatever the evaluative scale correspondent to the trait having been inspected or reviewed. Other traits or data components, even ordered or partially-ordered integers, of review or receiving some observable level of liability bearing capacity, like insurance.

In one embodiment components include:
A physical site with inspectable physical security
A Computer Platform configuration of evaluated or reviewed status.
A software program of evaluated or reviewed status
An external or internal digital signature private key for Extension Hash Sign
A Policy and Practice with reviewed status
Gradable physical security
Gradable Procedural components;
Quality Attributes rated and signed by an Independent Reviewer for introduction to Extension
Inclusion of an attribute or attributes of the physical, computer, software, and private key
Attestation by individual representatives of the Participant's Role Binding organization.
Attestation by individual representatives of the Participant's Security Organization

In one embodiment the physical hardware components are stored and maintained against some security policy reviewable by inspection. A reviewer can provide a numerical assignment or influence the numerical assignment of a Quality Attribute element said to pertain to the Policy and for procedure and for practice, as carried out in the organization.

The components used in the formation of the Extension can be reviewed and rated by the Review. The Reviewer(‘s’) accreditation can be made part of the Extension Quality Attribute(s). A numerical analysis can occur as an accumulation of metrics as discerned from the quality and numerical judgments digitally linked to an Identity by several “Reviewers” or via externally derived evaluation and attestation, as linked to the digital signatures.

The risk mitigation or liability allocation can be derived from the use of one or more private digital signing keys from reviewers or risk mitigating organizations (e.g., insurers, etc.). The private key digitally signs a hash of the attested level of a reviewed quality. Digital Certificate issuance, although common practice, is secondary to the independent levels of attestation in representation. The Private Key Protection and the Binary Attribute Generation via examination of the platform security, the physical and electronic security on the actual system are attested to in Attribute elements of an Extension or certificate of attributes.

Also, include within the Extension Quality Attributes is the quality of the Public/Private Key Generation and protection of the Signing private key for the Certificate Authority, as derived by inspection, review, evaluation, or suitable examinations.

Transaction Processing

Having described the components of the architecture making use of the Transfer Network System 100, the securitization of the various transactions that can be carried out within an e-commerce architecture will now be discussed.

In the present system the Network Transfer System provides assurances of the authenticity of the authorization to make the transfer between the participants, according to the applications and processes defined and allowed.

In the systems making use of the Network Transfer System 100 to mediate financial and other business transactions, the Network Transfer System 100 handles messages between the various entities described above. For instance, the Network Transfer System 100 can handle messages traveling between an agent and its customer (e.g., between the sending party agent 130 and the sending party 110). The Network Transfer System can also handle an Application Message passing between two agents (such as, for example, the sending party agent 130 sending funds to the receiving party agent 140 in the case of a purchase transaction where the agents are the parties respective banks). The Network Transfer System can also be used to in the general case to handle messages traveling between the two business parties to the transaction, e.g., the sending party 110 and the receiving party 120. Or, to handle (Instant) messages between two or more participants, as in a semi- or private conversation between participants concerning an Application Message or transaction datum. Additionally, the Network Transfer System 100 can handle traffic between one or more of the parties and a third party that is part of facilitating the transaction, e.g., the intermediary 150 identified in FIG. 1.

In effect, the Network Transfer System 100 acts as a secure and trusted conduit for the Application Instructions (Messages), information updates, instant messages between participants concerning a Application Message (or transaction) and the needed meta data associated with a transaction. The only requirement is that the parties 110, 120 and the agents 130, 140, 150 are all equipped with appropriate client systems 300 capable of properly interacting with the Network Transfer System 100, as described above.

Components Architecture (The Network Transfer System Structure)

Having described the structural architecture of the systems and components providing secure transaction with finality, the various functional aspects of the architecture will now be described. In the description that follows, the term “component” broadly includes any process or result that can be achieved through the use of the described systems and methods.

Security functions include the protections—hardware, operating systems, software—provided and enabled by the security architecture to address the issues related to the trust and security. Measures of the applicable security functions resident at each machine or in each configuration can be placed, “tagged,” to the information flowing through the Network Transfer System 100. In particular, security functions are used to prevent Messages (i.e. exchanges) that are not properly authorized by the companies who are represented or from an improperly formed Message (electronically inaccurate formation or authentication) or from un-identifiable individuals or from individuals without proper authorizations. These security functions will automatically “FAIL,” as in to-pause or hold-up, until authorizations can be determined (or allowed). Inadequate authorizations can even stop a transaction or prevent other business exchanges between specific participants, especially if the above conditions are not met. One such example is a failure to deliver a message across the communications medium 125. This is a reliability component handled by the VS 340 and the ICN 100 systems, like a TCP ACK, it is integrity checking the send at the systems level consequently not a “security” function]

In general, the components provided within a particular embodiment of a system for securitizing the transactions are described. These components can vary in implementation for different embodiments.

There are distinct components by which the RVS (and HVS) provides services. First, a message reception or transmission service called the Gateway. A second component of the VS provides the message credential, inclusions when sending and derives the message credential information from digital signatures via Directory services for messages arriving. A third component of the VS provides connection with the Workflow Engine, which also ensures connection with the EETM 1.

Gateway—200

The Gateway is the actual interface of the NTS to the outside world. It stores and forwards messages between the remote clients or servers and the NTS, in a controlled mode which enables the establishment (see Logon and Login), operation and closure of a “secure pipeline” between all participants to a given transaction in cooperation with the others components, mainly the message server, the validation server and the workflow engine.

The Gateway component is part of the VS component or separate with direct connection, only to the VS, 2.

Message Server—210

The message generation and distribution (Message Server 210) is directed by WF Engine 260 to provides a user of a Network Transfer System client 300 to generate an instant message (canned) or to distribute status update messages or report messages to authorized participants through the Network Transfer System 100. Executing instant messages requires that the user have the appropriate level of authority.

Status Server—500

The Status Server 500 contains the text for Status Update messages and can contain updates for various message types as well as message coordination, Canned Messages and message variants for message content management according to the needs of various participants of a Message exchange.

Status Information—1100

Status Information are the tables of text content and format for corresponding to a particular number status received from the WF Engine 260. It allows the Messaging Server to generate formatted-text or graphics for sending Status Updates.

Status Message—1110

The Status Message or Status Update Message can be a text or graphic for corresponding to a particular error message and status level as received from the WF Engine 260. Status Messages can be End-User oriented or ICN Systems Administrator oriented, as indicated by the nature of the message. End-User Participants of the ICN systems can also received Systems Level Message, perhaps different from ICN Administrators, as needed for Status Updates, which may include Systems delays or other Systems types of messages.

File—1120

Multiple levels of File system messages are possible and distribute-able to the various participants. However, a majority of File system messages can be directed to the Archival and Storage activities of the system and directed primarily to the initiating participants. The various ICN Participants can receive different file activity messages as part of the actions indicated by the Workflow and EETM Engines and as according to the Patterns and records activity indicated for execution or from responses to command execution.

Distribute—1130

Distribute 1130 contains variations on message content for a particular participant in a Message exchange or for a particular Status Update.

Message Receiving—510

Message Reception and Decomposition.—1200

Message reception is a function of the Message Server as the Validation Server 230 is directed by the WF Engine (or similar) to accomplish initial and all subsequent Message capture—the process of separating data-fields from the Message body and for holding

Message Content Distribution—1210

As directed by the WF Engine—Message content from Message decomposition introduced into forms via 1200 can be distributed according to the participants Need to Know.

Message Format—1220

Like 1110 content data can be reformatted to pre-defined terms contained in this table.

Message Sending—520

Message content collection is done above in 1210

Message Content Format—1300

Various Outgoing message are in formats other than the format in which they were received. This is a correspondence table by Participant for reformatting and re-organizing data (other than Status Updates)

Message Composition and Transmission—1310

This is the form content for composing data from the 1300 systems table of forms

Message Saving (Temp. Archiving)—530

The Message Saving subsystem holds the content of a Message and various messages within Message steps and iterations.

File System—1400

The Message Saving File System is a TTS system per iteration; these are eliminated when a transaction is finished.

Message Control Process—540

Authenticity—1500

Authenticity of a message is determined cryptographically during the VS decipher. However, secondary message determinations can be carried out on message content at by request of the WF Engine 260.

Feasibility—1510

Message Feasibility determinations within the Messaging Server can be executed against known information stored for any transaction.

Stop—1520

A STOP Error MSG can be returned, or no Response can be determined by the WF Engine.

Workflow Engine—220

The main function of the workflow engine is to script the activity and provide exchange of the internal messages between NTS components; in coordination with the EETM 260 this triggers the activation of these components according to pre-established generic or specific rules or scenarios. The following description follows the standard rules of the Workflow Management Coalition (WFMC).

Workflow API and Interchange—600

Filter—1600

Workflow Filters of Data Content Pattern Analyses and Data Content Workflow Response Recognition can be viewed in part as separate from Workflow Engine Pattern Analysis and Patterns and Response Recognition 1610, although variables of the data content can cause the Workflow Engine (or the EETM) to alter the workflow to accommodate variables in the content.

Patterns and Response Recognition—1610

Workflow Engine Pattern Analysis and Workflow Response Recognition can be viewed as separable workflow components, although they need not be, nor must they be termed workflow when they are view separately. As separated, the architecture of the engines from Response Recognition(s) and Pattern Analysis systems represent a hybrid engine. This hybrid provides traditional workflow features and at the same time activity like a database transaction tracking system (assured transactions). Recognition of this hybrid model, as separate activities, on separate workflow engine systems, cards (like blade servers) or in distributed servers—the Response Recognition, a comparative database process, waiting for the receptions and acknowledgement of a workflow command can be provided even though one of the ICN workflow engines has been removed (for any of various reasons). The remaining engine, also waiting for acknowledgement of receipt and acknowledgement of response, but also waiting for next acknowledgement (from the other workflow engine of the EETM) initiates a search for an alternative workflow engine and will re-instantiate the workflow up to the missed acknowledgement for further completions, based upon the missing acknowledgement

Reflection—1620

A reflection component is added to the scripting such that internal commands issued to subcomponents by the Workflow Engine are reflected to the EETM. As a subcomponent of the ICN system, the EETM is responsible for comparisons of responses, as noted above in 1610, to the workflow engine commands. The EETM has a database reference of Expected Responses by other subcomponent systems to the Workflow Engine Commands. The EETM also contains the alternative branching analysis processes need to re-direct WF Pattern Execution to new patters.

A message reflection scripting allows message components to be “echoed” at the time of messaging to other participants

Echo—1630

An Echo component is added to the scripting which captures the normal electronic acknowledgements and mandates all internal messaging Responses are sent to the EETM 260.

Tasking—1640

Tasking is a pattern script stored as a table by Customer. Since it is object oriented the super-procedure is usable where a participant-level procedure is not available. And the super-procedure can become the “new” participant-level procedure for the “next” transaction message.

Interfaces—610

Process definition—1700

Application processes of the ICN vary and are created and tested via a process definition language and testing component. This component can be used to exercise the ICN 100 system for transaction reliability and continuity checking as well as to develop Pattern alternative scripts.

Administration and Monitoring Tools—1710

The various tasks of administration and monitoring are available to ICN system-level operations.

Tools to exercise the EETM via with WF engine can be included here.

WF Client Application—1720

A workflow client development tool and client application are used by the system to create patterns and scripts

Other WF Engines—1730

Various tools to exercise the EETM via with WF engine can be used, such as, for example, a pattern development tool for systems engine testing, a scalability testing tool for systems and load testing. Other administrative tools, like a Systems Console, optionally with configuration elements, like a Global Network Operating System or GNOC (console) can also be used.

WF Client Application—1720

A workflow client development tool and client application are used by the system to create patterns and scripts

Other WF Engines—1730

The WF engines 1730 provide the ability to use other workflow engines and other platforms in the operation of the ICN 100 System(s). In one embodiment, the ICN Systems is a platform that can operate using proprietary or thir-party Workflow Engines. The configuration of a workflow engine juxtaposed to the EETM Pattern Recognition (and analysis) Engine, to enable a duplicated-level of “system responders,” i.e. Workflow Pattern Executives, enables a unique processing ability, unlike commercially available workflow engines that can be used within an ICN system.

Validation Server—230

The Validation Server in the ICN Host (and remote site operations) provides an ability to measure various security parameters used in other subcomponents, like the client-workstation and (validation server base) of the remote systems.

Identity Management Server—700

The Validation Server (currently DVS 230) is part of the IDM.

Another component that is provided is that of identity management 700. Identity management refers to the process of managing and maintaining multiple database references of profiles of individuals and how they are authorized to use the functions available through the Network Transfer System 100 and Network Transfer System clients 300. This component also includes authentication, as well as the Directory Service components 710. Through the appropriate use of Identity Management (IDM) processes, alerts can be triggered 730 and sent to Abuse Management server 240 and Audit server 250 where appropriate responses can take place.

Participant Identification-Authentication is the initial electronic process at the Network Transfer System client-workstation for corroborating an identity. Any individual representative of an organization can initiate using the Network Transfer System client applications, as an End-User. However, to successfully initiate without FAILURE, the individual User must have a valid electronic identity, an electronic credential (see 114 PKI)—applied for as the valid representative of the participant organization and only accessed via the system 300 Validation Server 340. The credential need only exist in the NTS Client system, and are discussed below, in detail.

Login

A User is provided with their identity name (Identification) for use in initiating access to the Network Transfer System client system. Also, they will need their “secret,” the Authentication secret (see Identification-Authentication), which will allow use of a protected electronic Secret, only used for their Digital Signature.

Proper Identification-Authentication, avails the End-User access to the applications, they are specifically allowed to use for Messaging on the system. Applications running on behalf of this Enterprise Representative (End-User) can request the Validation Server component 340 of the Network Transfer System client to Digitally Sign Messages on their behalf.

A Login from an individual at a workstation to a server is required for use of the system, except administrative activities of the Servers.

A network Login is used to gain a session level exchange (e.g., using an ISO Seven Layer model, session). The Login used by the ICN system, can optionally require additional connectivity and exchange of temporal secrets for the authentication and Proof-of-Presence. In the case of an additional Login sequence beyond the network Login sequence to the RVS, the Flowchart # 7 would change to accommodate the additional secrets transferred from the ICN Host Validation Server Login subcomponent to the Remote workstation via the Remote Validation Server.

From this exchange, a temporal password Proof-of-Presence exchange can be developed.

User Identity Certificates

If User Identity Certificate private keys are stored in the Verification Server, then an argument can be made that the owner of the private key had no knowledge of something signed with his private key. Storing the private key with PBE can help but if no trusted workstation is available, then the password (or a derived secret) would be sent to the server to decrypt the private key to be used to sign a document. The private key could then be used to sign other documents not authorized by the owner of the private key. An evaluation of the behaviors of the server could weaken that argument but not completely eliminate it (for example, the system may be administrated by someone not acting in the best interest of the owner of the private key).

One solution is to provide a mechanism/workstation that is administrated by someone with the best interests of the owner of the private key—him/her self—like a smart card. A smart card can sign documents with a private key without exposing the key.

But if the keys are stored on the Verification server, a second secret known to the owner of the key and the ICN Host can be used to validate a request signed by the user's private key within the Verification Server. The problem is in establishing this secret such that only the proper person receives the secret—authentication of the key owner. In one embodiment, this is done through an out-of-band channel, such as, for example, the telephone, a courier, the US Post office, etc. Using the post office as an example, the secret is sent via Registered Mail in a tamper Evident and shielded Envelope. The secret is a one-time use only secret that is used to establish an authenticated connection to the ICN host which is then used to exchange the password.

After a request is signed by the Verification server, the request is sent to the owner of the key to review. The signature (and a nonce) is then encrypted with the password and added to the request.

When the ICN Host receives the request, a check is made to see if the encrypted signature is needed (this was recorded when the password was exchanged). If so, the encrypted signature is decrypted and verified.

It now takes a breech of both the Verification Server (it knows the private key) and either of following to create a proper request without the knowledge of the private key owner:
The key owners workstation (it knows the second password); or
The ICN Host (It knows the second password).
   Re-issuance

Two alternative methods for Cascade Re-issuance of Identity Certificates can be described using: 1) the Quality Attribute Set(s) and 2) high-assurance (TCSEC or EAL 7+) computer platforms.

One embodiment provides the ability to cascade revoke the digital certificates with X.509v3 non-critical or critical extension or for a digital certificate. However, for those digital certificates that have been created using the various risk mitigation and liability allocation techniques noted herein—there are two methods for digital certificate re-issuance and both of these methods allow for cascade re-issuance of digital certificates with the commensurate creation of new key pairs.

Specific traits which are combined and attached to a digital certificate to identify the owner, and/or the issuer, and/or the constraints, etc. can be consumed and deemed reliable when analyzed in an environment with equivalent protections.

The traits can be represented as Attribute Extensions, like the X.509v3 digital certificate extensions or other digital certificate extensions that include a quality attribute and independent quality assignments or signers.

Other than the cryptographic key sets, it is not immediately apparent that the entire digital certificate can be created from the digital certificate extensions, where by use of the Quality Attribute Extensions equivalent and independently derived information can be introduced to form reference “sets” with independent signers, especially where the digital certificates of the signers do attest to the protections afforded their own key creation and protections and certificate protections.

In one embodiment, on a high-assurance machine of TCSEC B3+ or EAL 7 equivalent, reconstitution of the certificate can be accomplished by:
re-generating new key pairs for asymmetric key pair or other type of certificates via a standards based method, including the evaluated status of the generation component;
systematic decomposition of the attribute subcomponents to derive OID and Distinguished Name components of the (to be) certificate owner;
re-constitution of the digital certificate data set, including the original attribute extension, and to include the re-generation characteristics of the platform, operating system, key generation algorithm and evaluation stats, as noted in other sections.
Re-issuance of the digital certificate to the End-User individual or system, with any subsequent signatures
Certificate Signing, as per the appropriate standard.
Directory Services (X.500) publication of the

In one embodiment, on a high assurance machine of TCSEC B3+ or EAL 7 equivalent equipped with a Secret Store of evaluated or rated status, reconstitution can be accomplished by:
Pre-Certificate creation of cryptographic keys (en mass) to support cascade certificate generation
Directory Services Read of digital certificates, for those with Quality Attribute Extensions
Attribute decomposition, as noted in other parts of this patent to derive the Certificate Data Set from components of the Attribute and from any requisite data collection, as needed, like a Trusted Data Base as per the TCSEC or DOD 5200.28 or Equivalent of EAL 6+.
Certificate Re-Constitution according to traits and qualities as modified the previous method above.
Certificate Re-signing
Publication of Public Key to the Directory Service

For the secret key, several standards based methods are provided to enable secret key distribution, however, private key distributions are performed between the high-assurance system and the End-User individual in such a was as to protect their secret from exposure at any hardware level lower than the qualities assigned to their certificate.

Proof of Presence

To prove that the same person is still present at the machine where they initially authenticated when a message/request/transaction is signed, the system is implemented in such a way as to verify the continued presence of that individual. An additional, yet temporal, Login authentication can be used to add to credibility and to link the individual to system events such as digital signing and the like. However, the practice of re-authenticating via the Login-sequence (ID and password) does not overcome the problem of another individual who has obtained the authentication credentials of the authorized person. Once an authentication secret is lost, stolen, observed or subverted in some manner, it cannot be used again credibly.

It is desirable to verify that the same individual person who is now working at the keyboard and screen of the workstation is the person who initially Logged-in (Login). Since Login and operation are possible over a wide-range of circumstances with various physical security controls, like un-monitored Operations Centers, with or without security cameras, there are various ways to obtain individual substitutions, which can be attributed to a rated-level of authentication.

In one embodiment, at the ICN remote site, the person—an individual user—authenticates to the system as usual when initiating and receive a secondary short-term secret, such as, for example, a password. This short-term password is good for a brief period of time to ensure that the person receiving the password was the same person who was present at Login. The temporal nature of the secondary secret can be linked to the timing of the current operation, e.g., the session, a fixed time-period or to the specific application, page, form, etc.

In this implementation, the operating system gets the password from the user and not from a stored copy. A zero-knowledge algorithm can be implemented to validate the password authenticity without compromising the password itself.

In an alternative embodiment, the user has a cryptographic token or other Secure Token-like component. In one embodiment, a challenge-response system is used, such as, for example, a smart-card. The token-system presents a challenge to the user, and the user responds by entering the challenge into the token-system token along with a password. The token generates a response that the user then enters into the system.

Additional various commercial means can be used to bring about a proof-of-presence authentication, such as, for example, physical security controls, biometric security devices, auditing controls, face-to-face verification, etc.

Logon

In addition to the End-User “Log-In” to the Network Transfer System Participant system, each Network Transfer System Participant's client-workstation sub-Systems is also connected and “Log(ged)-On to the Network Transfer System Participant's System 300, as initially connected and validated for operation. Network Transfer System Participants' Systems 300 periodically LOGON to the ICN System 100 Host Network. In addition, to the Identity Credential of each End-User individual using an Network Transfer System client, each of the Network Transfer System client machines also contains an Identity Credential.

Throughout the authentication and credential related processes described, analysis of the credentials is performed by appropriate processing on the validation servers 230, 340 of the Network Transfer System 100 and the Network Transfer System clients 300.

Extract System—1800

The Extract System relates the digital signature to the digital references in the digital credential—not a matching process, which is performed in the Authentication

Profile System—1810

The Profile system contains information about the Participant Registries. It has a Directory Services (DS) component, used to build trust by creating and comparing certificates from various stages and times during the phases of the transaction.

Identity messaging System—1820

Contain information related to the Participant's credentials

X500 Directory Service—710

LDAP—1900

Standards-based Local Directory Access Protocol gives access to directory descriptive data.

X500 Tree Services Directory—2800

Where Federated Directory Trees Exist, this allows communication across the whole hierarchy of directory data.

PKI—720

Another standard that plays a role in the security functions available when using the Network Transfer System 100 is the X.509 V3 standard. These are Identity authentication techniques and cryptographic systems which allow the Log-In process described to take advantage of Identity Management regimes. One example is the Public Key Infrastructure (PKI) component of Registry Authority (RA). The RA uses cryptography to bind the Distinguished Names of participants with electronically discernable markings for identity. One embodiment of a PKI hierarchy system is disclosed in Appendix A.

A PKI is a mechanism for electronically conveying authoritative representations by one party about another party. The representations within a PKI are hierarchical. With each representation there is an identification of a “Certificate Authority” (CA).

An application that consumes certificates recognizes Enterprise A because some CA, (“Authority X”) issued a certificate making the representation. And “Authority X” is recognized because some other CA issued it a certificate.

This hierarchy uses a starting point, which is called a “root CA”. The root CA issues itself a certificate, which is considered valid by virtue of its being physically present on the platform that consumes certificates.

While the simplest hierarchical structure is one where a single root authority makes all representations (i.e., the hierarchy has but two levels, the root and the end-user), this is not always a practical business solution because the one root CA would have to both make and be liable for representations about parties for whom the CA has no authoritative knowledge. The PKI should reflect the distributed nature of the business processes. A more practical hierarchy is one where an enterprise makes (and is liable for) representations about its own members (e.g., employees).

At the next level of the hierarchy, a responsible trade group (known as a “registry”) can be best qualified to make representations about the enterprises within a given business sector. Such a hierarchy utilizes “wholesale certificates” issued by the registry to the enterprises. The enterprises then use the wholesale certificates to issue subordinate certificates to their employees (e.g., via the HR department). Each intermediate party is liable only for protecting its secret keys and for the representations that it makes.

The consumer of certificates needs a way of determining what a given certificate is good for. More precisely, the certificate consumer should be able to establish automated constraints on which certificates are acceptable for which business processes.

One approach is to explicitly reflect the quality of each certificate within the certificate itself, enabling a local validation of the suitability of the certificate for a specific business process.

Further, if the meaning of such a machine-readable “quality attribute” is cumulative over the entire chain of certificates (from the root to the end-user certificate), then the issuer of a certificate can place constraints on the representations that can be made within subordinate certificates.

From a user or administrative standpoint, this enables certificate consumers to consider the certificate chain as a single “composite certificate”, by which we mean a single manageable certificate representation that preserves the liability allocated to the issuers of each certificate within the chain.

Inclusion of an explicit quality attribute in each certificate makes it possible for administrators to define “validation profiles” for users and Internet components (e.g., a VPN gateway) that consume certificates.

These profiles constrain which certificates are acceptable for a particular business purpose in terms of the certificate attributes.

An illustrative certificate hierarchy is shown in FIG. 1 of Appendix A. FIG. 3 of Appendix A redraws the certificate hierarchy of FIG. 1 of Appendix A, but with both user and enterprise attributes in each certificate within the chain.

The root CA is Liable for protecting its secret key and providing a unique identifier for each registry. The Root CA actually issues two certificates that are in each certificate chain: The Root CA is also liable for any representations made about the registry (e.g., that it is an authorized key-escrow registry).

In one embodiment, there is a different registry for each major collection of enterprises that have significant requirements to exchange goods and services. Registries can be defined based on a set of business relationships where top-tier enterprises purchase goods and services from a common set of lower-tier enterprises.

Additionally, the registry is responsible for ensuring that enterprises are provided with unique (within the registry) identifiers. The registry is also responsible for any representations made about the enterprise. Finally, the registry is responsible for protecting its private key.

Each enterprise is liable for representations made within certificates issued to each of their end-users, and for the protection of the enterprise's private keys. This includes liability for their representation of the identity of the user in the certificate.

Each user is accountable for their use of the certificate (or more precisely, their use of the associated private key). The user has only an end-entity certificate, i.e., not a CA certificate. There is, of course, no notion of liability for representations made, since the user does not issue certificates.

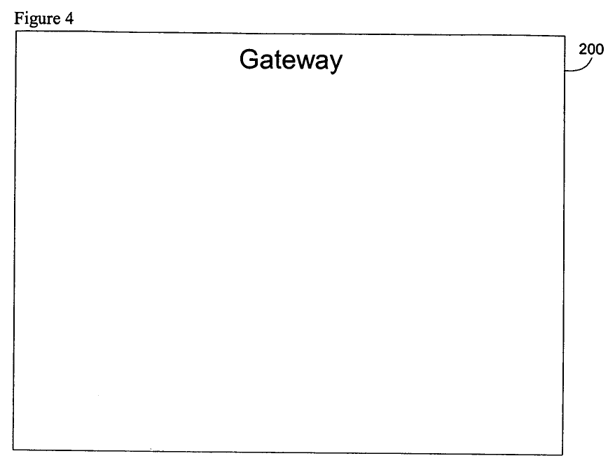

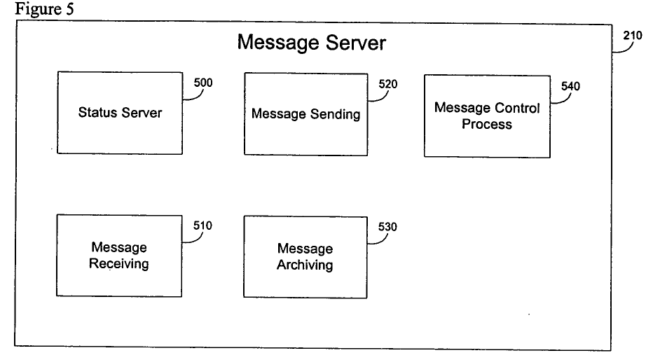

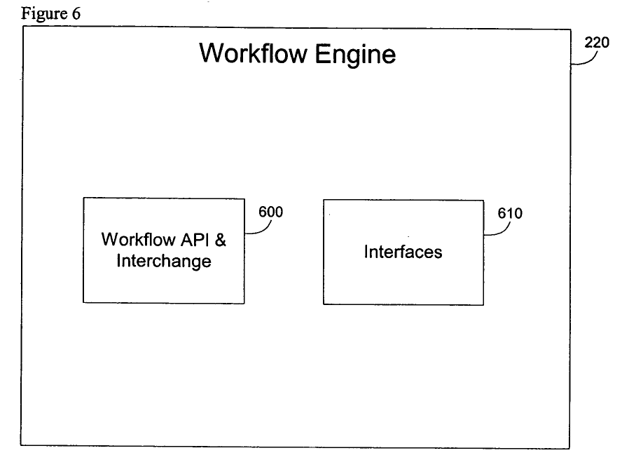

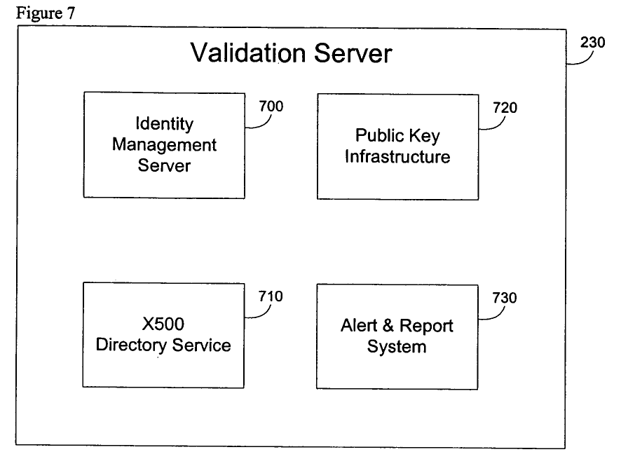

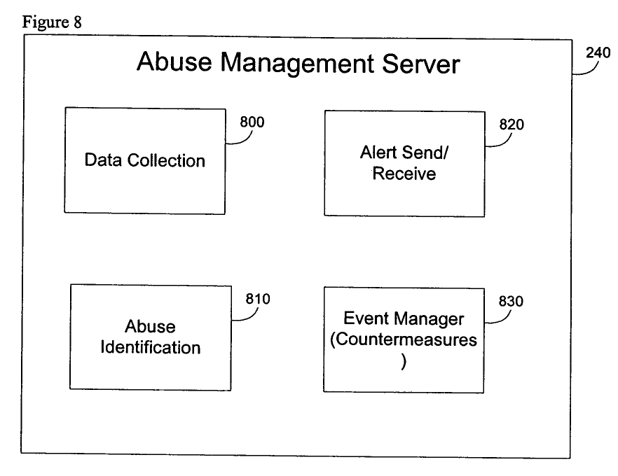

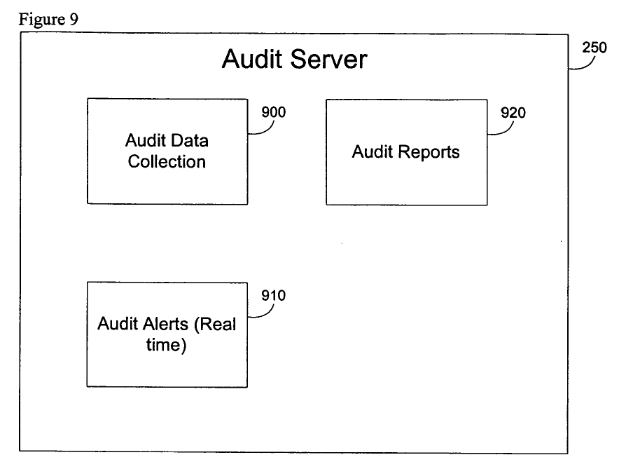

FIG. 4 of Appendix A illustrates the hierarchy of CA's Some information is more sensitive than other information. This is usually reflected by an indication of a hierarchical level with a resulting ordering. The combination of hierarchical levels and non-hierarchical categories is referred to as a “security level” (though strictly speaking, they are not always levels, e.g., two levels can be non-comparable).

Digital Signature Server—2000

Various digital signature standards can be used by the ICN and Participant system

Modular Cryptography—2900

Various Cryptographic Modules are located at the Participant Systems VS 340 to meet internal system needs.

Directory Validation S—210

The DVS is the Validation Server for Directory Certificates, it is used to validate the digital signature and thus authenticate the cryptography, i.e. the message was mathematically correct as sent from the holder of the “secret key”.

X500 Interface—3000

Standards Based x500 Access

To obtain a desired high level of visibility, clarity and verifiability for use with the NTS network, the combination of X.509 digital certificates with the V3 (version 3) Black Forest Group Quality Attribute extensions allow a participant organization to advertise their employees' electronic credentials via X.500 Directory Services, using LDAP. Directory Services, like the X.500 Standard, allow other participants and the ICN System 100 to access each credential in order to validate any Digital Signature. Network Transfer System clients and ICN Systems can also use X.500 Directory Services via protocols, such as LDAP to retrieve credentials. Thus, Credentials provided by the receiving party 120 can be used by the sending party 110 and vice versa.

Alert and Report System—730

Error Messaging System—2100

Error messages from the validation server are sent to the workflow engine and in the case of no previous transaction WF engine archives the errant message for post-facto analysis. See abuse detection.

Error Profile System—2110

Error messages generated from the Validation Server can be at various levels indicating the various levels of authentication and correspondence. Correspondence is the cross-reference of attribute values to the established mean acquired via the REGISTRY.

One example of a type of security datum that can be inspected and extracted via the VS is the Organizational ID (OID) of a digital certificate. This is different than the Distinguished Name component of a typical digital certificate. It is a part of the Quality Attribute component, defined as part of the X.509v3 standard. While the BFG Quality attribute forms the primary basis for the system 100 and SEC client authentications, it is useful that any externally created attribute with functional depth equivalent to the Black Forest Group Quality Attribute, (i.e. quality attributes for platform strength, cryptographic strength, certificate strength) could provide data to the system 100 and Network Transfer System client IDM function.

The system 100 IDM function provides the basis for distributing the information obtained via Validation Server identifications, using the Black Forest Quality Attribute, resolving to the authorizations corresponding to the attributes found in the digital certificate received with a Message. Once resolved from computer digital to readily readable by the Network Transfer System Participant's, they can be distributed, as needed, to the participants.

The identifications can contain Message identities (credentials pertaining to the form of the message) in the form of Transaction Identities (TIDs) 1) as well as the other participants, generated as Alerts, Status Updates, as well as, to distribute the appropriate elements to any other system 100 subsystem requiring security data.

Abuse Management Server—240

Abuse management is a function that relies on a pre-established scheme of known and unknown exposures. When using the architecture and systems described herein, various types of abuse management functions can be made available. They include without limitation: protection and deterrent mechanisms, and the ability to trigger real-time or delayed countermeasures. Such features can make use of login metrics, initiation algorithms, data capture and communication checks, including checks based on the quality attributes of certificates used throughout the sessions. Such information can be used to generate appropriate error messages for transmission and display to an appropriate user. These abuse warning can also be recorded in the audit database of the Network Transfer System for later review and analysis.

Abuse Data Collection—800

As commanded by the WF Engine

Abuse Identification—810

Determination of abuse elements in IDM

Internal Certificate Checks—2200

WF commanded cross-checking of current and previous certificates.

Various uses can be made of the attributes associated with Participant's Identity Credentials, as aggregated and compared using information available through the validation server. Digital certificates can be decomposed into data fields for comparison, e.g., the Organization Name and Individual Name in the X.509 certificate can be compared with those in the X.509 V3 extension to ensure they are the same. Elements of the X.509 V3 certificate can be resolved by the validation server to determine what an individual can have been authorized to do in the course of business. Based upon the electronic policies of the certificate consuming organization, suitably defined access controls can be defined for use in allowing access to data or services.

Additionally, use of the Quality Attribute for Identification enables interaction between almost strangers, although individuals without Enterprise association and participation in the transfer network cannot interact.

Individuals previously un-identified, yet working for any registered Enterprise can exchange Messages with other participants, even without Message FAILURE, as long as, the Enterprise they belong to has incorporated sufficient Bona Fides in their Quality Attributes.

A mechanism used within the Network Transfer System, Participant and system 100 systems can discern Attribute elements from the electronic Identities presented by the Enterprise Client. An innovative technique allows existing and new Message transfers to proceed, even as a new Enterprise transactions in process are detected.

Another innovative technique allows new Enterprise Representatives (new to the System 100) to initiate through the Network Transfer Participant System and create or continue Message transfers through the network, e.g., previously un-reviewed Credentials with previously un-reviewed authorizations and constraints do not halt or FAIL business Messages or the inherent exchanges that can occur. The system can review existing references from the Representatives Certificate or can make inference using the BFG e-Commerce hierarchy and the Registry and Participant Organization Policy along with the IC and Insurer e-commerce activity policies.

A method for Continuous Role Inference allows continuity of business process. The method uses the non-proprietary Attribute Elements (field values, singletons in reference) from the Quality Attribute found in the Enterprise Credential combined with the non-proprietary Attribute Elements found in the Enterprise Representative Credential and the attribute elements found in the Participant's Registry Credential This method allows “gray logic” inference concerning the electronic Identities used by ICN systems.

Additional Inferences can be generated for continuous application of electronic controls in an object oriented coding environment or as a coded inference engine or in straight forward coding, as in if-else-end. And these inference(s) can be recorded and stored as tables, like flat data files, or in databases, and can be used by and subsumed by the organizations that create them.

New Identities can cause the ICN 100 System to alert the appropriate Network Transfer Participant System 300 and any participant companies as well as any appropriate other individuals and companies using the Transfer System. Any potential failure of the transaction can be addressed, early on. Thus, any such “fail-able” transaction can be resolved using the innovative Pattern Scripting technique. Transactions that would apparently ‘fail’ due to a variety of improper operation circumstances and possibly due to an improper assignment of Representative Roles or authorization(s) can be interpreted by the IDM System via alternative IDM scripting available to the WF engine 260 and operated on by the IDM system per the existing electronic policies available to the system.

The Network Transfer System 100 provides content abuse detection and alerting. In addition to the abuse detection provided by the Network Transfer System client's validation server 340, the Network Transfer System 100 services include abuse detection of content for content management. The Network Transfer System records the streamed audit of all transactions and files the audit records in the audit database 250 for subsequent review.

Internal Digital Signature Checks—2210

Internal digital signature checks are resolvable from the data information passed by the Validation Server 230 to the WF engine and can be obtained and operated upon by the IDS 2210 sub systems via the TTS record of data for a transaction event, step, or record

Internal Message Checks—2220

Internal Message checking 2220 is available to the ICN System 100 via the WF and EETM (E2E) systems

Pattern Recognition—2230

Consistency checking of Participant Representative Entry Data as well as Event Timing and pattern Recording and well as Pattern Retrieval are available to the ICN System 100 and can be Report to Participant's Point of Contact person(s).

Comparator—22400

And comparator function is provided to do field-level data analysis and can be activated to review and resolve incremental file and field updates by End-Users. In addition, the comparator function can be enabled to review and report changes in—Identity Credentials, Audit Records, however it is not limited to these comparisons

Field Comparison—3500

A first-level comparison is performed at a data field level, where the content of the field is examined to determine if the authorizations provided the user by their organization correspond with the constraints (limits) put upon their data entry or upon the Message types they can use or upon the applications they can use. This comparison can use extracts from the Quality Attributes provided by the IDM component of the system 100. It can also detect alterations that can have been made by another user and identify the party who is responsible for the changes to the data in a message. If changes in the data are found where they should not be found, an alert or responsive event to the alteration in the data can be triggered, which becomes part of the abuse management component of the system 100.

Field Profile—3510

The field profiles can be provided from a base of forms and fields to be numerically indexed and accessed for comparison. There is the ability to perform comparisons of fields of different numerical order than 1 corresponding to 1, 2 corresponding to 2. For instance, in various form templates corresponding data fields can not be located in the same order. An example, 1 to 25, can indicate the correct location of data found in the next iteration of form for the same datum. Thus a data found in form(1) can be in field 3, while the same data to be found in a return or reply Message can be found in Form(6) field 25 for example. The comparisons field 3 to field 25 in their respective forms would allow for the detection of any change, either anticipated or un-anticipate, “Allowable or un-allowed,” in error or not.

Violation Management—820

Violation Management can be a group of or a single subsystem process. Violation Management processes are indicative of or looking at any type of or group of business or identity exception or error within ICN Application Messages or application related data content, as submitted to the Abuse Management Server.

The Violation Management service can be used consistent with Credential checking, i.e. comparison or review at the digital certificate level, as well as for Message checking—data consistency per available Policy Constraints, which can be used from tables or other reference to enact controls as need by the ICN systems. These can be used by and in conjunction with the—ICN Host Policy, Participant Registry Policy, Participant Organization Policy, Insurer Policy and allowing specific interim End-User policy—as applied to each and every transaction.

Error Messages Generation—2300

ABM produces application-level error messages for appropriate action by the WF and EETM System. Combined with EETM and WF system-level error messages, these messages can be used to build the context of appreciable errors—an appreciable error, as increasing (or decreasing) the error-level of any particular message. The err(msg(lvl)) system can be of any nature to communicate responses through the ICN System, even to the EETM or other modules directly as required. Business and Application-level error messages tend to appear later, within the system, as composed from Patterns and scripts. These can be made as text responses at the Error Reporting Level directly or separately on the Messaging Server.

Error Reports Generation—2310

Error Report(s) of the ABM can come from application- or systems-level error messages. The Error Report Generator of the Violation Manager can allow for the creation of internal operations error messages to Support and Service interfaces

Event Manager (Countermeasures)—830

Detection of Application, Identity or of Systems' abuse can be handled with the subsequent assignment of an error-level via distribution to both the WF Engine 220 and the EETM 260. Error-level responses to the Abuse Management Server from WF (via EETM) can have real-time consequences to Messages in transit and Message completion or Status Updates

Real Time (Towards Other Processes)—2400

Error-level messages directed to the WF and EETM servers can alter Message progress with-pause, alternate branching, hold, re-initiation or even STOP—activity messages, in addition to any other required branching or process looping. Real-time activities might include yet are not limited to—the augmentation-repair of inadequate credentials via associative techniques, involving Credential Trust Trees and various levels of attribute representations.

Delayed—2410

Delay of Message or of Status Updates is both a recorded and audited event, as well as, can indicate alternate process branching. Delays of Message. Timer(s) active in the WF and EETM can indicate a delayed status, require a branch or loop to the Event Manage and can be indicated via error-level messages to Participants.

Audit Server—250

Business Audit processing and systems security records are two of the areas where the IDM function can be uniquely used by the system 100. A new security function is provided. As transactions occur and the messages related to those transactions are passed through the Network Transfer System 100, the systems' events and Messages are audited by the Network Transfer System 100. During the application audit process, different types of audit can be performed. For instance,

Messages arriving are logged to the audit server and separately written in their original encrypted form with decryption keys to the message archive, using ICN Audit Encryption Keys or using the PUBLIC Audit Encryption Key of the Originating or Participating participants, as individuals for the messages they individually receive.

Audit Data Collection—900

Audit data collection for “write-off” is a function of the WF Patterning and EETM activities. Data is written to the Audit Server Filing System, as directed by the WF Engine 260.

Journaling—2500

A unique use the Message data and the IDM extracts, can create transitory audit journals for external review in participant accounting functions or internally for post-facto comparisons by other systems operating within the Network Transfer System 100. The transitory audit records can be built from the continuous flow of discrete Message-data in transactions by party, as sent and received. Also, since Message Data is captured by the transaction tracking system, which records each discrete transaction, data loss in event of a computer “down”, transmission failure, or general power loss can be restored to back to the time of “failure.” The data file of the audit record can persist as is formed and provided with a subsequent integrity check from the operating system, until such time as it can be physically removed, “written-off,” to storage media.

Archiving—2510

The actual media used for the “writing-off” and physical filing of audit information can vary to the best available technologies, however, a database index of transaction number, step number, iteration, per organization transaction can be activated with cryptographic protections to allow only properly authorized access to suitably encrypted data records.

Redundancy of physically filled data, like Archives and Indexes, can take various forms as to the needs of participants, and is not intended to be limited to any single method.

Audit Alerts (Real Time)—910

An Audit Alert subprocess to the EETM or other ICN or Participant System can be activated for Status Updates—particularly, while interruption of Message transmission or alerting for Identity Management processing or other necessary processing is expected to be a subsystem component of independent activity, whose particular access to the ICN System 100 is via a System 300, or like connection—remote, external.

Audit Reports—920

Audit Report subsystems and processing can send messages to the ICN System 100 for processing and distribution to the ICN Participants.

This audit trail provided by the information placed into the audit database provides a level of protection to users of the system. This is because any transaction which is mediated through the Network Transfer System 100 will have the appropriate authenticated messages identified in the audit database, allowing for a quantifiable ability to review and evaluate transactions after they have occurred. By providing such a capability for reliable after the fact analysis and reproduction of transactions as they originally occurred, the system becomes reliable in a manner very similar to systems which make use of physical markers (such as signed checks) to provide an auditable record of past transactions. Such quantifiable protections in the system can allow insurers to have the ability to underwrite policies that depend upon known levels of reliability in the transactions being carried out, so as to limit the total liability exposure of the parties to transactions mediated through the Network Transfer System 100.

Comparator—2600

And comparator function is provided to do field-level data analysis and can be activated to review and resolve incremental file and field updates by End-Users. In addition, the comparator function can be enabled to review and report changes in—Identity Credentials, Audit Records, however it is not limited to these comparisons

Field Comparison—3100

A first-level comparison is performed at a data field level, where the content of the field is examined to determine if the authorizations provided the user by their organization correspond with the constraints (limits) put upon their data entry or upon the Message types they can use or upon the applications they can use. This comparison can use extracts from the Quality Attributes provided by the IDM component of the system 100. It can also detect alterations that can have been made by another user and identify the party who is responsible for the changes to the data in a message. If changes in the data are found where they should not be found, an alert or responsive event to the alteration in the data can be triggered, which becomes part of the abuse management component of the system 100.

Field Profile—3110

The field profiles can be provided from a base of forms and fields to be numerically indexed and accessed for comparison. There is the ability to perform comparisons of fields of different numerical order than 1 corresponding to 1, 2 corresponding to 2. For instance, in various form templates corresponding data fields can not be located in the same order. An example, 1 to 25, can indicate the correct location of data found in the next iteration of form for the same datum. Thus a data found in form(1) can be in field 3, while the same data to be found in a return or reply Message can be found in Form(6) field 25 for example. The comparisons field 3 to field 25 in their respective forms would allow for the detection of any change, either anticipated or un-anticipated, “Allowable or un-allowed,” in error or not.

Filtering—2610

Various techniques for filtering and analyzing comparisons can be applied. One such technique might encompass indicated which field are not allowed to change or limits that can apply to the changes.

Pattern Recognition—2620

Various responses to filtering and field comparison can be generated and replayed to the WF and EETM servers for further analysis

End-to-End Transaction Manager—260

As discussed above with regard to non-financial and financial message exchanges, the service functions also include the ability to provide for End-to-End Transaction Management (E2E) between the various Network Transfer System Participant 300 that are connected to the Network Transfer System 100 by the communication network. This follows the same script and pattern as described below. This allows for the real-time exchange of text message(s) in a bi-directional, even multi-lateral exchange. This capability (as discussed above) is only available when both (or all) parties have access to and active connections with the Network Transfer System 100.

The features apply to a system, in which set-up includes at least the following: two Network Transfer System Participant systems at two different remote (participant) locations, a local server at each remote location, a central server. The number of remote locations can be arbitrarily expanded. Such a system are referred to in the following as “the system” and the parts dedicated to the exchange of information between participants and the central server as “the transfer network”.

The End to End Transaction Management server builds on functions and processes from other components with the key difference to perform from End to End i.e. between all parties involved in a transaction, according to agreed preset rules which are expressed as transaction patterns (or scripts or scenarios), which can be input, interpreted and monitored by the NTS components.

The set of applicable rules is only bound to the capacity of the WF engine, which can be implemented in the system and to the various monitoring and controlling processes, which are parts of the NTS servers. The following is a non-limiting list of “generic” rules, which are the foundation of the E2ETM:

Real Time End to End

Messages, whatever their content (transaction or supervision), will move swiftly through the system.

There is an obligation for all parties to deal with the messages according to an agreed (fast) schedule (pattern, script, scenario etc. derived from the agreed “set of rules”).

Users connected to the system are able to communicate and exchange documents, when and if required, instantaneously, in confidence and trust.

End-to-End Clarity (Transparency, Visibility)

Transaction progress and message status known (accessible) to parties involved when and if required.

Message and data formats are converted if and when necessary, that is in such a way as to be either machine- or human-readable and/or processed at each step of the transaction.

Ability for More Integrity—Message Content Integrity Checks (Source to Host)

Integrity of data from specified data field, with or without format conversion.

Ability for Non Repudiation

Bound to validity of Electronic signature, and exchange script defined in accordance to applicable commerce regulation/laws.

The components can include and without limitation: the control of the channel established between transaction participants, the monitoring of transaction patterns (scripts), the management of the pattern (script) description records, the consistency checks between “adjacent” processes, the management of insurance, which can also follow different patterns (scripts).

Transaction Channel Control—1000

A “secure” VPN-like channel is established between business participants in a given transaction (Log On). The “VPN” will stay established as long as defined by the pattern (including security mode) of the transaction. The “VPN” will enable the exchange of documents and messages in RT or store and forward mode (etc.) in both directions and from end-to-end. The components can include and without limitation: channel tracking and monitoring, message reflection and echo, instant document messaging.

Transaction Channel Tracking and Monitoring—2700

This component will command and overlook the channel lifecycle from creation of a first path between the initiator and the NTS, at the start of a transaction, to closure at the end or the termination of the transaction. This cycle will go through various stages where “secure” paths or channels are gradually open and closed between participants, once their credentials have been validated and the exchange of messages authorized. Every event in this life cycle is recorded in a way to enable the generation of real-time or delayed analysis, audits and reports which can be distributed and/or displayed to business participants, to the NTS and to the NTS manager.

Message Reflection and Echo—2710

Every participant gets the assurance that what they see or get is either identical or fully consistent with what was created, validated and sent by any other recognized party, with the appropriate authority. This is done in providing identity, consistency and validity checks on content of messages or documents, which are reflected or echoed from one step of the transaction to the next. Reflection or echo can take place either bilaterally between processes which are directly communicating on a given site or between one of the participant and the core server or from end-to-end between remote clients (participants) or between adjacent processes activated at one of the participants sites.

Instant Messaging—2720

Instant “document messaging”, the ability for business participants in live transactions to exchange short messages or documents in real time is a build-in feature of the NTS, which, when activated, can be used once the “VPN-like” is established.

Transaction Pattern (Script) Adherence Monitoring—1010

This component will command and overlook the (predefined) business transaction pattern (script) from the initiation of the transaction to its end (or termination) whether the transaction is successful or diverted from its “normal” course by countermeasures triggered by the security servers like the Abuse Management Server.

This component includes the ability to hold or stop a transaction from the initiative of a participant.

Status Updates—3310

Once a transaction starts, ends, terminates or reaches a new step, a “transaction status” record is either created or updated, which new content are distributed to the E2ETM tracking and tracing component and to other components of the NTS.

Tracking and Tracing—3320

Transaction status records are archived, accessed and distributed in a way as to enable the generation of real-time or delayed analysis, audits and reports which can be distributed and/or displayed to relevant participants in the business transaction and to the NTS manager, when and if appropriate.

Visualization of Transaction of Transaction—3330

The display of automated Monitoring is provided through:

Two build-in options, one of which is or can be activated at any time at the remote site of each of the business participants during a transaction, once the “VPN-like” is established: either a “Status Window” displaying monitoring data like participants rep., step number, state of progress within step, or a process diagram like the one illustrated in FIG. 34;

Alerts or “Signals” distributed via the communication media to the remote sites of the participants in the business transaction.

Transaction Pattern (Script) Manager—1020

This component will enable the management (creation, update, deletion) of “policy profiles” via the formalization of operating and prudential rules and procedures, which can then be used by various components of the NTS, when appropriate. It includes

Policy Profile—3410

This component enables the formalization of an agreed set of rules, a “policy profile”, into pattern, which are used directly by the various processes activated in the NTS.

New Pattern and Acceptance Logging—3420

This component enables storage (record) and activation of either a new pattern or the update of an existing one.

Inter-Process Consistency Checks—1030

The NTS application server at the remote site gives the ability to the client adjacent applications to receive and transmit data “unaltered” (apart from needed format conversion by so-called “adaptors”) from one client application to another. Consistency checks are made between messages of same sequence (or transaction) on predefined data field.

Insurance Management—1040

There are a number of identifiable risks when the NTS is used for data transactions related to financial transactions.

Customer Transaction Services and Software Risks include risks involving a breach of logical or physical security due to any failure of the Software, when used properly as described and required hereunder, or any failure of the Software's interaction with IC's data transfer network which results in inaccurate, altered, improperly authenticated or invalid transaction messages sent or received by Customer or any Receiving party or Agent participating in the Service; and

Internet Transmission Risks include risks involving alteration, re-direction, interception, delay or destruction of any transaction messages from the point at which a properly formatted, authorized and prepared message is sent by Customer from Customer's Software interface to the point at which it or should have been properly received, authenticated and validated by the intended recipient.

This insurance management component 1040 monitors the processes by which the NTS enables each participant to verify and authenticate transactions electronically in a pre-arranged and secure format, including, without limitation, transfer and delivery, digital certificates. etc.

Transfer and delivery of transaction messaging uses a digital signature validated by a legitimate digital certificate authority (“Transaction Services”), through the transfer network system that authenticates the integrity of the data transmitted and received using the Service, as well as the reliability of authenticated messages. The Service, which includes such Transaction Services, can authenticate and validate each message and confirmation made by Customer through use of the Service, based on authorities and approval rights specified by Customer and compliance to agreed Customer specified criteria and procedures.

The use of X.509 v3 digital certificates (or any other subsequent digital certificates approved by IC in writing) in connection with the NTS provides various quality attributes, so that responsibility for inaccurate identification and authentication can be clearly identified.

Other Security Components

Communications between the entry workstation 320 and the management workstation 330 with various other devices, belonging to the Remote system 300, can be made using a Secure Socket Layer (SSL) protocol to protect data transmissions. SSL protocol yields session level encryption and provides a distinct identity for the workstation communications protocols. This further allows a greater degree of data protection to the Network Transfer System 100 and a higher degree of trust in the data stored therein.

Valued Message, Updates and Alert Triggers

The various modules and components of the ICN Host, System 100 and Network Transfer System clients 300 interact with security functions that can be provided from the Enterprise's client workstations themselves and from the underlying communications medium 125. Additionally, security related data can be generated and appended to Messages transferred between the Network Transfer System clients and the system 100. Security related data obtained by the system 100 from the Network Transfer System client systems can be analyzed and extracted as well as appended to messages transferred between the Network Transfer System 100 and the other Network Transfer System clients.

The ability to inspect, identify and extract security related data, in addition to the ability to Identify its source allows the various Remote and Systems 100 modules in various physical locations to identify themselves by tagging the data and processes that are associated with the actions of a specific user.

Through the use of the systems 100 Identity Management IDM) component described above, the transaction security data, authorizations and constraints can be associated with 1) the correct user, 2) tagged to the appropriate Message and 3) distributed via Status Update (messages) and for the purpose of validating authorizations and data from end-to-end.

Additional security functions of the network and operating system can provide an extended basis for establishing and corroborating the security functions provided by the Network Transfer System 100 and Network Transfer System clients 300.

As mentioned above, alerts can be provided in order to provide notice to a user or administrator or other individual associated with the Network Transfer System or client when a process is inside or outside the expected behavior. For instance, lack of digital certificate integrity can be used to signal an immediate alert from the validation server to the appropriate Participant(s). Other examples include noting a potential abuse of the system when any conflict in information between the digital certificate of a client and the OID or other values of their organization Quality Attribute.

Standards-in-Use and Flexibility

To obtain the highest level of clarity and verifiability for use with I-C transactions, electronic identities are bound to the individuals using the Network Transfer System clients 300 using the X.509 V3 standard for digital certificates and in accordance with the Quality Attributes. The combination of X.509 digital certificates with the V3 (version 3) Quality Attribute extensions allows any participant organization to advertise their employees' electronic credentials via X.500 directory services. This also allows other participants to access these credentials via directory protocols, such as LDAP. The credentials provided by the receiving party 120 can be used by the sending party 110 and vice versa. Similarly the credentials provided by the Network Transfer System can be used by all participants and Network Transfer System clients, and the use of these reference numbers with the quality attribute.

Identity Resolution and Distribution is One example of a type of security datum that can be inspected, resolved and distributed to other Participants The system 100 IDM function provides a highly secure environment as the basis for distributing the identifications, which are derived in part from the result of digital signature resolution, using the Quality Attribute, and distributing these via the digital signature of the ICN Host Systems.

The distributed identifications can contain Message identities, Organization Identities, Individual and Machine (hardware) identities incorporated into the form of Transaction Identities (TID) 1) as well as the other participants, generated as Alerts, Status Updates, as well as, to distribute the appropriate elements to any other system 100 subsystem requiring security data.

As discussed above, directory services, such as X.500 standards-based directories, are used by the Network Transfer System and Network Transfer System clients and their various components for proper addressing. Any of these components or the modules running on them can look up the correct address for any other individual registered with the Network Transfer System. The information available includes address specifics, organization names (e.g., X.500 Distinguished Name), as well as specific information in the defined Quality Attribute.

In addition to audit functions and functions provided through the capabilities of the Network Transfer System 100 or the Network Transfer System clients 300, other security functions are also available through the operating system or through third-party software. These can include, for example, digital certificate analysis software for identification purposes. For example, when identity authentication is performed during a log in process, the operating system compares a data “secret” presented by the end-user with a secret available to the operating system. The operating system can audit these events as well. It are understood that a variety of different digital signature authorities could be used without altering the fundamental nature of the system described.

So when specific security functions of the network or operating system are executed, the network or operating systems security and audit features can record the activity along with the logged in identity for the activity. Selected data fields from the system's audit record can then be sent to the Network Transfer System or client and analyzed after the fact. More detail regarding logging in to the Network Transfer System can be found below.

These audit features form s the basis for a continuous audit, and allow transaction audit records to be compared with system audit records in order to perform specific data analyses. A common comparison that can be performed via the network and operating system's security functions is a comparison related to the use of a digital certificate.

The support functions deal with operation and maintenance of the system under normal conditions and back-up or recovery.

These functions can include without limitation: a gateway to clients that only allows properly authenticated communications, i.e., communications from users validated through a validation server internal secure hub for the exchange of information between all software modules of the Network Transfer System and the Network Transfer System clients, and maintenance functions for recovery and backup.

Service, security and support functions are implemented accordingly as inspected software (or hardware) elements are available for either standard or secure (EAL level 2 or level 4) platforms, as well as, for variations within the commercial environment that can receive independent evaluation.

In the case of payments, because the Network Transfer System 100 does not actually perform the transfer of any of the funds between agents (this is handled directly between the agents using any ordinary settlement system), the digital documents can be used in the same way that paper copies of signed payment orders or checks would be used. This allows the Network Transfer System operator to only be liable for the authenticity of the documents they transfer, and not the funds at issue.

In the case of a financial transaction, the appropriate language to bind the parties legally to the transaction can be inserted in the appropriate interfaces and digital documents which are signed and authenticated. In addition to providing the appropriate support for the authenticity of the documents, if it ever becomes necessary to prove the validity of the transfer instruments at a later time, the interface associated with presenting and digitally signing these documents can also be configured so as to comply with the appropriate regulations governing the transfer of funds. For instance, appropriate consent and warning language in order to comply with Regulation E or other regulations implementing the Electronic Funds Transfer Act, can be inserted into the documents that are digitally signed by the appropriate parties.

In addition to the embodiments described above, certain additional functions/components can be added to the system. For instance, a data clearing house entity can be configured to hold copies of all transaction instruments recorded by the transfer network system, and then periodically post these results to the appropriate entities for final settlement and storage. Note that this data clearing house need not clear actual financial transactions, but can act as a daily data repository which is periodically (e.g., daily) posted.

One additional service function provided by the systems described herein is that of transaction fee collection. This is a function that allows tracking of the amount of traffic and the value of the transactions associated with particular Network Transfer System clients 300. This information can be stored and aggregated in order to provide an appropriate basis for usage-based billing of the parties making use of their Network Transfer System clients. Additionally, this information can automatically be used to generate invoices which can be sent in a properly pre-formatted payment message by the Network Transfer System 100.

Transactions Scripts

In the flowcharts in FIGS. 39-55 associated with the various transactions and transaction scripts, certain conventions are used. In each flowchart in which a process or script is displayed, the first row of the flowchart represents the various parties to the particular process being discussed. These can include, for example, the sending party 110, or the Network Transfer System 100, or even a particular portion of one of the participating systems, for example, the messaging server 210 or the management workstation 330 at a receiving party 120. As the flow of the processes are followed (reference numbers for process blocks are provided in the far right or left column), the activity or state of each of the participating systems is noted underneath the heading for that particular system.

Secure Message Creation and Transmission

FIG. 39 shows a script that covers the basic process for the creation and transmission of a message between a client (either a transaction party, an agent or an intermediary) and the Network Transfer System 100. This script provides for a secure creation and delivery of a message to the Network Transfer System, and are used whenever a communication with the Network Transfer System is initiated by any client system, whether the communication is related to a commercial portion of a transaction or a financial portion of a transaction. The script includes the following functions:
generating at the first party (sender) WS an order or request document, sending document to ICN once it is digitally signed (see also Generic script-secured transmission) from the first party to the network transfer system electronically. This data are transferred in a standard format which can be automatically verified by the transfer network system against an appropriate digital certificate authority (see Generic script one blocks 2, 3, 4);
storing a copy of the signed digital document in a database associated with the transfer network system (see Generic script one block 5);
sending back an authorization request from the network transfer system to the first party management WS once it is authenticated (see Generic script block 6);
sending the signed authorization request from the first party to the network transfer system electronically once it is authorized, i.e., assenting to the order/request. The transfer network system is able to appropriately authenticate that the user approving the order/request has appropriate authority for it (see Generic script one blocks 7, 8, 10, 11, 12);
storing a copy of the signed authorization request in the database associated with the transfer network system, i.e., copy of this assent to the payment is stored in a database associated with the transfer network system (see Generic script one block 9);
sending order/request message, appropriate confirmation of the approval of the message (such as a copy of the authenticated assent) to the recipient and acknowledgment to the sender of transmission to recipient (see Generic script 1 blocks 13, 14, 15).

As shown in FIG. 39, the actions of the script are:
(Logon), VPN established or activated with sender, 1
Entry workstation login incl. Proof of “presence” to run in person or to launch the process (if automated), 2
Message created, 3
Message audit file created, 4
Message audit file received, 5
Signed & encrypted data & form(s) sent to ICN, 6
Message data and forms received, 7
Message validation (identity and constraints management) from Identity Management subcomponents of Validation Server; response sent to Sender, possibly created by returning audit file with comparison to message data or similar comparison., 8
Message validation response created and for Status Updates at participant sites, 9
Message validation response(s) received, 10
VPN inactive, 11

This process is described as relating to an initial message between a sender and a recipient. However, a similar process is used with the sender and recipient reversed when a message is responded to. This process is described below.

This process is generic to communications through the Network Transfer System 100 and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Secure Message Creation and Transmission with Approval (FIG. 40)

A high level script that covers the basic process for the creation and transmission of a message between a client (either a transaction party, a agent or an intermediary) and the Network Transfer System 100 will now be described. This script provides no change secure creation and approval by a client authority and delivery of a message to the Network Transfer System, and is used whenever a communication with the Network Transfer System is initiated by any client system, whether the communication is related to a commercial portion of a transaction or a financial portion of a transaction. The script includes:
(Logon), VPN established or activated with sender, 1;
Entry workstation login, 2;
Message created, 3;
Message audit file created, 4;
Message audit file received, 5;
Management workstation login, 6;
Signed and encrypted data sent to management WS;
Message approval—Management WS validates message, 7;
Message approval audit file created, 8;
Message approval audit file received, 9;
Signed and encrypted message sent to ICN—Management WS post message (with signature) 10
Message received, 11
Signed and encrypted message approval sent to ICN, 12;
Message approval received, 13;
Validity of message checked by comparing message audit file, encrypted message, message approval audit file and encrypted message approval, 14;
VPN established or activated with recipient with agreed options re. confidentiality;
created, 15;
Message validation response received, 16;
VPN inactive, 17

This process is described as relating to an initial message between a sender and a recipient. However, a similar process is used with the sender and recipient reversed when a message is responded to. This process is described below.

The system supports the following type of script for the secured generation and transmission of the response to an order/request message:
acknowledging and analyzing at the recipient (other party) WS the received order or request message, generating the response document and sending document to ICN once it is digitally signed (see also Generic script-secured transmission) from the other party to the network transfer system electronically. This data are transferred in a standard format which can be automatically verified by the transfer network system against an appropriate digital certificate authority (see Generic script two blocks 2, 3, 4, 5);
storing a copy of the signed digital document in a database associated with the transfer network system (see Generic script two block 6);
sending back an authorization request from the network transfer system to the recipient management WS once it is authenticated (see Generic script two block 7);
sending the signed authorization request from the recipient management WS to the network transfer system electronically once it is authorized i.e. assenting to the response. The transfer network system is able to appropriately authenticate that the user approving the response has appropriate authority for it (see Generic script two blocks 8, 9, 11, 12);
storing a copy of the signed authorization request in the database associated with the transfer network system e.g., copy of this assent to the payment is stored in a database associated with the transfer network system (see Generic script two blocks 10, 12);
sending to the order/request sender the response message, with the appropriate confirmation of the approval for the response by the order/request recipient (such as a copy of the authenticated assent) and acknowledgment of message and notification of message to initial (responding) recipient (see Generic script one blocks 13, 14, 15, 16).

This process is generic to all communications through the Network Transfer System 100, and are used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Secure Reception of a Message with Acknowledgement and Response

FIG. 41 shows A high level script that covers the basic process for the reception, acknowledgement and response of a message between a client (either a transaction party, a agent or an intermediary) and the Network Transfer System 100. This script provides no change secure reception, acknowledgement, and response of a message to the Network Transfer System, and is used whenever a communication with the Network Transfer System is initiated by any client system, whether the communication is related to a commercial portion of a transaction or a financial portion of a transaction.
The script includes:
   VPN established or activated with receiver, (Logon) and for the other Participants, as an outgoing communication from the System 100, 1;
   Entry workstation login, 2;
   Message received, 3;
   Message receipt audit file created, 4;
   Local audit;
   Message receipt audit file received 5;
   Signed and encrypted message receipt acknowledgment sent to ICN 6;
   Local audit;
   Message receipt acknowledgment received 7;
   Validity of response checked by comparing message receipt audit file and encrypted message receipt acknowledgement 8;
   VPN established or activated with “sender” with agreed options regarding confidentiality;
   Message validation response created 9;
   Response receipt message sent to “recipient” and response forward message sent to “sender”;
   Message validation response received, 10;
   VPN inactive, 11

This process is generic to communications through the Network Transfer System 100, and are used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Secure Reception of a Message with Approval

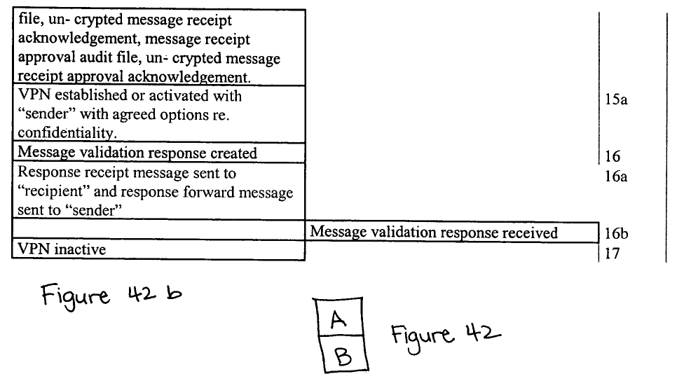

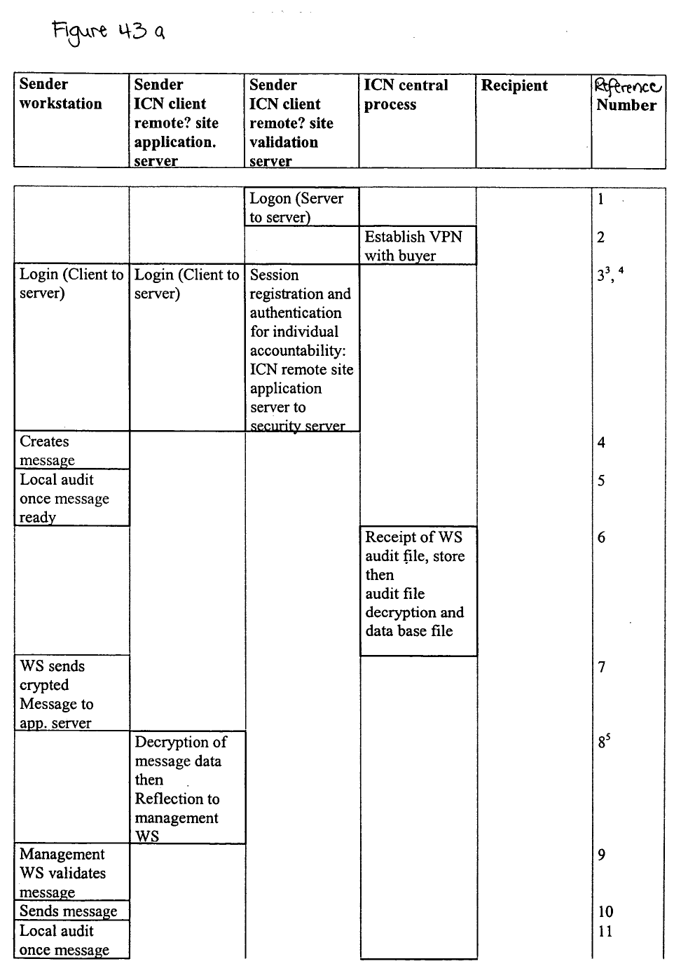

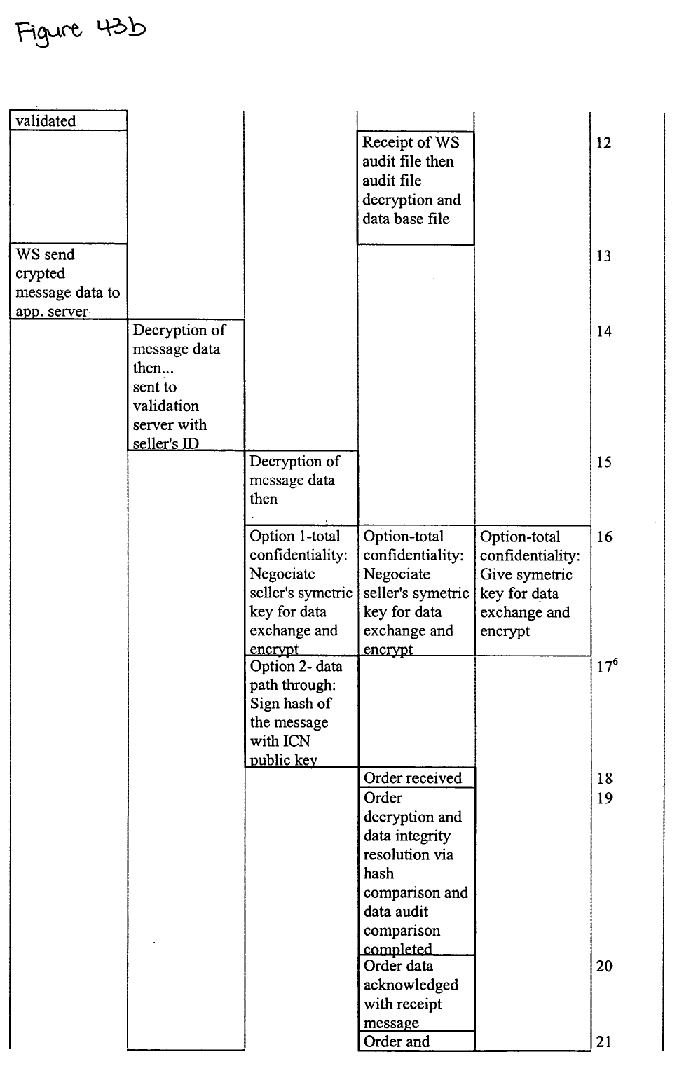

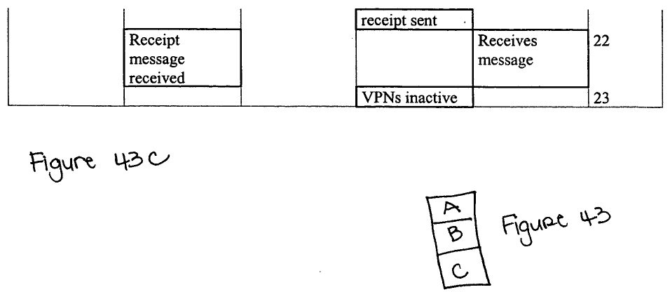

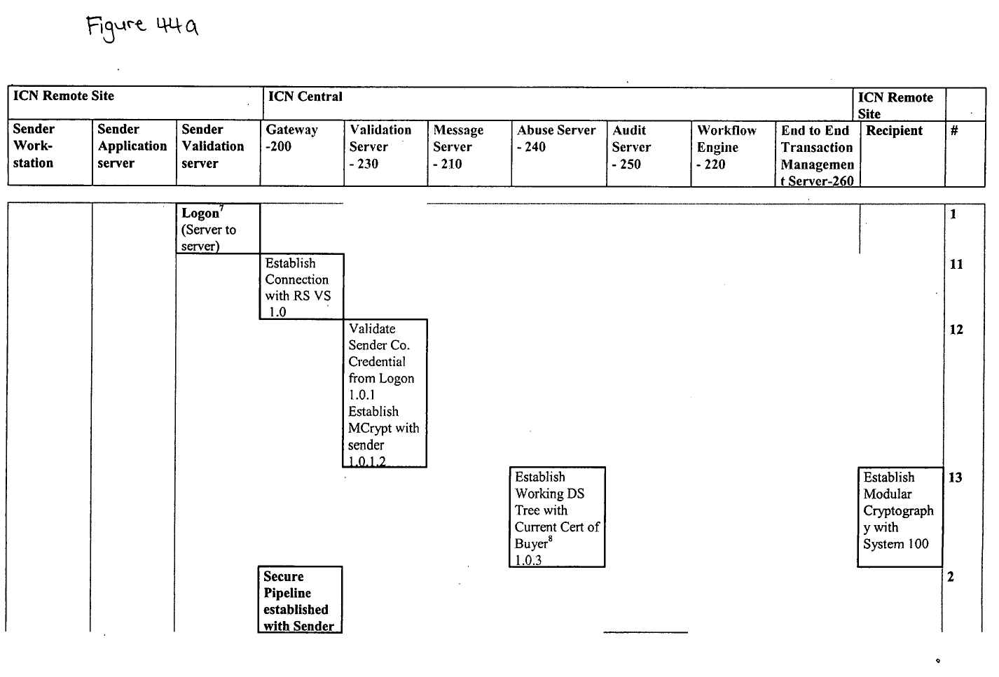

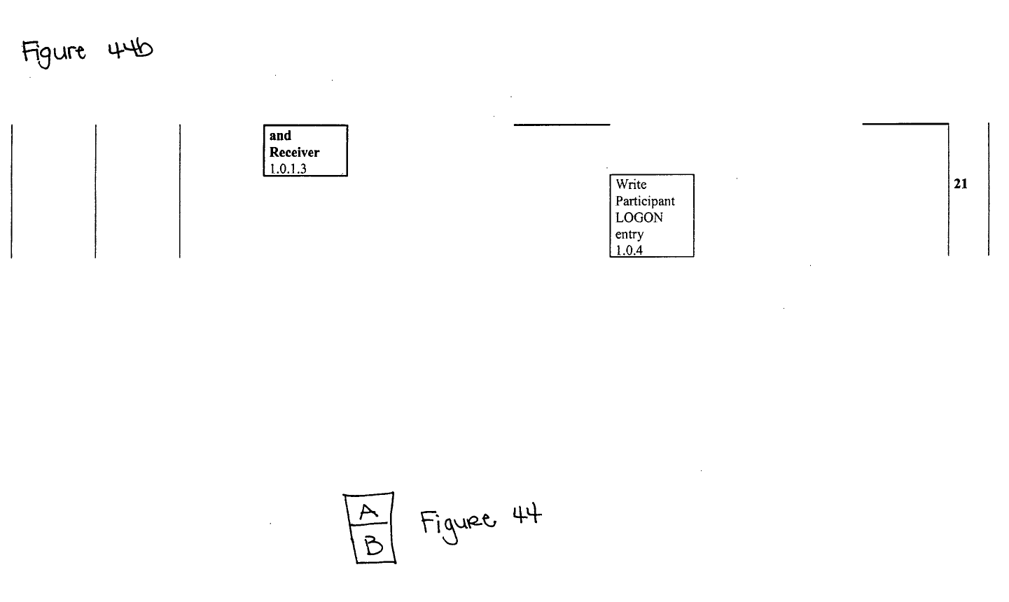

FIG. 42 shows al script that describes the basic process for the reception, acknowledgement and response of a message between a client (either a transaction party, a agent or an intermediary) and the Network Transfer System 100. This script provides the secure reception, acknowledgment and response of a message to the Network Transfer System, and are used whenever a communication with the Network Transfer System is initiated by any client system, whether the communication is related to a commercial portion of a transaction or a financial portion of a transaction. The script includes
VPN established or activated with receiver, (Logon) 1;
Entry workstation login 2;
Message received 3;
Message receipt audit file created 5;
Local audit;
Message receipt audit file received 6
Management workstation login 7;
Message receipt approved 8;
Message receipt approval audit file created 9;
Message receipt approval audit 10;
Signed and encrypted message receipt acknowledgment sent to ICN, 11;
Local audit;
Message receipt acknowledgment received, 12;
Signed and encrypted message receipt acknowledgment sent to ICN, 13;
Local audit;
Message receipt approval acknowledgment received, 14;
Validity of response checked by comparing message receipt audit file, encrypted message receipt acknowledgement, message receipt approval audit file, encrypted message receipt approval acknowledgement, 15;
VPN established or activated with “sender” with agreed options re. confidentiality;
Message validation response created, 16;
Response receipt message sent to “recipient” and response forward message sent to “sender”;
Message validation response received, missing;
VPN inactive 17.

This process is generic to communications through the Network Transfer System 100, and are used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Authenticating Message Creation and Transmission (FIG. 43)

A generic script that covers the basic process for the creation and transmission of a message between a client (either a transaction party or an agent) and the Network Transfer System 100 will now be described. This script provides for the secure creation and delivery of a message to the Network Transfer System, and is used whenever a communication with the Network Transfer System is initiated by any client system, whether the communication is related to a commercial portion of a transaction or a financial portion of a transaction.
The script includes:
   Logon (Server to server), 1;
   Establish VPN with sending party, 2;
      Login (Client to server), Login (Client to server), Session registration and authentication for individual accountability;
   ICN remote site application server to security server, 3 (Allows for graded authentication, which can be assigned in numerical evaluation consistent with the insurance UWs need for individual accountability. Establishes connection between identity and use of the secret.
   Creates message instead of order (or request for quote), 4;
   Local audit once message instead of order ready, 5;
      Receipt of WS audit file then audit file decryption and data base file 6;
   WS send encrypted data to application server, 7;
   Decryption of message instead of order data, then Reflection to management WS, 8 (Data formatting will depend on the app. itself whether it is C-S or web service type. The SLA must specify that ICN is not responsible of malicious attack at the client level and the inventor suggest that WS application software be reloaded at each session in a suitable object reused model removing all prior data from WS at logout.);
   Management WS validates message instead of order, 9;
   Sends message instead of order, 10;
   Local audit once message instead of order validated, 11;
   Receipt of WS audit file then audit file decryption and data base file, 12;
   WS send encrypted data to app. server, 13;
   Decryption of message instead of order data then sent to validation server with seller's ID, 14;
   Decryption of message instead of order data then 15;
   Option 1—total confidentiality:;
   Negotiate seller's symmetric key for data exchange and encrypt, Option—total confidentiality;
   Negotiate seller's symmetric key for data exchange and encrypt, Option—total confidentiality;
   Give symmetric key for data exchange and encrypt, 16;
   Option 2—data path through:;
   Sign hash of the message with ICN public key, 17 (Public” confidentiality comes from VPN);
   Order received, 18;
   Order decryption and data integrity resolution via hash comparison and data audit comparison completed, 19;
   Order data acknowledged with receipt message, 20;
   Order and receipt sent, 21;
   Receipt message received, Receives message instead of order, 22;
   VPN inactive, 23.

This process is described as relating to an initial message between a sender and a recipient. However, the same process is used with the sender and recipient reversed when a message is responded to. The responding party (the recipient of the above described process) will send a response message to the Network Transfer System 100, where it are validated and sent back for authorization. The responding party will have an appropriate individual authorize the communication, after validating that it came from the Network Transfer System 100, and then will send the digitally signed message back to the Network Transfer System 100 for validation and forwarding to the sender of the original message. Copies are stored in the audit database 250 as described above.

This process is generic to all communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

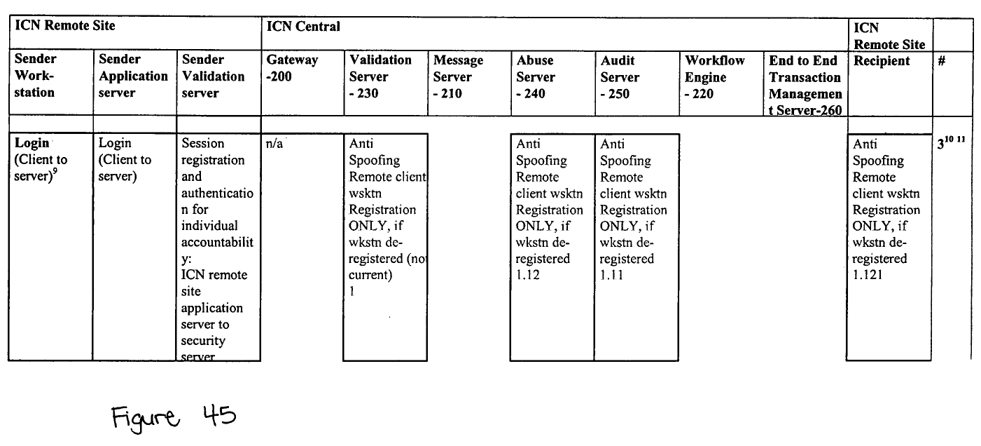

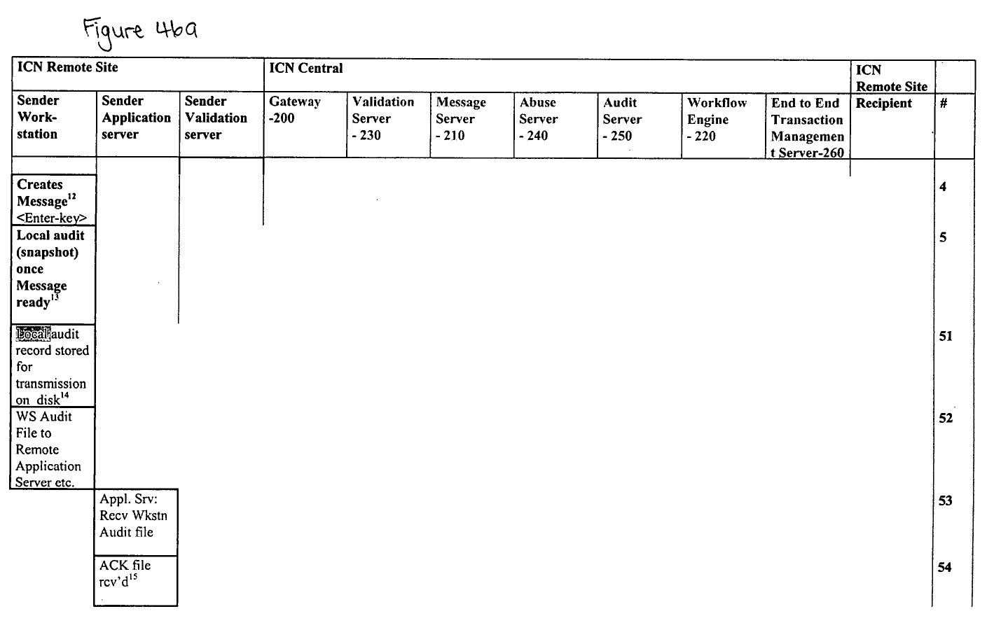

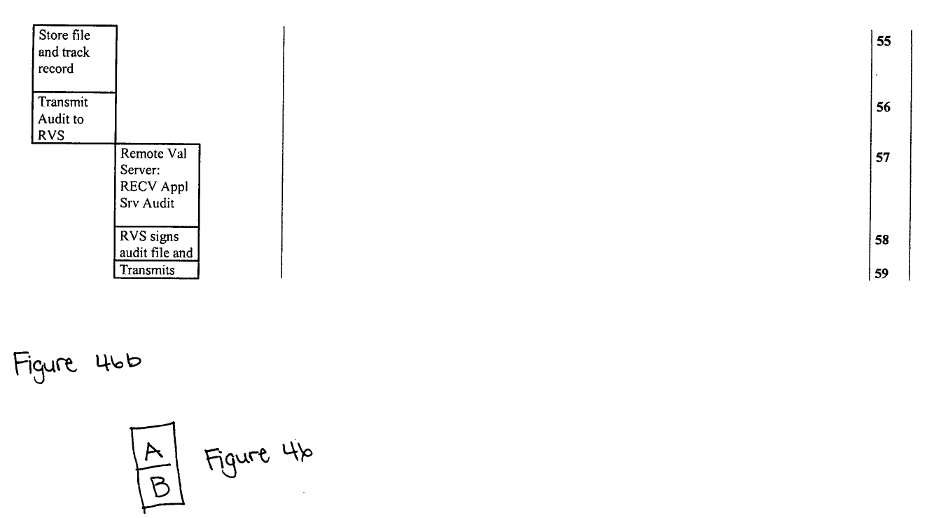

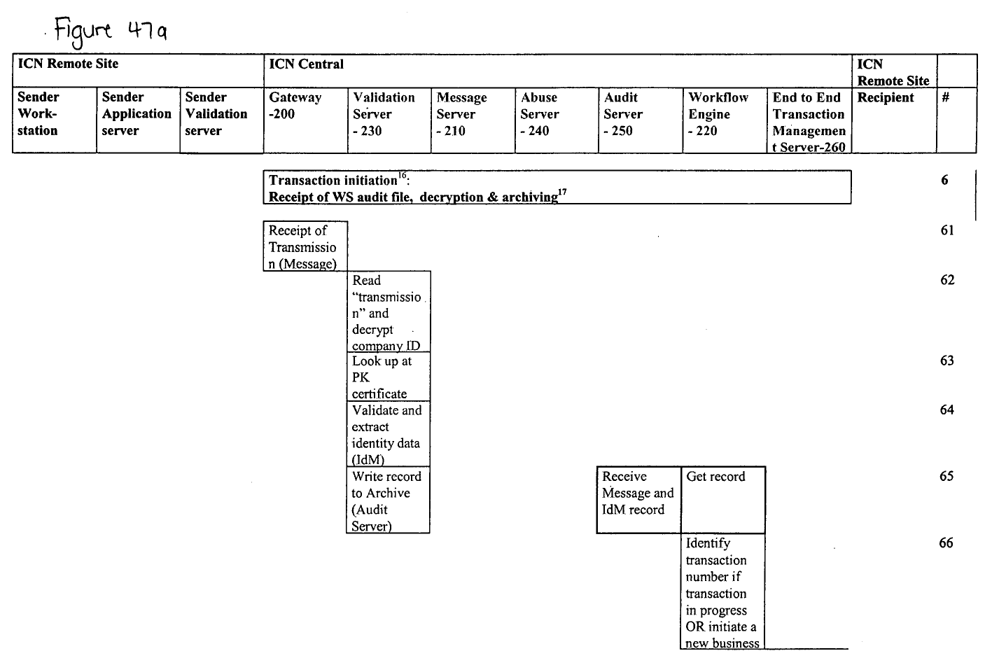

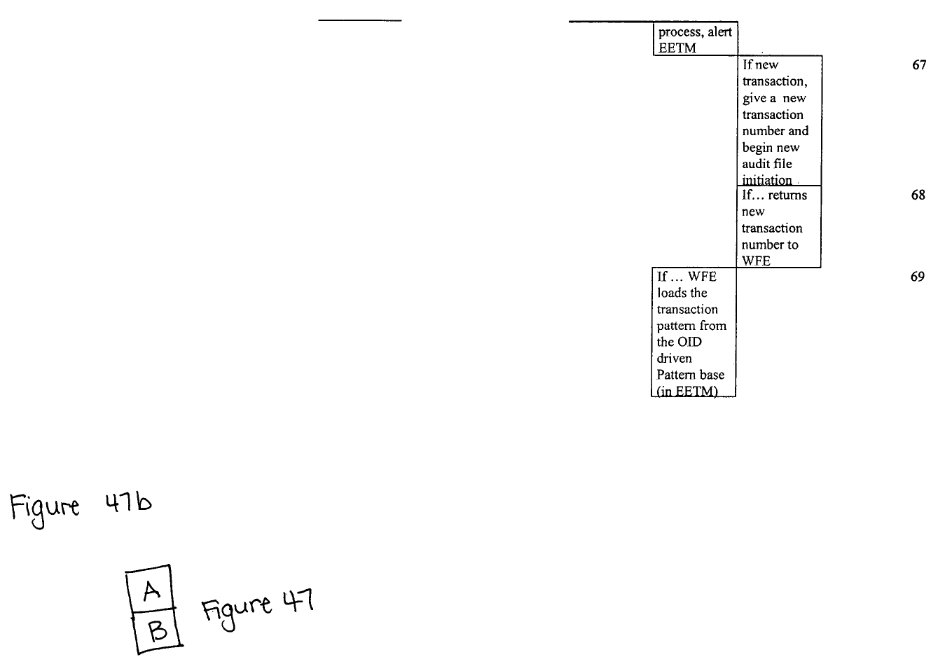

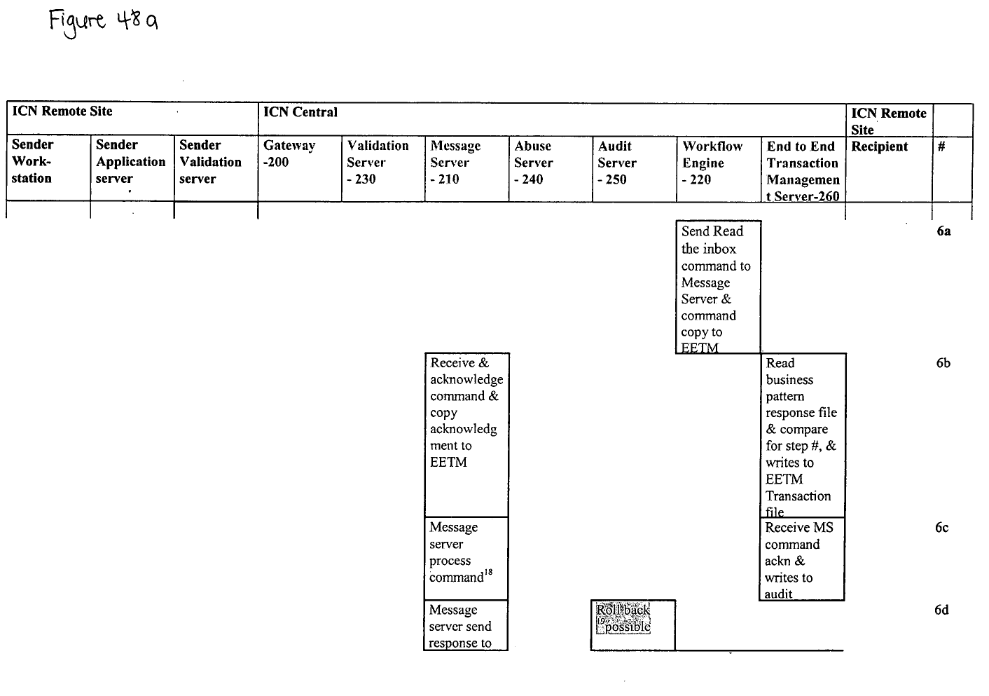

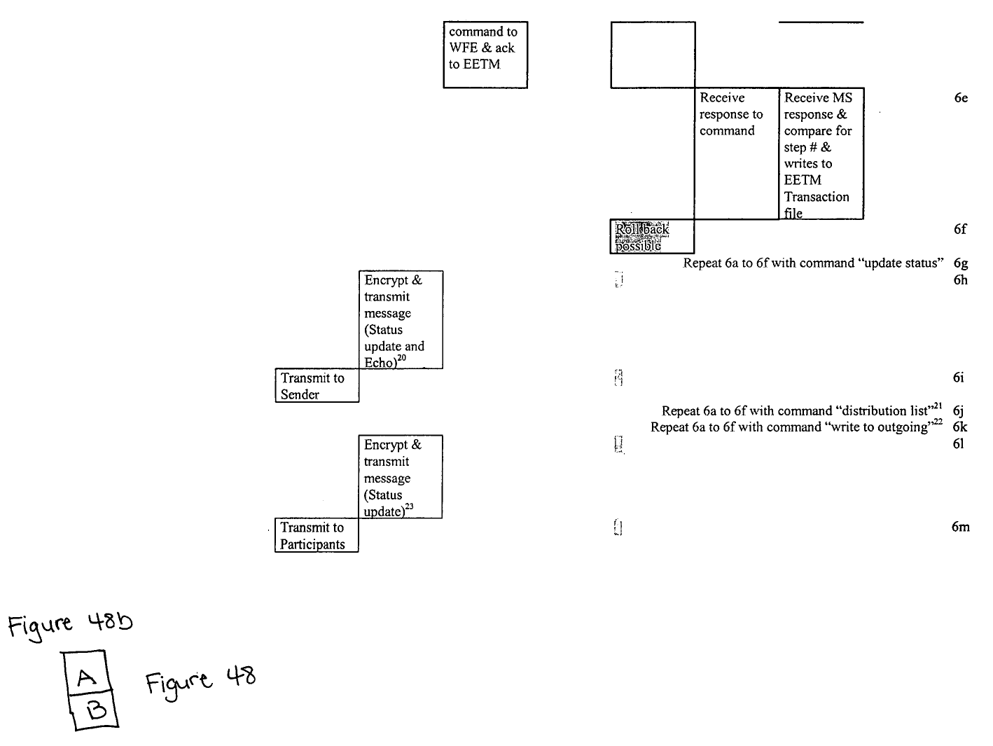

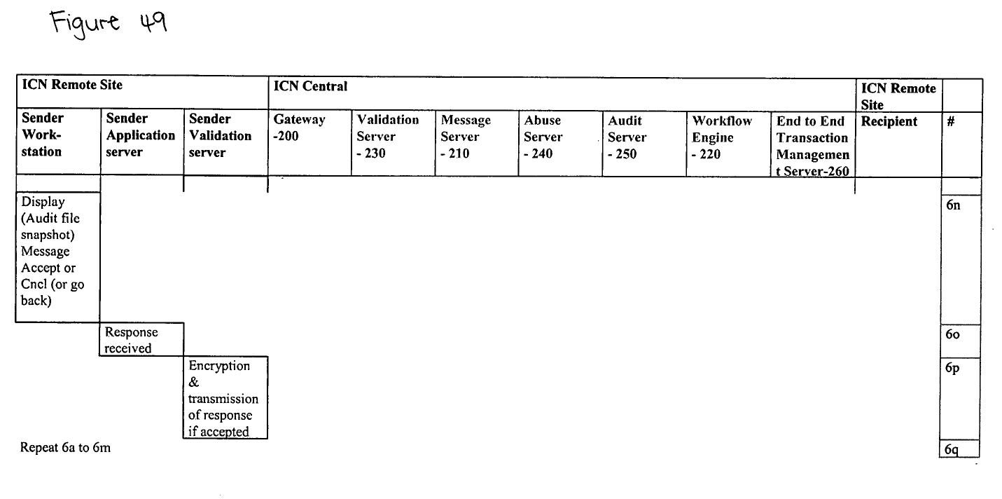

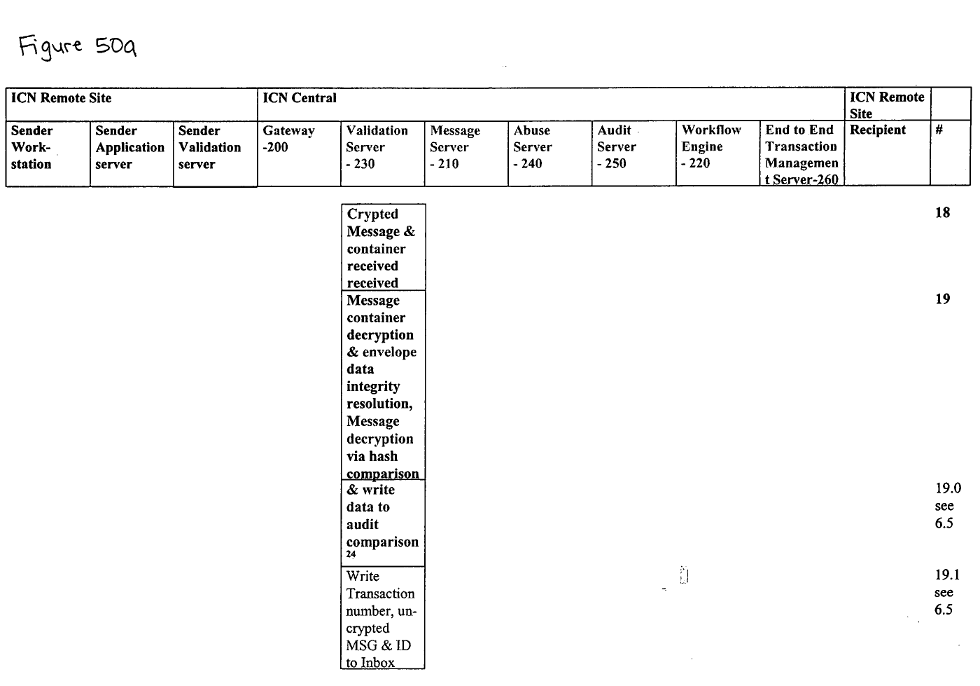

Logging On and Logging In (FIGS. 44 and 45)

Within the Figures and description that follow, two different processes related to establishing connections between the various described systems are noted. The first is called “logging on” to the Network Transfer System 100. Logging on is the process of establishing a network connection between a particular Network Transfer System client 300 and the Network Transfer System 100. This process is essentially similar to establishing a Virtual Private Network (VPN), (i.e. VPN-like any of a type of confidential communications technologies) connection between the two systems. Data sent across this VPN-like (e.g. confidential cryptographic communications) is actually carried across the communications medium 125; however, an additional VPN-like (e.g. confidential cryptographic communications) protocol is applied on top of the normal protocols in use for the communications medium in order to establish the private nature of this communication. This logging on process is performed prior to the exchange of any messages or data that are to be carried across the Network Transfer System to any other system.

Separate from the “logging on” process described above, the process of “logging in” is used to refer to the authentication and validation of individual users with particular levels of authority to transact across the Network Transfer System 100. Logging on is a process which is carried out automatically by the Network Transfer System client 300 and Network Transfer System 100 as needed in order to maintain a private communications channel across the potentially insecure communications medium 125. By contrast, logging in is a process initiated by a user in order to establish their credentials to carry out a transaction on behalf of the entity they represent (e.g., the sending party 110 or the receiving party 120).

The process of logging in as a particular user is discussed in greater technical detail below. While logging in establishes that the particular Network Transfer System client 300 that is connecting to the Network Transfer System 100 is properly authorized to exchange messages with the Network Transfer System 100, logging on establishes the appropriate authority level associated with the particular individual that are applying a digital signature to the messages that are being sent. This process of logging in is important for those signed messages which are to be used as an indication of a legally binding transaction. For instance, in order to properly bind one of the parties, an appropriate message containing the warnings and consent and warning language in compliance with Regulation E can be digitally signed. However, such signature must be made by a party properly identified and validated to have the authority to properly bind the party. Logging in establishes the identity and authority of the digitally signing individual.

Secure Logon (FIG. 44)

In logging on, the Network Transfer System client 300 must properly authenticate itself to the Network Transfer System 100. This does not require the acknowledgement of any particular user at the client 300 or any particular authority level, but merely an authentication that establishes that the Network Transfer System client 300 is an established client known to the Network Transfer System 100 and trusted to transact across the Network Transfer System.

Once logged on, this VPN-like connection (e.g., confidential cryptographic communications) is used for any further communication between that client 300 and the Network Transfer System 100 until the end of that particular communication stream. For instance, in order to send a request for quotation (RFQ) message to a receiving party 120, the Network Transfer System client 300 of the sending party 110 first logs on to the Network Transfer System 100 and establishes the appropriate connection. Similarly, prior to passing the message along to the receiving party's Network Transfer System client 300, the Network Transfer System 100 establishes the proper VPN-like (e.g., confidential cryptographic communications) connection by having the receiving party's Network Transfer System client log on to the Network Transfer System.

Communications to be carried between any of the Network Transfer System client systems 300 and the Network Transfer System 100 are carried across this VPN-like (e.g. confidential cryptographic communications) connection only once the client is properly logged on. For security purposes, encryption can be used at the VPN-like (e.g. confidential cryptographic communications) level in order to secure all of the traffic carried across the communications medium 125. Such encryption is a common feature of VPN-like (e.g. confidential cryptographic communications) systems.

A generic script that covers the Logon process will now be described. This script provides for a secure Logon of a participant top the NTS 100 and is used whenever a communication with the Network Transfer System is initiated by any client system, whether the communication is related to a commercial portion of a transaction or a financial portion of a transaction:
Server to server logon 1 (This is the initial link to the ICN System 100);
Establish Connection with RS VS 11;
Validate Sender Co. Credential from Logon, Establish MCrypt with sender, 12;

Establish Working DS Tree with Current Certification of Sending party, Establish ModularCrypt with System 100, 13;
Secure Pipeline established with Sender and Receiver, 2;
Write Participant LOGON entry, 21.

In one alternative embodiment to the LOGON depicted in FIG. 44, noted above is described as follows. While LOGON is the initial process for establishing what is most often a store-and-forward network with periodic connectivity to the ICN Host (as message requests are transmitted, corroborated and replied), there are occasion, like the ones where and End-User individuals perform their Login onto the ICN network (verified to the ICN HOST in addition to the Login verified to the Remote Validation Sever) or the End-User transmits a text message, like mail, in near real-time via a “chat”-like session when working with a form or document. In cases like these, LOGON can vary to accommodate the near real-time transmission of authentication secrets or connection information.

The LOGON sequence has three component operations between the: Secure Remote Validation Server (RVS) to ICN Host connection; the Secure Remote Application Server (RAS) to RVS; and the Remote Workstation to RVS.

LOGON develops from an active hardware attachment between two devices, e.g. the Remote Validation Server is LOGGED-ON (LOGON) to the ICN Network, such that connection is established with a currently active (usable) cryptography, which can be used to send or receive a message. The connection operates all the way to the remote console of the RVS, where initial server installation has located the secrets of the Company and ICN LOGON software.

The major and initial LOGON is to activate the connection between the RVS and the ICN. This is done on an individual Participant basis, one RVS at a time. However, this does not affect the ability for multiple RAS components to attach to one RVS. An initial LOGON can occur during the installation of the RVS at the Participant site. This uses the cryptographic keys described, above. The process is normally seen to originate with the ICN Host connecting to the RVS, while the Installation Manager(s) are present and able to verify the connection. However, there is no dependence upon the ICN Host initiating the connection, as the LOGON software and Installation Manager(s) can connect to the ICN Host using the LOGON software and a workstation component. Additional cryptographic secrets may be transmitted at that time.

Once the mutually authenticated, connection between the ICN Host System and the RVS is established with an active secret for additional communications security, other connection LOGON(s) can occur, such as, for example, a confirmation of the connection between the RAS and the RVS at the Remote Installation site. This, too, is an alternative embodiment of the LOGON between the ICN Host and the RVS, as it is between two machines with a dedicated connection.

One difference in LOGON component exchanges is that of the Remote Workstation to the Validation Server. LOGON for the workstation can optionally entail continuous configuration management (CCM), as an activity of the Validation Server and as reflected in the service log for the workstation connection. As an electronically enforced policy, the Validation Server can optionally “re-enforce” configuration management, if the workstation should physically LOGOUT and become un-connected to the RVS at anytime.

This process is described as relating to the initial connection of a participant to the NTS before message creation and transmission between a sender and a recipient. However, the same process is used with the sender and recipient reversed when a message is responded to. The responding party will have an appropriate individual authorize the communication, after validating that it came from the Network Transfer System 100.

This process is generic to all communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Secure Login (FIG. 45)

The client-server Login function is performed from the IC participants' workstation and is a required and prerequisite action of the Participant's employee. The client-server Login is then also part of the Identification and Authentication security function and is also part of the Hardware Identification and Authentication security function (see Validation Server Anti-Spoofing, below). The employee participant's Login action provides the appropriate application with an electronic path supported by adequate electronic credentials identifying the employee participant, their application, and the hardware platforms used in sending a message, 3.

A generic script that covers the Login process will now be described. This script provides for a secure Logon of a participant top the NTS 100 and is used whenever a communication with the Network Transfer System is initiated by any client system, whether the communication is related to a commercial portion of a transaction or a financial portion of a transaction:

Session Registration and Authentication for Individual Accountability

The VS recognizing an initial Login from a previously unrecognized participant's workstation, will process the digital identities and invoke IDM processing to determine any previous encounter with the hardware platform. Specific messages can be passed between the IDM subsystems of the VS and the WF engine, enabling further identification processing.

This process is described as relating to the initial connection of a participant to the NTS before message creation and transmission between a sender and a recipient. However, the same process is used with the sender and recipient reversed when a message is responded to. The responding party will have an appropriate individual authorize the communication, after validating that it came from the Network Transfer System 100.

This process is generic to all communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

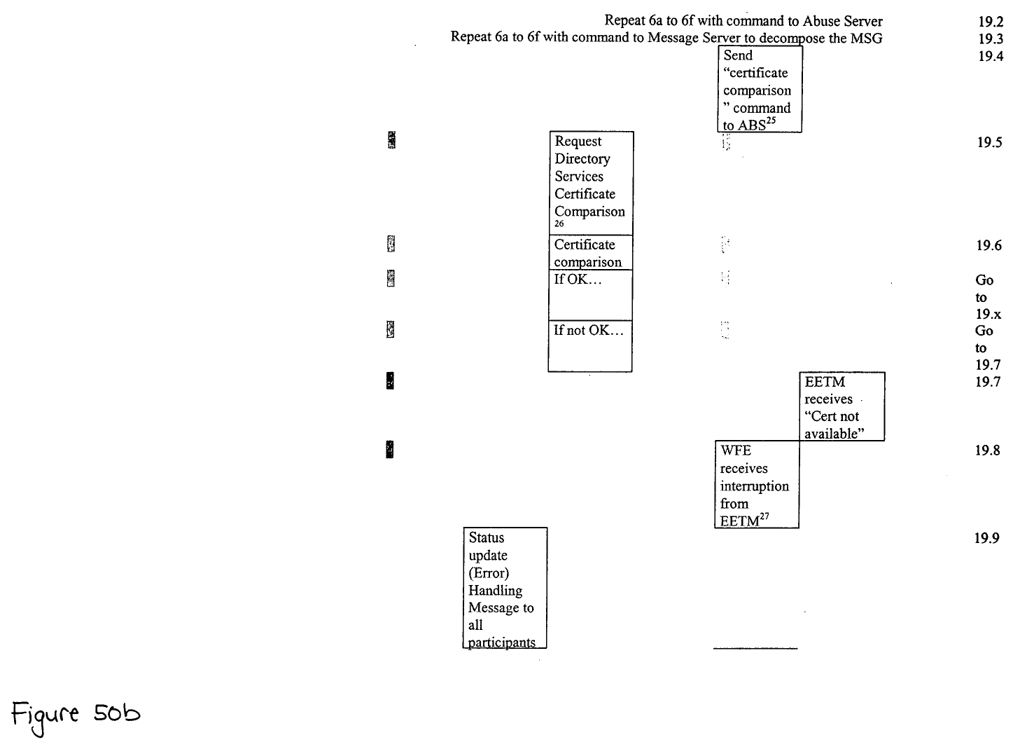

Local Audit File Preparation and Transmission (FIG. 46)

A generic script that covers the basic process for the local audit between a client (either a transaction party or a agent) and the Network Transfer System 100 will now be described. This script provides for the secure creation and transmission of the local audit file to the Network Transfer System. It is used to the Network Transfer System, and are used whenever a communication with the Network Transfer System is initiated by any client system, whether the communication is related to a commercial portion of a transaction or a financial portion of a transaction. The script includes:
Creates Message 4
Local audit (snapshot) once Message ready 5 (The hash of the audit file is created at the workstation and sent to the ITS System 300)
Local audit record stored for transmission on disk, 51 (the header contains the workstation ID, date, time, the application server number, the process workstation, the process application server for response).
WS Audit File to Remote Application Server etc., 52
Application Server, Receive Workstaion Audit file 53
ACK file received 54 (Acknowledgements (ACKs) are written to the WF engine, as part of the objects and TCP to convey that the respondent machine has received the process block (or blocks)).
Store file and track record, 55
Transmit Audit to RVS, 56
Remote Val Server: RECV Application Server Audit, 57
RVS signs audit file and, 58
Transmits, 59
Comments
A record of the entry is independently sent to the ICN Host by the RVS, 5.

The RAS receives the Workstation TTS entry of the message, as it is ready to send this data, it is first captured by the RAS. The data is put in a local yet secure Transaction Tracking System file record. The captured data is referred to as the Audit File Send or Sent.

This particular Audit File is passed to the ICN Host via the RVS.

The RVS begins a TTS cycle of waiting for the reply from the ICN Host, 7.

The RVS accepts messages from the RAS and uses the digital signature of the organization and of the End-User individual to process and encode messages for delivery to the appropriate recipient, which is initially always the ICN Host. The ICN Host determines from both addressing in the message as well as from the recipients certificates, where the message is to be delivered.

TTS in the RVS ensures message delivery by storing a copy of the message in a secure transaction tracking system.

When confirmation of receipt from the ICN Host occurs the RVS will initiate the next cycle WF activity and waiting, 74.

This process is generic to communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

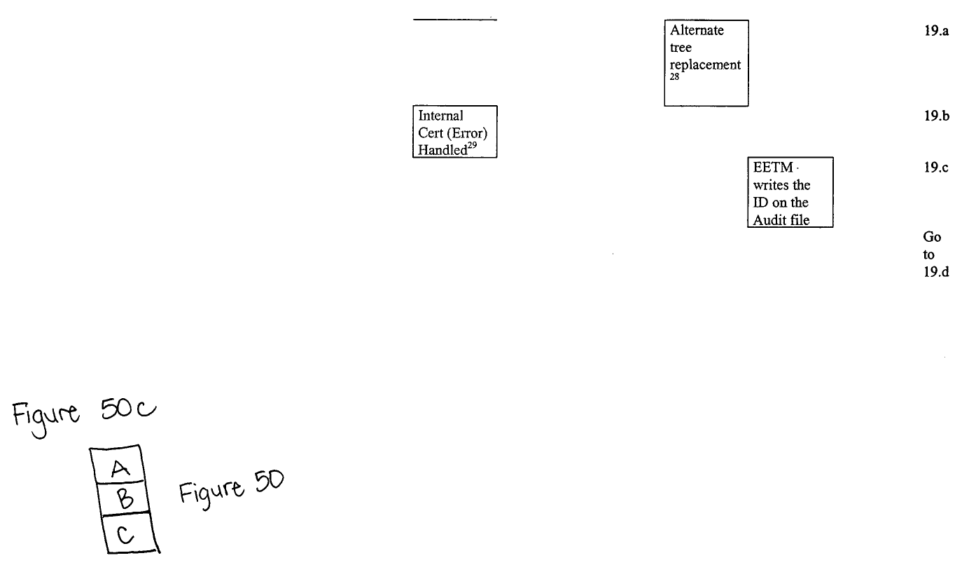

Receipt and Processing of Workstation Audit File—(FIGS. 47-49)

Various system 100 components are arrayed and utilized during the initial Audit File Send Message Acknowledgement to the Participants Remote Site systems. Receipt of the Status Updates generated by the WF Engine at the system 100 Host will be distributed to the other servers.

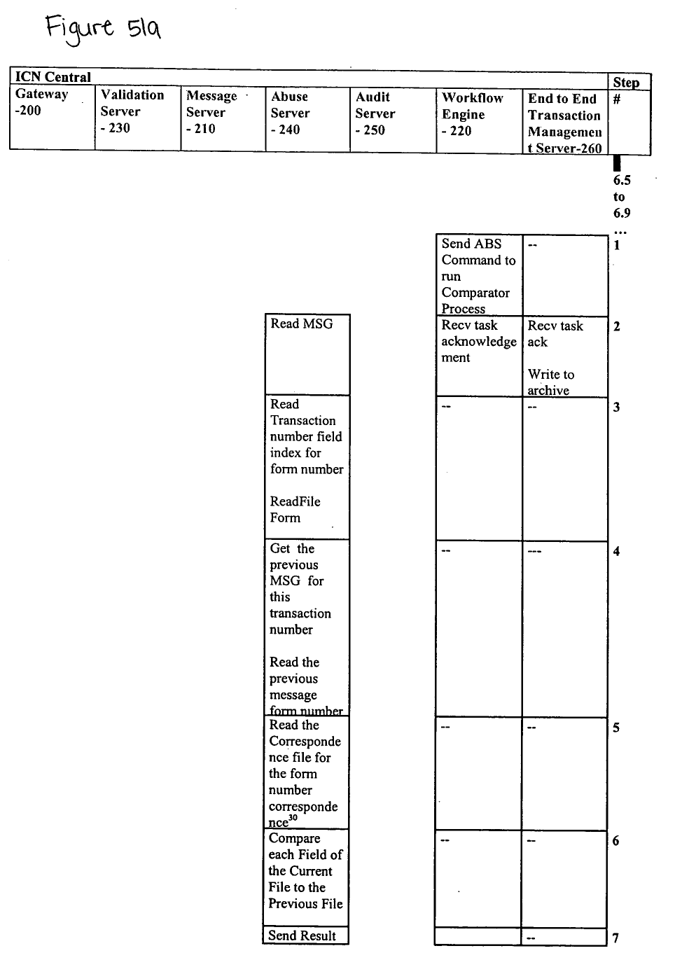

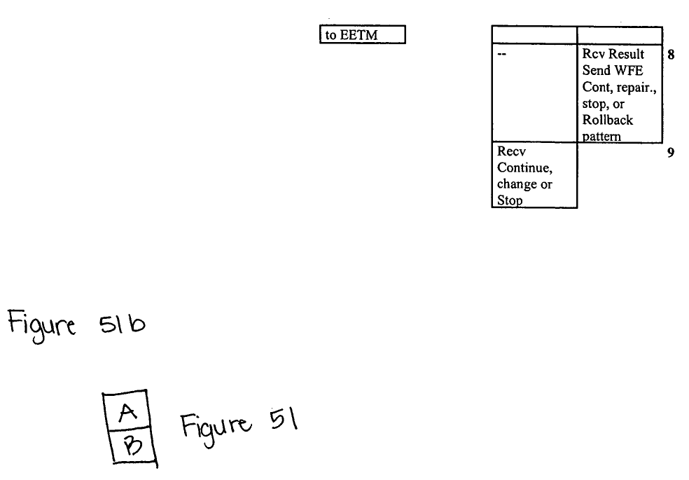

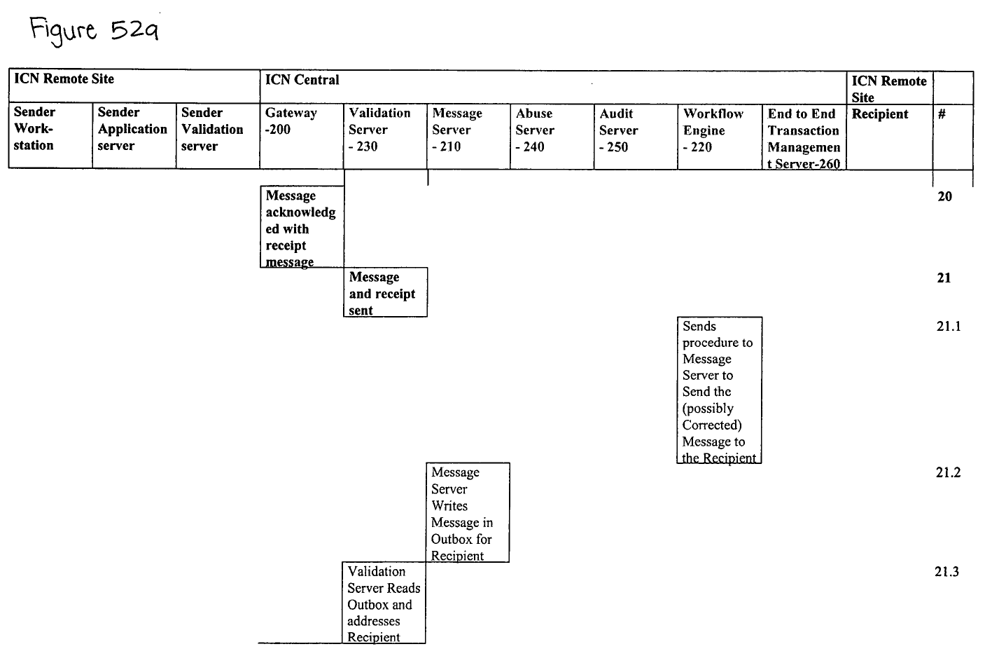

A generic script that covers the basic process for the receipt and the processing of the local Audi File by the Network Transfer System 100 will now be described. This script provides for a secure reception and processing of the Network Transfer System, and is used when a communication with the Network Transfer System is initiated by a client system, whether the communication is related to a commercial portion of a transaction or a financial portion of a transaction.
FIG. 47 shows:
   Transaction initiation
   Receipt of WS audit file, decryption and archiving (this is a combination of ID, transaction management and archival), 6.
   Receipt of Transmission (Message), 61
   Read “transmission” and decrypt organization ID, 62
   Look up at PK certificate, 63
   Validate and extract identity data (IDM), 64
   Write record to Archive (Audit Server), Receive Message and IDM record, Get record, 65
   Identify transaction number if transaction in progress OR initiate a new business process, alert EETM, 66
   If new transaction, give a new transaction number and begin new audit file initiation, 67
   If . . . returns new transaction number to WFE, 68
   If . . . WFE loads the transaction pattern from the OID driven Pattern base (in EETM), 69
(FIG. 48)
   Send Read the inbox command to Message Server and command copy to EETM, 6a
   Receive and acknowledge command and copy acknowledgment to EETM, Read business pattern response file and compare for block #6, and writes to audit, 6b
   Message server process command, Receive MS command acknowledges and writes to audit, 6c
   Message server send response to command to WFE and ACK to EETM
   Roll back possible, 6d
   Receive response to command, Receive MS response and compare for step # and writes to audit, 6e
   Roll back possible, 6f
   Repeat 6a to 6f with command “update status”, 6g
   Encrypt and transmit message (Status update and Echo), 6h
   Transmit to Sender, 6i
   Repeat 6a to 6f with command “distribution list”, 6j (prepares distribution of status update to all participants).
   Repeat 6a to 6f with command “write to outgoing” (distribute status update to all participants), 6k
   Encrypt and transmit message (Status update), 6l
   Transmit to Participants, 6m
(FIG. 49)
   Display (Audit file snapshot) Message, Accept or Cancel (or go back), 6n
   Response received, 6o
   Encryption and transmission of response if accepted, 6p
   Repeat 6a to 6m, 6q

In Message Reception, Transaction Initiation, and new messages, are determined via IandA. If there is no StepNumber available from the IandA information, the WF Engine is notified then to determine the Process (step number start) from the IandA materials. However, independent notifications of a new message arrival are also considered, as they can or can not be consolidated under the WF and EETM Components.

The VS receives messages and validates their origin and type to the WF engine, 6.

Acknowledging the Audit File Send message: The sequence is based upon The Accept option taken at the workstation.

A message is originated by the participant workstation. The Audit File Send had returned without errors. The workstation program acknowledges receipt. Organization Employee (representative) reviews the message returned. Here, the Organization Employee (representative) Accepts the returned information as correct, 60.

This process is generic to all communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

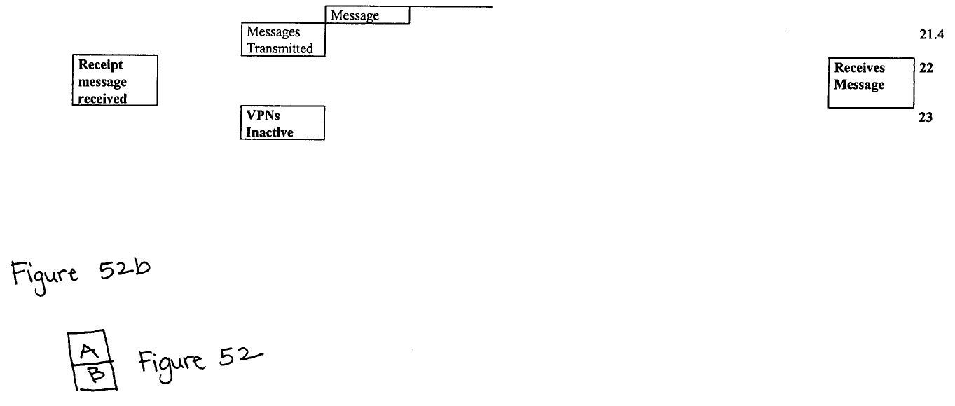

Message Decryption and Data Integrity Resolution, Identity Management, Identity Abuse Management (FIG. 50)

A generic script that covers the basic process for the message decryption and multilevel security checks between a client (either a transaction party or a agent) and the Network Transfer System 100 will now be described. This script provides for data integrity resolution, identity management, identity abuse management by the Network Transfer System, and is used whenever a communication with the Network Transfer System is initiated by any client system, whether the communication is related to a commercial portion of a transaction or a financial portion of a transaction. FIG. 50 shows:
Encrypted Message and container received, 18
Message container decryption and envelope data integrity resolution, Message decryption via hash comparison, 19
and write data to audit comparison (instead of data audit comparison completed), 19.0
Write Transaction number, unencrypted MSG and ID to Inbox, 19.1
Repeat 6a to 6f with command to Abuse Server, 19.2
Repeat 6a to 6f with command to Message Server to decompose the MSG, 19.3
Send “certificate comparison” command to ABS (similar to [6a, 6f] procedure) 19.4
Request Directory Services Certificate Comparison 19.5
Certificate comparison, 19.6
If OK, Go to 19.x
If not OK, Go to 19.7
EETM receives “Certification not available”, 19.7
WFE receives interruption from EETM (tells EETM [OID]: Trans to Write an Exception to the [OID]: TRANS Table for the TrXNumber entry. Has the WF insert an ERROR Handling Routine at the outset of processing to use a modification in the BP Table. Initiates a series of msg [UPDATE . . . ] activities 1^{st} notifying Participants of new [missing] Cert, then of Processing of the new cert), 19.8
Status update (Error) Handling Message to all participants, 19.9
Alternate tree replacement (duplicates the BU or OU from which the current [Co or End-User] Cert is derived, Note: the routines should be robust to handle changes in the CO certs the BU=CO certs and variation below), 19.a
Internal Certification (Error) Handled (differentiates between cert not found and cert non-equal, messages to EETM and sets flags), 19.b
EETM writes the ID on the Audit file, 19.c
Go to 19.d

This process is generic to communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

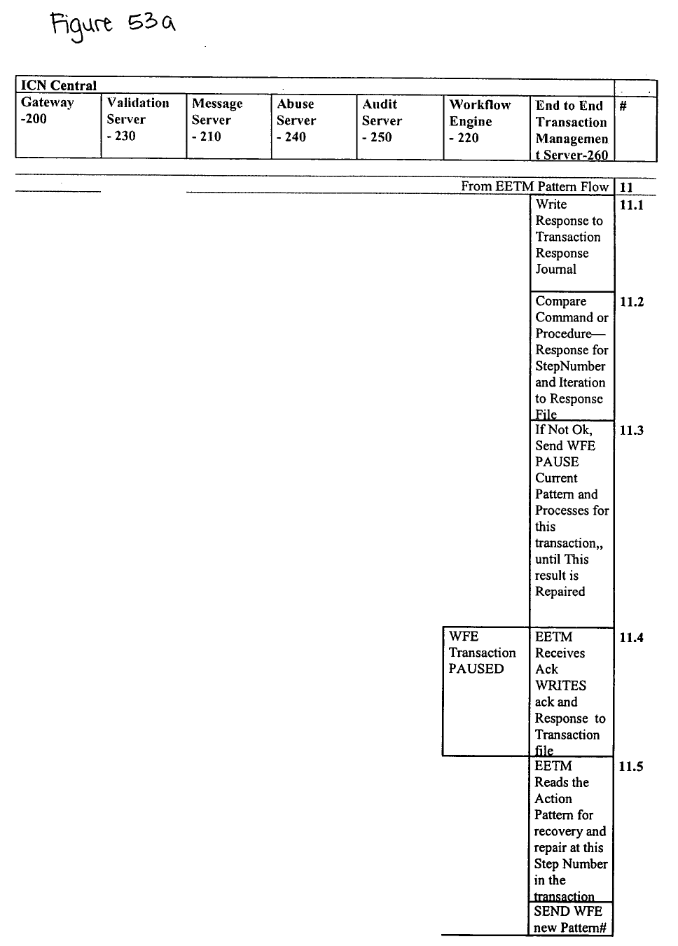

Message Content Comparison for Abuse and Audit Management (FIG. 51)

A generic script that covers the basic process for message content checks will now be described. This script provides for abuse and audit management and is used whenever a communication with the Network Transfer System is initiated by any client system, whether the communication is related to a commercial portion of a transaction or a financial portion of a transaction. FIG. 51 shows:

Do Previous blocks 6.5 to 6.9

Send ABS Command to run

Comparator Process, 1
Read MSG, Receive task acknowledgement, Receive task acknowledgment, Write to archive, 2
Read Transaction number field index for form number, ReadFile Form, 3
Get the previous MSG for this transaction number, Read the previous message form number, 4
Read the Correspondence file for the form number correspondence (File Correspondence, contains the 1 to n correspondence and what Result to send to EETM. EETM makes the decisions on what is right or not—NOT ABS or WFE), 5
Compare each Field of the Current File to the Previous File, 6
Send Result to EETM, 7
Receive Result, Send WFE
Continue, repair, stop, or Rollback pattern, 8
Receive Continue, change or Stop, 9

This process is generic to communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

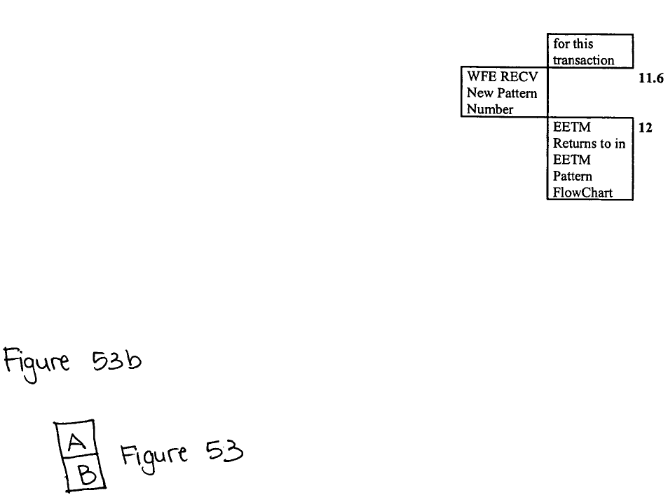

Message Transmission to Receipt and Acknowledged with Receipt (FIG. 52)

A generic script that covers the basic process for message transmission to recipient and acknowledged with receipt will now be described. This script provides for acknowledgements that are used whenever a communication with the Network Transfer System is initiated by any client system, whether the communication is related to a commercial portion of a transaction or a financial portion of a transaction. FIG. 52 shows:
Message acknowledged with receipt message, 20
Message and receipt sent, 21
Sends procedure to Message Server to Send the (possibly Corrected) Message to the Recipient, 21.1
Message Server Writes Message in Outbox for Recipient, 21.2
Validation Server Reads Outbox and addresses Recipient Message, 21.3
Messages Transmitted, 21.4
Receipt message received, Receives Message, 22
VPNs Inactive, 23

This process is generic to communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

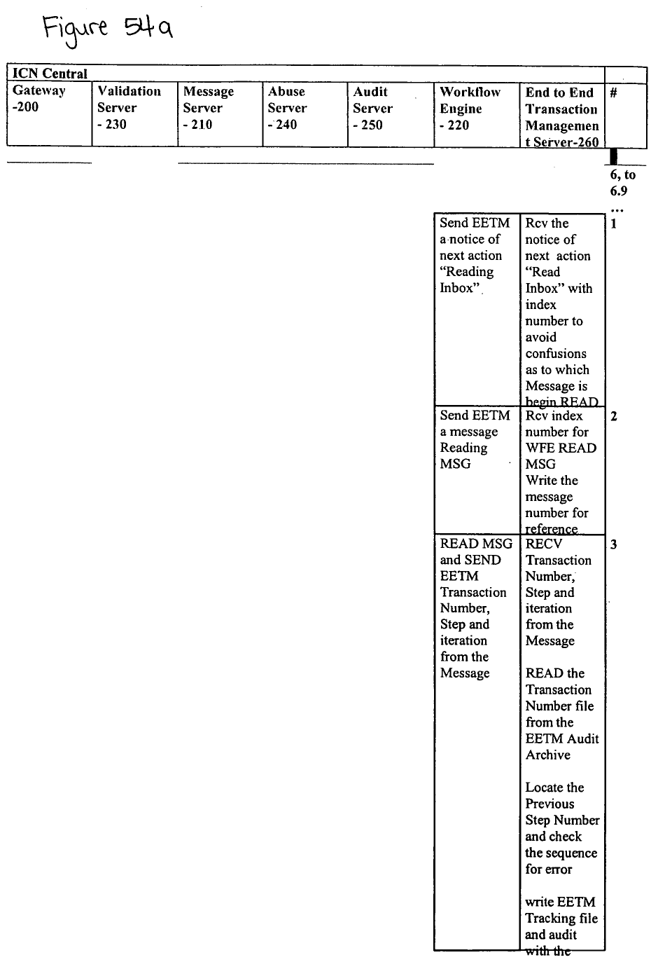

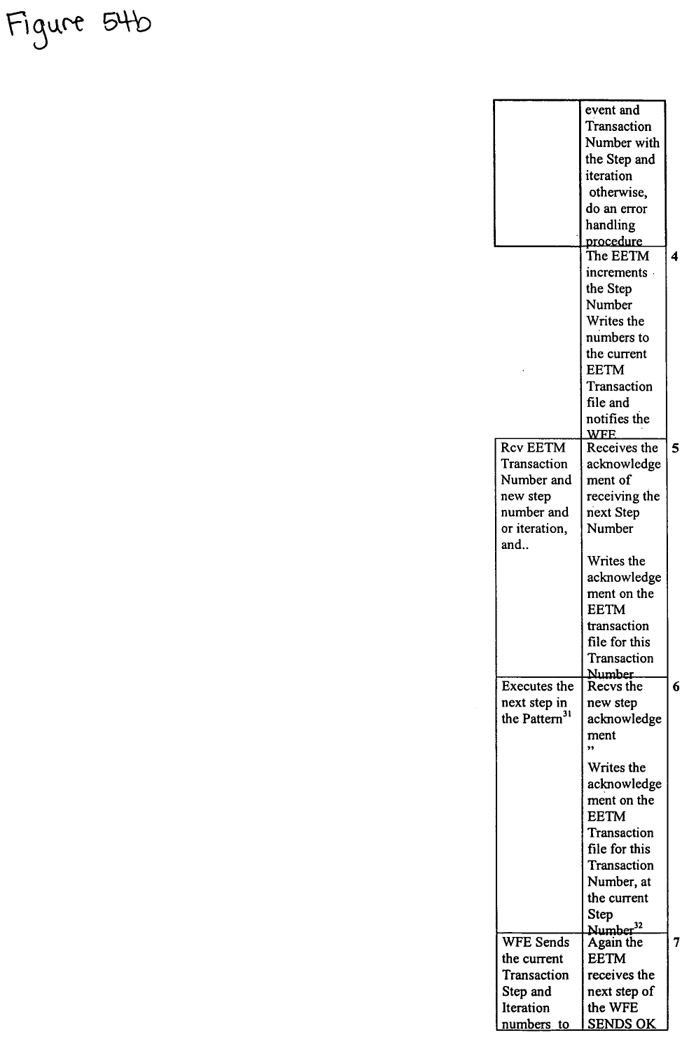

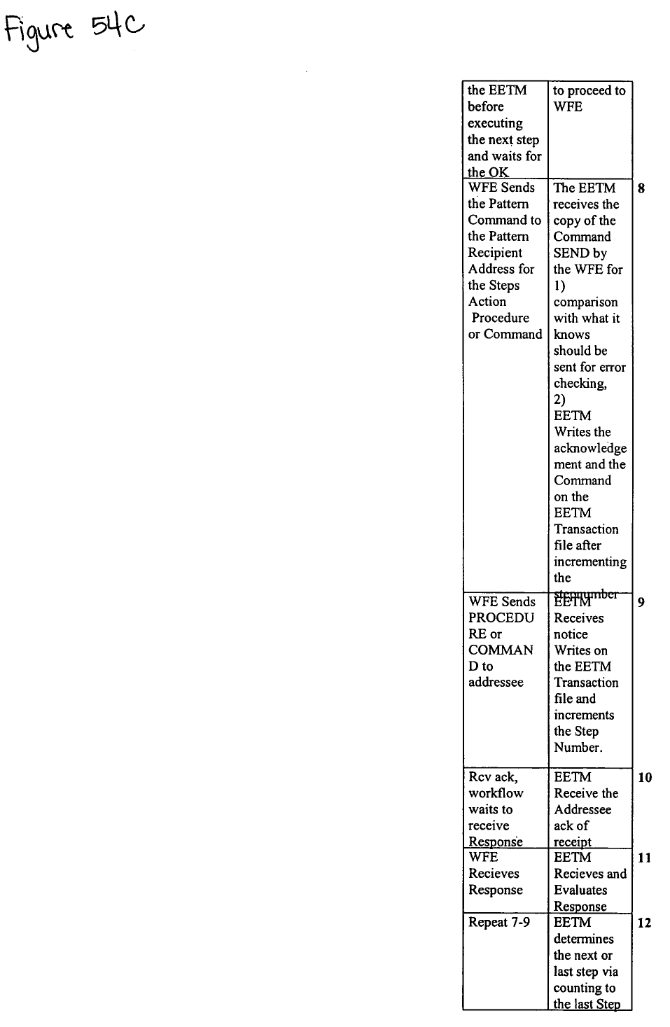

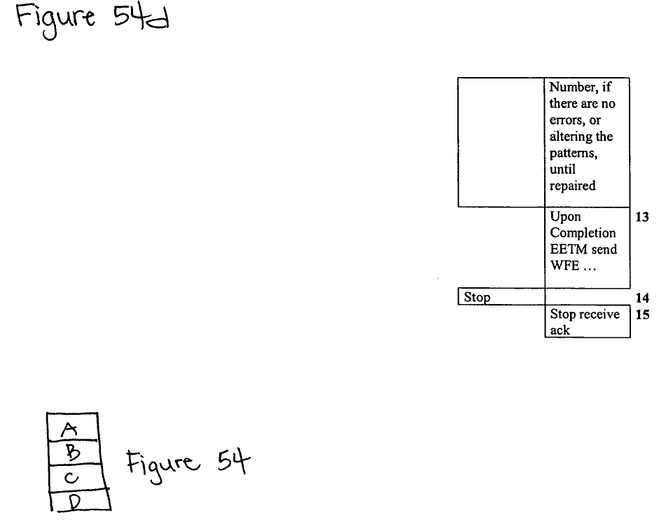

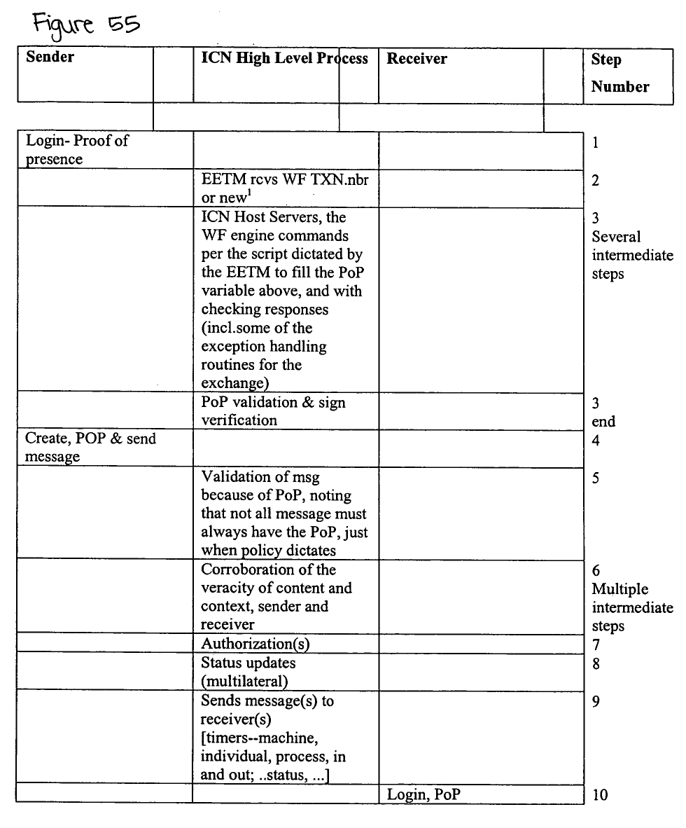

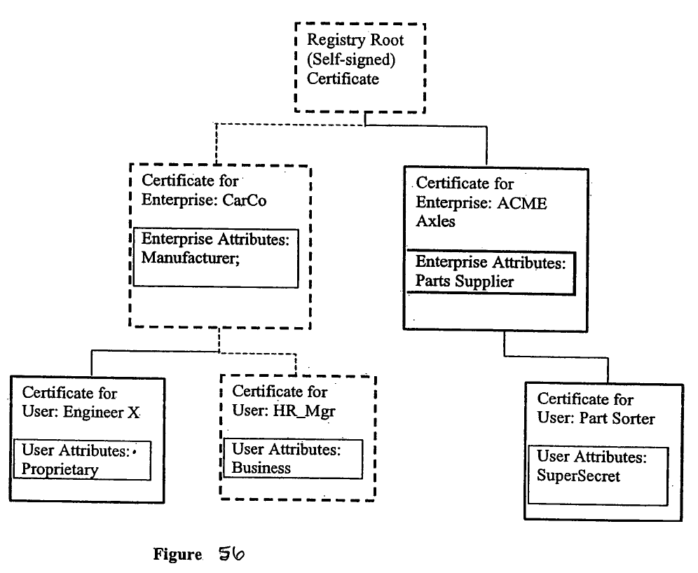

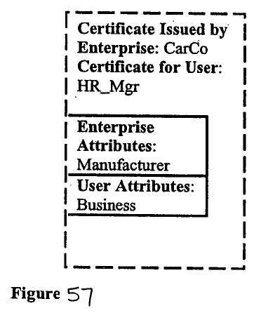

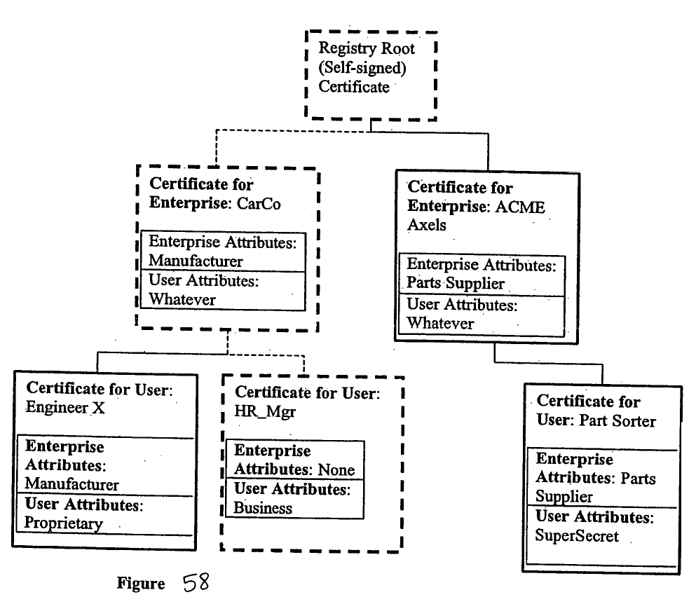

Pattern Execution and Response (FIG. 53)

A generic script that covers the basic process for pattern execution and response flow will now be described.
From EETM Pattern Flow, 11
Write Response to Transaction Response Journal, 11.1
Compare Command or Procedure—Response for Step Number and Iteration to Response File, 11.2
If Not Ok, Send WFE PAUSE Current Pattern and Processes for this transaction, until This result is Repaired, 11.3
WFE Transaction PAUSED, EETM Receives Ack WRITES ack and Response to Transaction file, 11.4
EETM Reads the Action Pattern for recovery and repair at this Step Number in the transaction, 11.5
SEND WFE new Pattern number for this transaction, WFE RECV, New Pattern Number 11.6
EETM Returns to EETM Pattern Flowchart, 12

This process is generic to all communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Pattern Receipt and Response (FIG. 54)

A generic script that covers the basic process for pattern adherence monitoring will now be described. This script provides for pattern reception, analysis and response generation and are used whenever a communication with the Network Transfer System is initiated by any client system, whether the communication is related to a commercial portion of a transaction or a financial portion of a transaction. FIG. 54 shows:
Do Previous blocks 6, to 6.9
Send EETM a notice of next action “Reading Inbox”, receive the notice of next action “Read Inbox” with index number to avoid confusions as to which Message is begin READ, 1
Send EETM a message Reading MSG, Receive index number for . . .
WFE READ MSG, Write the message number for reference, 2
READ MSG and SEND EETM Transaction Number, Step and iteration from the Message, RECV Transaction Number, Step and iteration from the Message, READ the Transaction Number file from the EETM Audit Archive, Locate the Previous Step Number and check the sequence for error, write EETM Tracking file and audit with the event and Transaction Number with the Step and iteration otherwise, do an error handling procedure, 3
The EETM increments the Step Number Writes the numbers to the current EETM Transaction file and notifies the WFE, 4
Receive EETM Transaction Number and new step number and or iteration, and Receives the acknowledgement of receiving the next Step Number, Writes the acknowledgement on the EETM transaction file for this Transaction Number, 5
Executes the next step in the Pattern, Receives the new step acknowledgement, Writes the acknowledgement on the EETM Transaction file for this Transaction Number, at the current Block Number, 6
WFE Sends the current Transaction Step and Iteration numbers to the EETM before executing the next block and waits for the OK, Again the EETM receives the next step of the WFE SENDS OK to proceed to WFE, 7
WFE Sends the Pattern Command to the Pattern Recipient Address for the Steps Action Procedure or Command, The EETM receives the copy of the Command SEND by the WFE for comparison with what it knows should be sent for error checking,
EETM Writes the acknowledgement and the Command on the EETM Transaction file after incrementing the block number, 8
WFE Sends PROCEDURE or COMMAND to addressee, EETM Receives notice
Writes on the EETM Transaction file and increments the Block Number 9.
Receive ACK, workflow waits to receive Response, EETM Receive the Addressee ACK of receipt, 10
WFE Receives Response, EETM Receives and Evaluates Response, 11.
Repeat 7-9, EETM determines the next or last step via counting to the last Step Number, if there are no errors, or altering the patterns, until repaired, 12.
Upon Completion EETM send WFE 13.
Stop, 14.
Receive Stop ACK, 15.

This process is generic to all communications through the Network Transfer System 100, and is used whenever a communication with legally binding significance is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Login, Proof of Presence (FIG. 55)

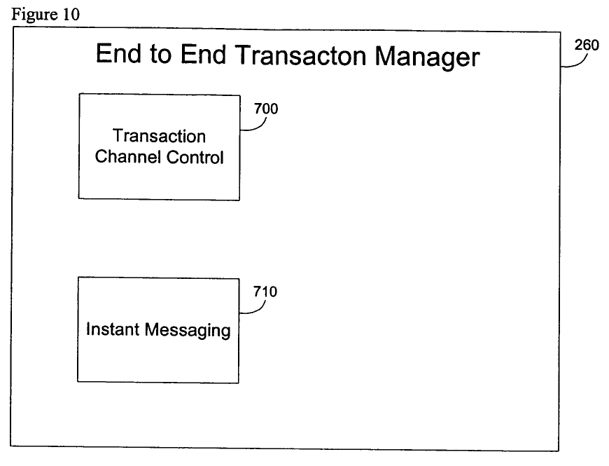

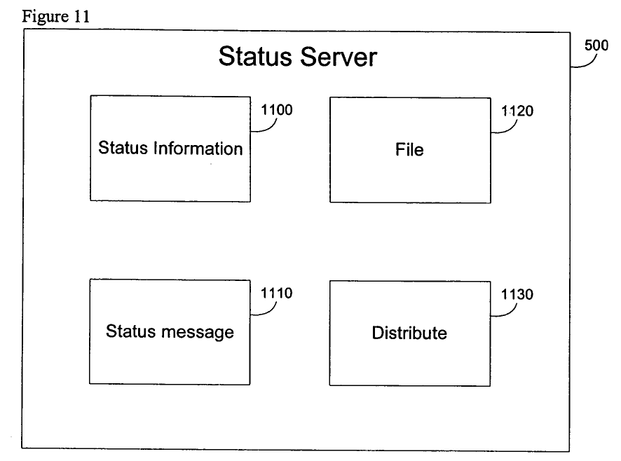

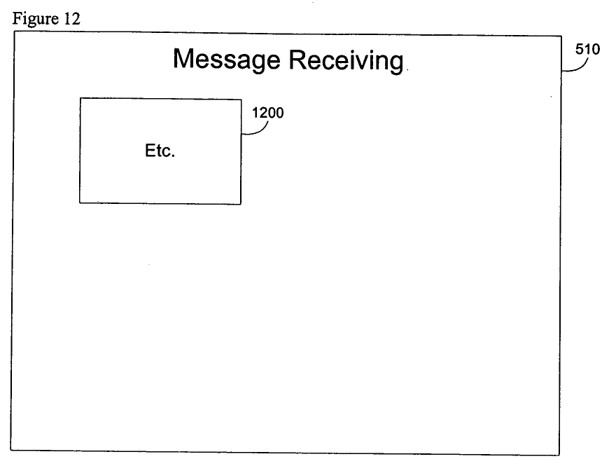

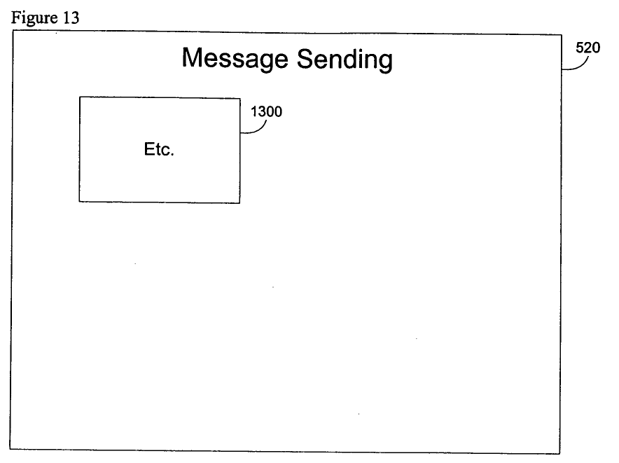

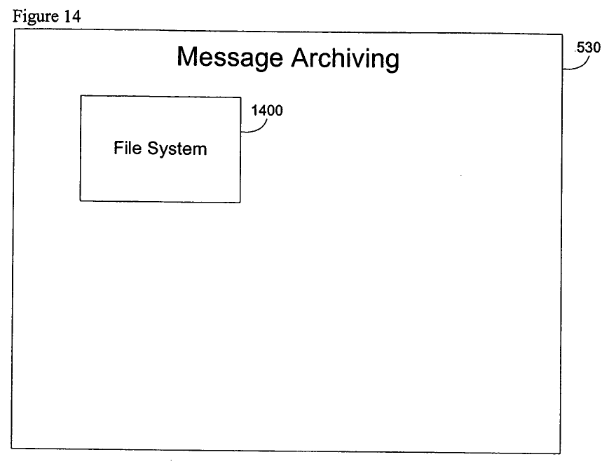

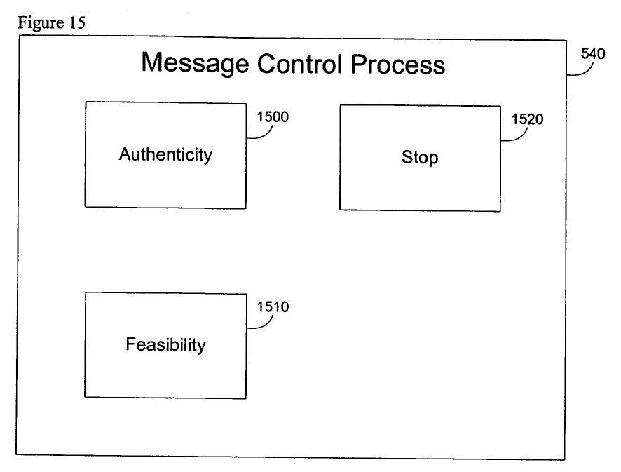

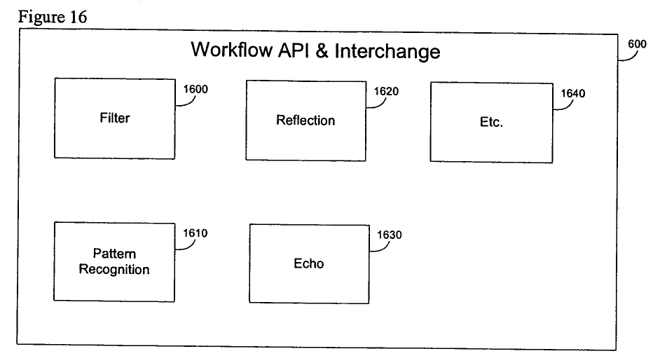

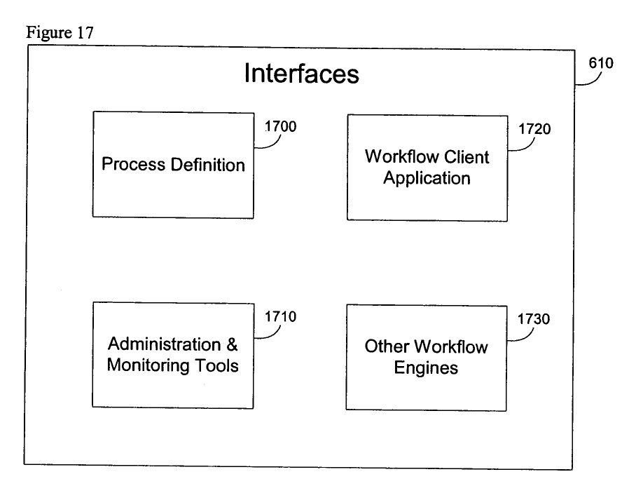

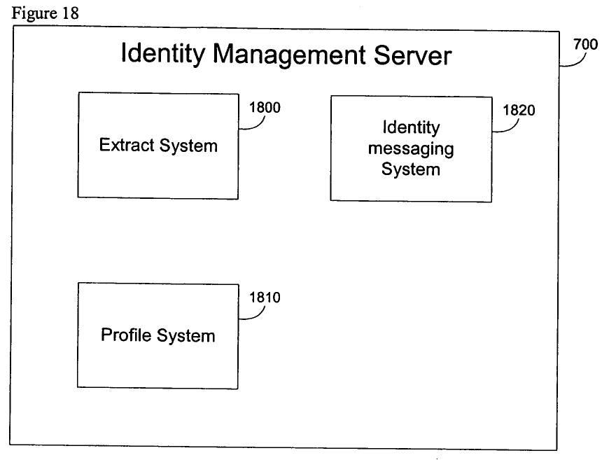

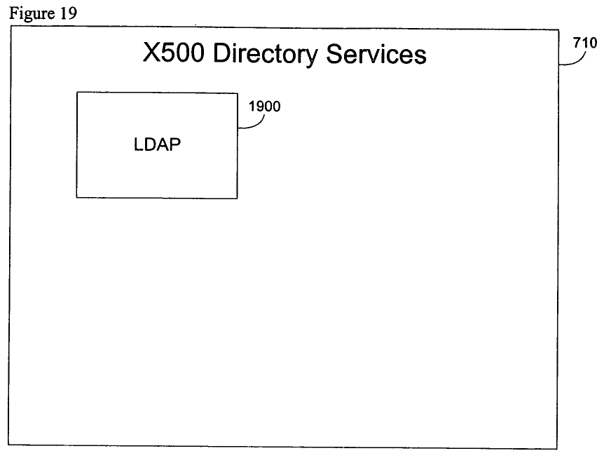

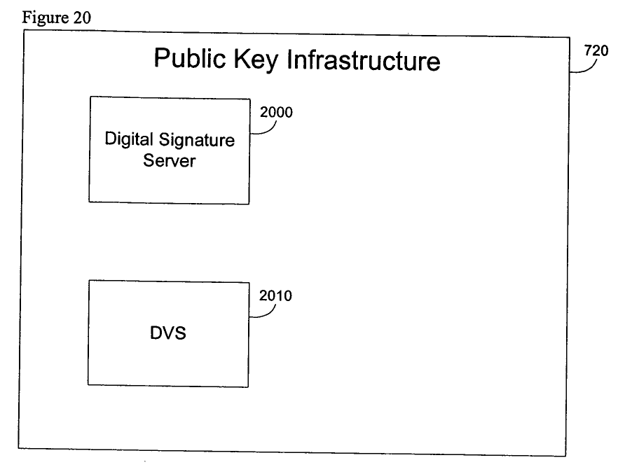

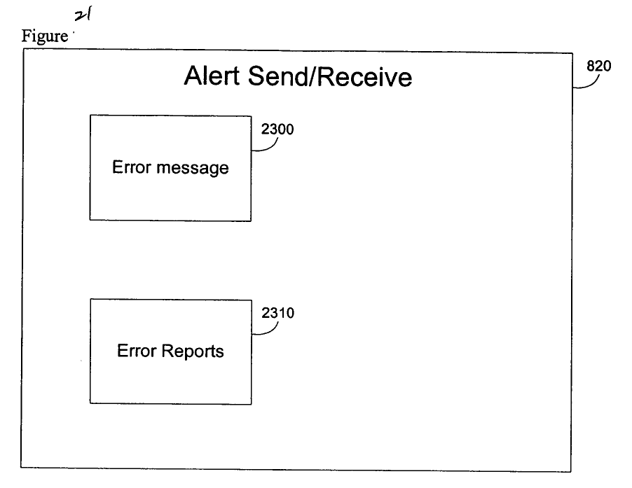

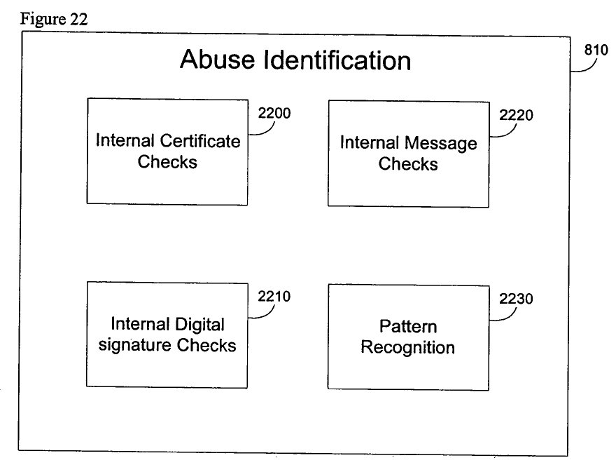

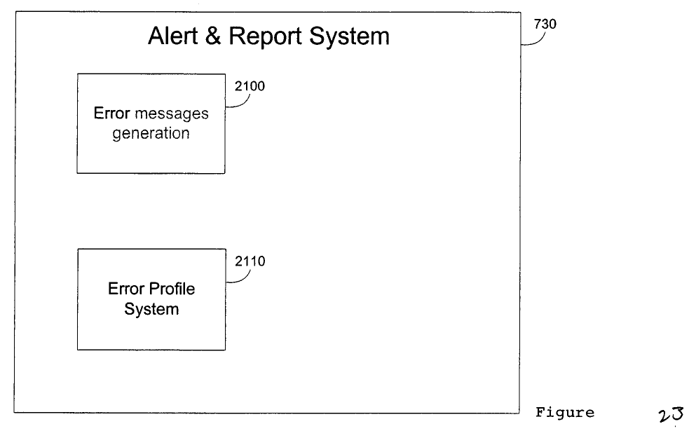

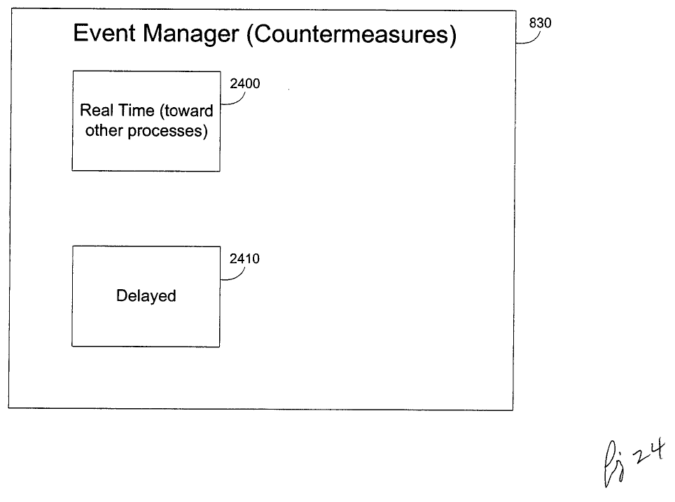

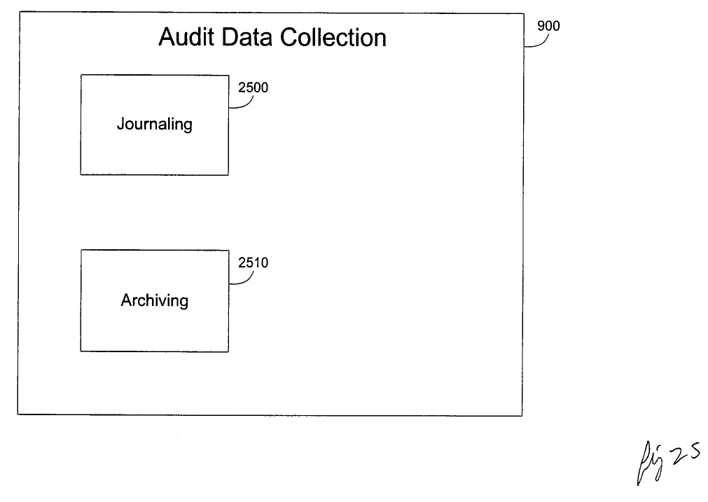

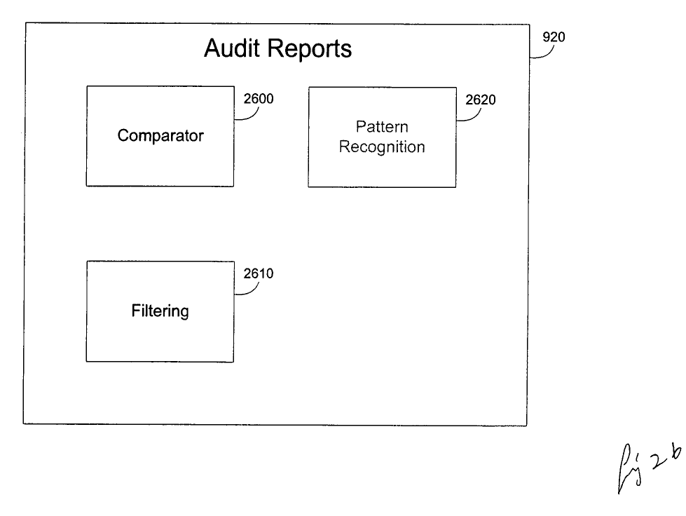

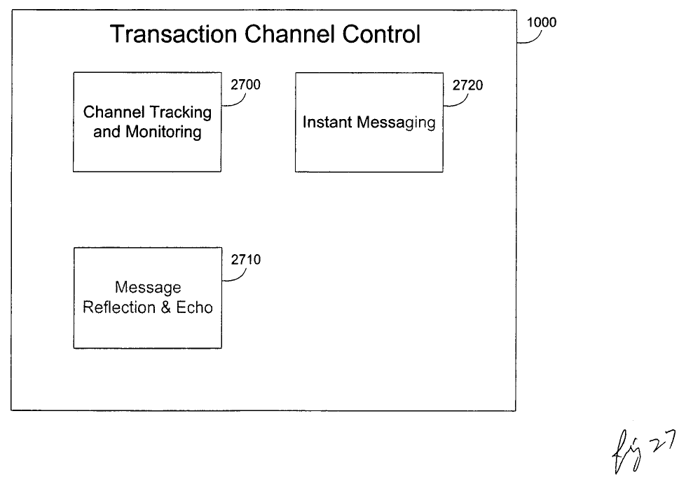

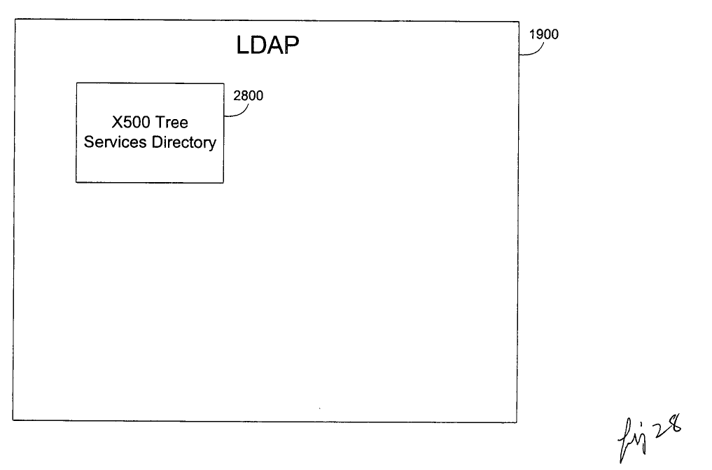

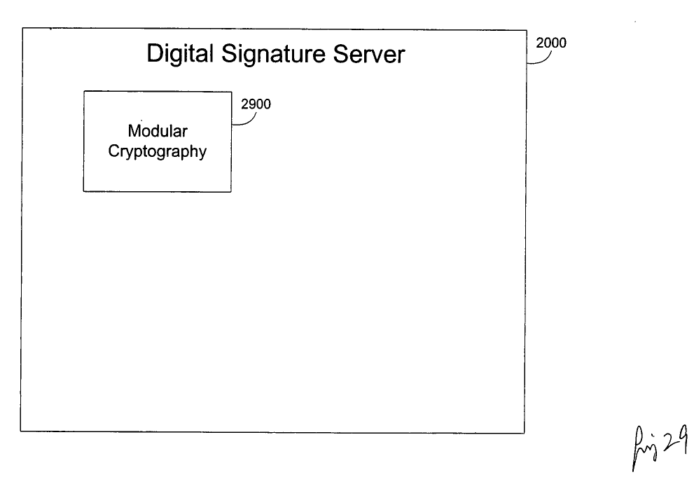

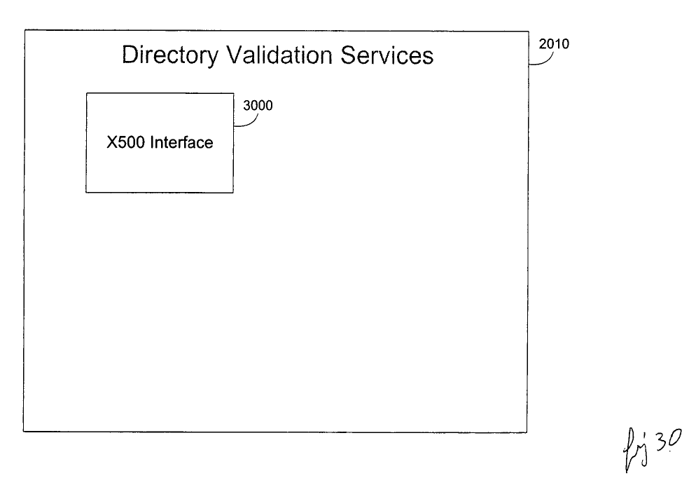

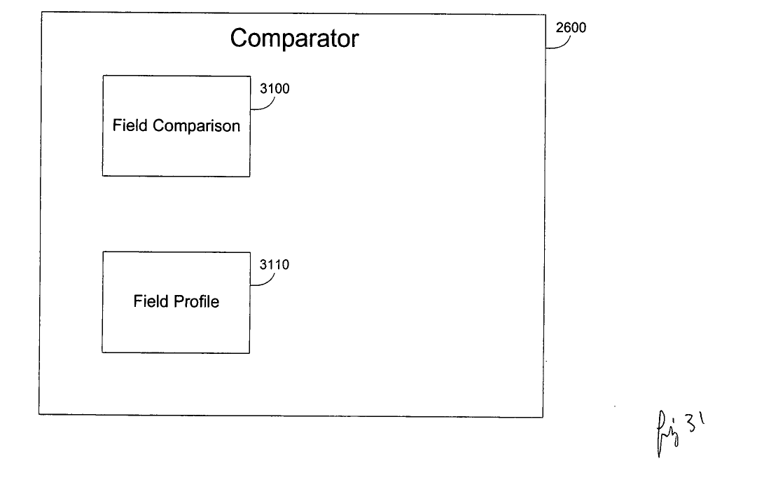

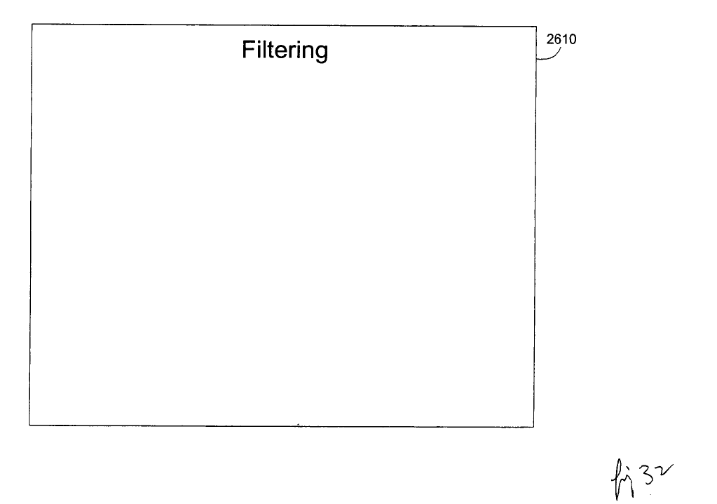

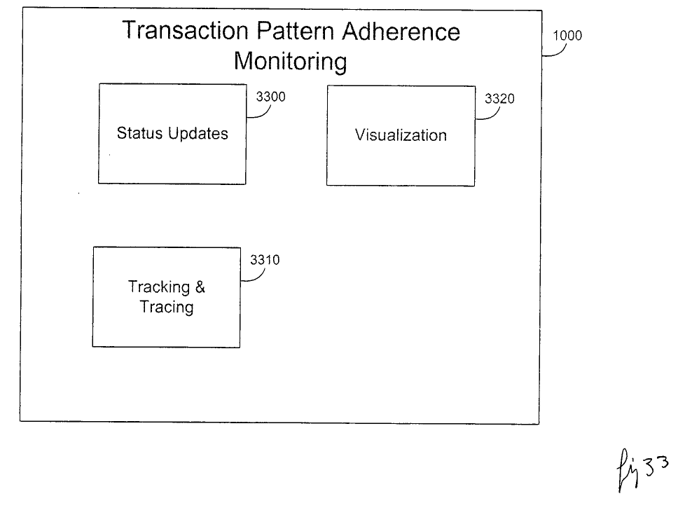

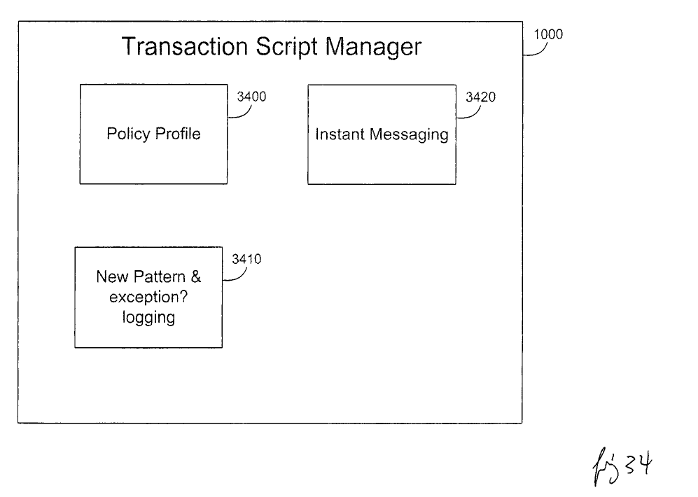

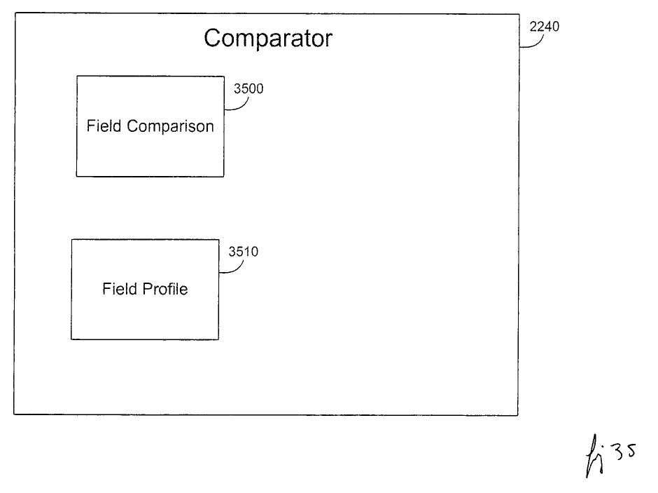

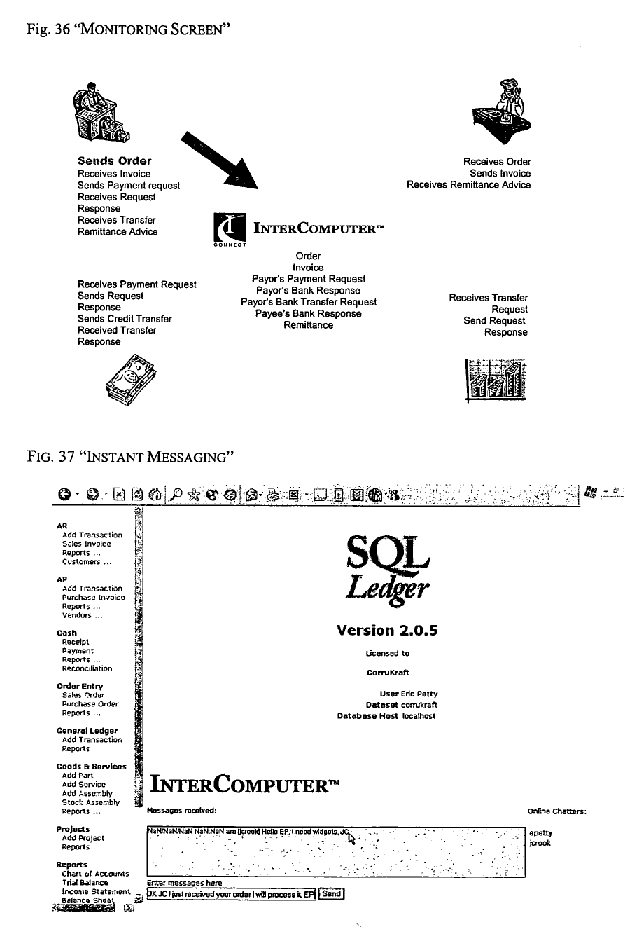

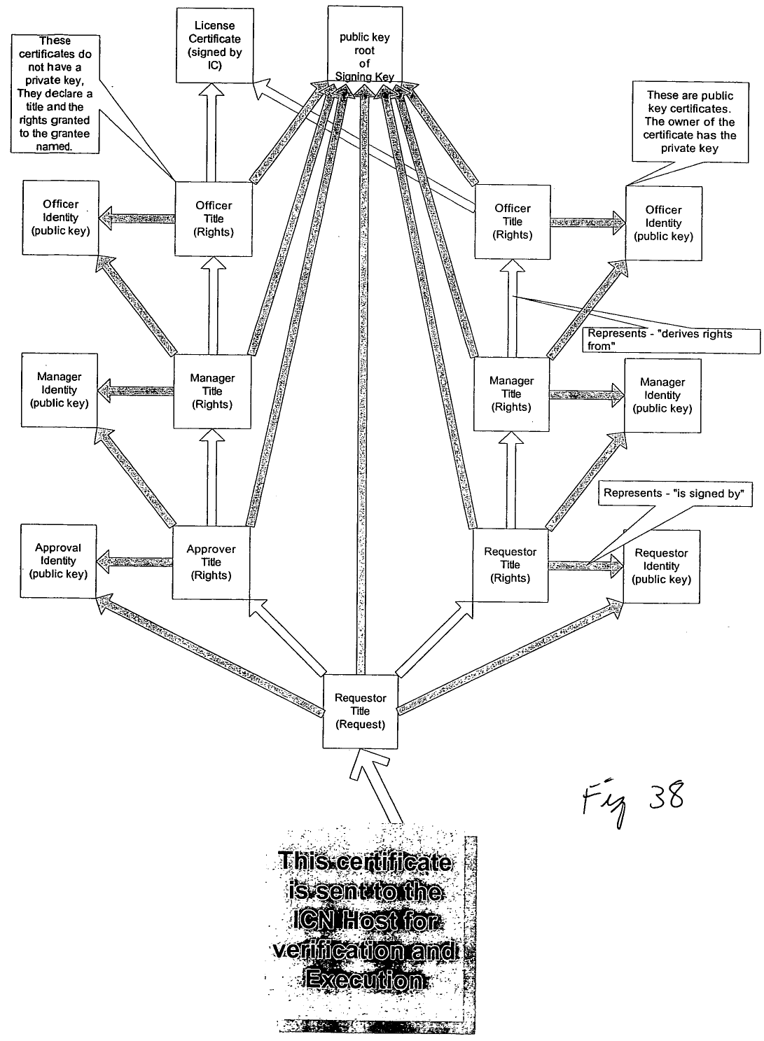

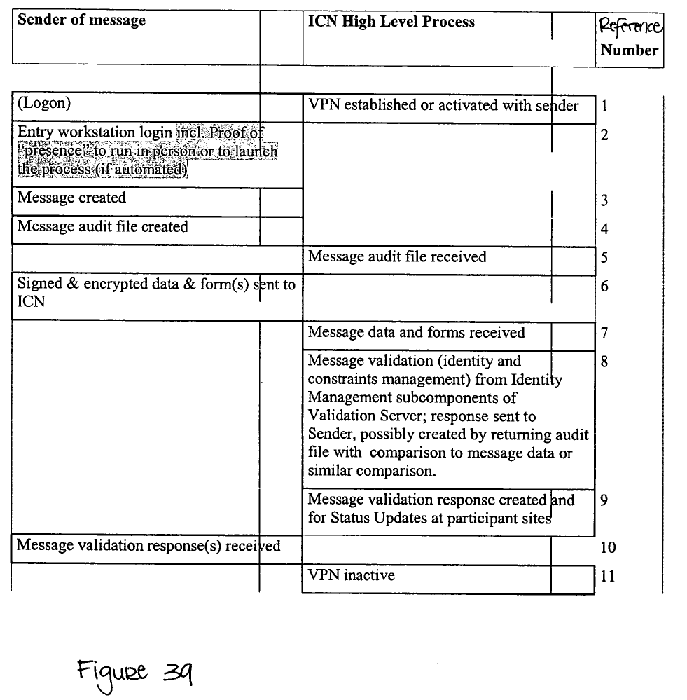

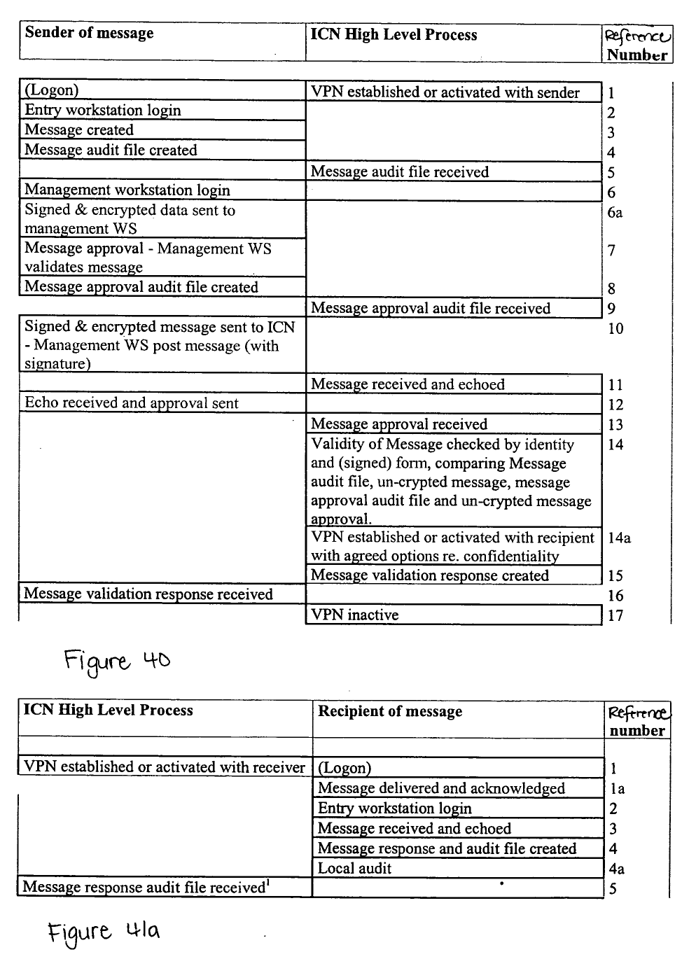

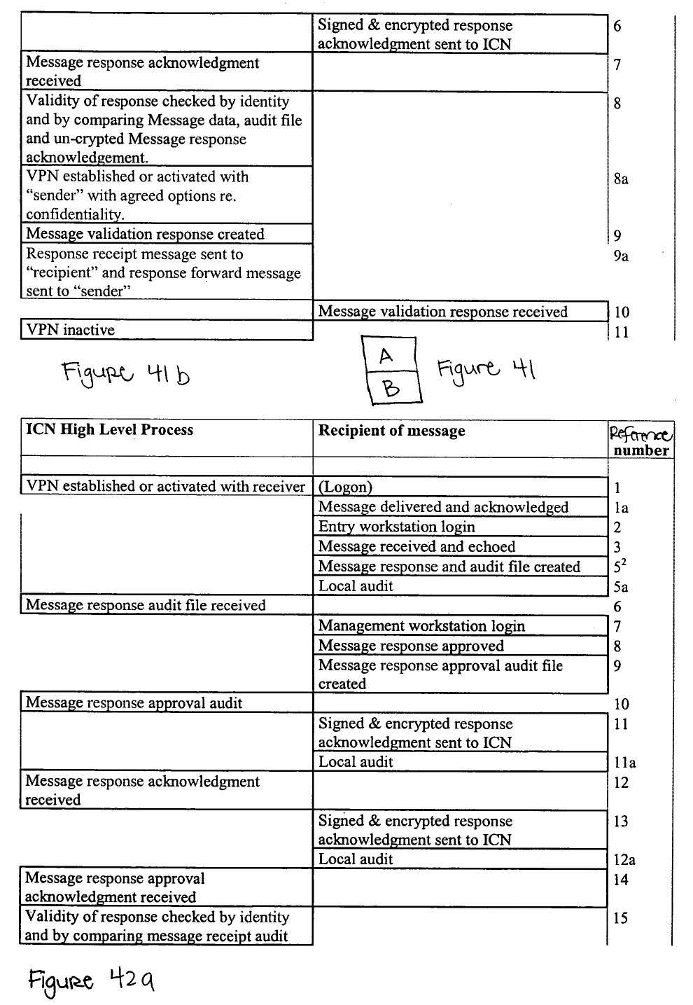

A generic script that covers the basic process for Login and the proof of presence will now be described. This script provides for the secure recognition of actual presence of a participant when he or she connects to the network). This process is run by the End to End Transaction Management of FIG. 10. FIG. 55 shows:
Sender's Login—Proof of presence, 1
EETM rcvs WF TXN.nbr or new (The differentiation that points to where in the process or which step number is to be found and the readnext would be diverted to handle that the individual needs to do POP and fill that variable for End-to-ICN Login confirmation, then EETM would direct WF to do the next step), 2
ICN Host Servers, the WF engine commands per the script dictated by the EETM to fill the PoP variable above, and with checking responses (incl.some of the exception handling routines for the exchange), 3 Several intermediate blocks
PoP validation & sign verification, 3 end
Create, POP & send message, 4
Validation of msg because of PoP, noting that not all message must always have the PoP, just when policy dictates, 5
, Corroboration of the veracity of content and context, sender and receiver, 6 Multiple intermediate blocks
Authorization(s), 7
Status updates (multilateral), 8
Sends message(s) to receiver(s) [timers—machine, individual, process, in and out; . . . status, . . . ], 9
Receiver's Login, PoP, 10

This process is generic to communications through the Network Transfer System 100, and is used when a secure is made between the parties. In addition to the validation and digital signature processes which are described, it should also be understood that encryption can be used as appropriate to further secure the contents of the messages being exchanged if this is desired. The details of the particular encryption scheme can be varied as needed, and do not effect the overall operation of the systems described herein.

Integrity Responsibility

The Network Transfer System is only responsible for the accuracy of the data it provides, and the reliability of the authenticated documents that it stores and delivers. By acting as a data delivery and authentication service, the Network Transfer System is able to forward the appropriate transfer requests and confirmations quickly, without having to perform any of its own checking as to the data being transferred. Thus, in one embodiment, liability for the accuracy of the data transferred (e.g., account balance of sending party) rests with the sending and receiving parties, not with the NTS.

The data issues (e.g., commercial and financial accounts) are handled by the receiving parties and agents themselves accordingly, and only the results of the transactions into and out of those accounts are forwarded through the transfer network system. In this way, the Network Transfer System need not vouch for the validity of the transferred data itself, but rather only for the validity of the request being made via the electronic instrument.

By vouching for the validity and authenticity of the requests, the Network Transfer System provides a level of trust to the automated communications between participants e.g. between the agents when requesting and confirming he payment and transfer of funds.

In the case of payments, this trust is normally generated by having agents either intermediate their transactions through a trusted third institution such as a clearing house (such as a Federal Reserve Agent in the case of banking), or by having one of the agents have an account with the other.

The system described herein reinforce the trust mechanisms. The appropriate level of trust in the transaction instruments is backed by the authentication system and the ability of the agent to digitally verify the authenticity of the transfer documents in real time and in an automated manner by having these documents created and signed electronically.

The Network Transfer System 100 provides merely a trusted communications system for the participants. The participants can transact with trust in the documents used to initiate and validate the transfer. This is possible because the authentication documents stored by the Network Transfer System are able to be used to support the legitimacy of any transfer if required after the fact. In addition, by vouching for the validity and authenticity of the requests and responses, the Network Transfer System provides a level of trust to the automated communications between the participants when requesting and confirming the transaction incl. payment and transfer of funds. This allows a state of finality to be reached in real-time. Finality is the state where there are no remaining obstacle to final settlement of transaction (e.g., there is a good faith belief by both sides that the is legitimate; there is no reason to suspect that the transaction are repudiated by one or the other party; there is a legal basis for compelling the to occur in the even the transferor refuses).

Furthermore the systems described herein reinforce the trust mechanisms. The appropriate level of trust in the transaction instruments is backed by the authentication system and the ability of the participants to digitally verify the authenticity of the transfer documents in real-time and in an automated manner by having these documents created and signed electronically.

The use of the network transfer system can also avoid any liability associated with repudiated transactions as it significantly reduces the possibility of a repudiated transaction. For instance, a transaction will not proceed from one step to the next unless the former step has been validated and approved by the authorized person and/or its compliance to agreed procedures and values (limits) has been automatically checked.

By setting up a system in which the electronic instruments of transaction can be relied upon to the same degree as the physical tokens associated with ordinary fund transfer, it becomes possible to allow the participants to maintain their ordinary responsibility for the transaction, while allowing the operator of the Network Transfer System 100 to only be liable for the integrity of the data received and sent, and the reliability of the authenticated documents stored and delivered.

By acting as a data delivery and authentication service, the Network Transfer System is able to forward the appropriate transfer requests and confirmations immediately, without having to perform any of its own checking as to the viability of the accounts held with the agents. The financial accounts are handled by the agents themselves, and only the results of the transactions into and out of those accounts are forwarded through the transfer network system.

In classical systems, the validation of the transfers calls for feedback, which leads to greater delay and overhead processing time. The described systems and techniques enable agents to settle transactions in one pass thus getting rid of “multipass” overheads and, again, reducing the time to reach the confirmation of the transaction (e.g., final settlement).

In this way, the agents can transact with trust in the documents used to initiate the transfer. The Network Transfer System provides merely a trusted communications system for the agents, rather than a trusted financial account. This allows for the transactions to settle with finality in real time, and provides for non-repudiation of the transfers, without the overhead of third parties or intermediary agents, as are used in many other systems.

In addition, the authentication documents stored by the agent and by the Network Transfer System can be used to support the legitimacy of any transfer if required.

Furthermore, the skilled artisan will recognize the interchangeability of various features from different embodiments. For example, variations in the authentication protocols used by the Network Transfer System and client can be combined with systems in which encryption is applied to more fully protect the messages in transit across the Internet. These various aspects of the system design and its associated processes, as well as other known equivalents for any of the described features, can be mixed and matched by one of ordinary skill in this art to produce other architectures, devices and techniques in accordance with principles of the disclosure herein.

Although these techniques and systems have been disclosed in the context of certain embodiments and examples, it are understood by those skilled in the art that these techniques and systems can be extended beyond the specifically disclosed embodiments to other alternative embodiments and/or uses and obvious modifications and equivalents thereof. Thus, it is intended that the scope of the systems disclosed herein disclosed should not be limited by the particular disclosed embodiments described above, but should be determined only by the scope of the claims that follow.

### APPENDIX A

Introduction

A public key infrastructure (PKI) can provide some amount of security for E-Commerce. But, can a PKI meet the technical and administrative requirements for scalability while meeting business needs for interoperability and liability allocation as daily transactions grow to an order of hundreds of millions of dollars? The current PKI solutions are only “stovepipes.” They are not scalable. They are not interoperable, and their applicability to global B2B E-Commerce is in doubt.

The underlying question is whether a PM will be driven by the business models of today's PM vendors, or by the business processes of the enterprises that depend on the PKI to securely perform value-laden transactions. Qualified business representatives have researched the question of how a PKI can enable E-Commerce. They concluded that interoperability and liability allocation require a high integrity root of trust that is common between the engaging parties, as well as digital certificates containing an explicit quality attribute that can be reliably utilized to make informed local decisions on the suitability of a certificate for a particular business process. It was further concluded that digital certificates should be produced on and consumed by platforms having an explicit measurable assurance of the platform's correct behavior.

Following this introduction, a more detailed presentation of the quality attribute and insurable platforms is provided in sections titled:
“A Business Rational for a Quality Attribute” describes a business rationale for the use of a global root and quality attributes in PM certificates.
“The Structure of the Quality Attribute” describes the components of the quality attribute in terms of their intended use.
“An Application of the Quality Attribute” provides a discussion of an example use of the quality attribute in the context of a hypothetical automotive industry.
“A Basis for Insurable PM Platforms,” describes properties of platforms whose correct behavior has an assurance that can be confirmed through objective third party evaluation, thereby providing a basis for insuring the platforms against failure of protection mechanisms.
   What is a PM to a Business?

A PKI is a mechanism for electronically conveying authoritative representations by one party about another party. For example, “Authority X” represents that ACME is a widget manufacturer holding a specific secret. Or, “Authority X” represents that the name of the holder of this secret is John Doe. The PM is relied upon for electronic identifications called “digital certificates.” Digital Certificates serve as components of automated business processes culminating in business transactions. Certificates are often characterized as a “digital ID” of an Internet user. But, in a business context other representations about the subject of a certificate are often more important than the subject's name (e.g., that John Doe is a purchasing agent for ACME may be more important than the person's name).

The representations within a PKI are hierarchical. With each representation there is a corresponding “who says so,” i.e., an identification of a “Certificate Authority” (CA). An application that consumes certificates recognizes ACME because some CA, (“Authority X”) issued a certificate making the representation. And “Authority X” is recognized because some other CA issued it a certificate. This hierarchy requires a starting point, which is called a “root CA”. The root CA issues itself a certificate, which is considered valid by virtue of its being physically present on the platform that consumes certificates. Obviously, there can be more than one “root CA.” However, a proliferation of root certificates on a single platform (such as the sixty-odd root certificates included with the Netscape browser) dilutes the ultimate value of any certificate validated on that platform because “who said so” becomes a large crowd having more than a few unrecognized “authorities”.

A Global Root for Interoperability and Liability Allocation

Any lack of allocated liability results in an inadequate basis for damage recovery. A common shortfall of commercial PKI's is a lack of definitive liability allocation. When multiple enterprises use a PKI to conduct transactions, the allocation of liability is most clear when each enterprise is within the same hierarchy of representations, with a common root CA. When the parties are within different hierarchies, mechanisms such as “bridging authorities” and “cross certification” become necessary to resolve the question of “who says so,” and these mechanisms distort intermediary liability.

While the simplest hierarchical structure is one where a single root authority makes all representations (i.e., the hierarchy has but two levels, the root and the end-user), this is not a practical business solution because the one root CA would have to both make and be liable for representations about parties for whom the CA has no authoritative knowledge. The PKI should reflect the distributed nature of the business processes. For instance, the HR department of ACME is in a better position make representations about ACME employees than is a root CA (or a bank). A more practical hierarchy is one where an enterprise makes (and is liable for) representations about its own members (e.g., employees).

At the next level of the hierarchy, a responsible trade group (known as a “registry”) may be best qualified to make representations about the enterprises within a given business sector. Such a hierarchy utilizes “wholesale certificates” issued by the registry to the enterprises. The enterprises then use the wholesale certificates to issue subordinate certificates to their employees (e.g., via the HR department). The critical property is that each intermediate party is liable only for protecting its secret keys and for the representations that it makes.

The challenge of establishing a global root CA that assumes hundreds of millions of dollars of liability is not as great as it might appear because such a CA would only be responsible for protecting its secret key and issuing unique names to the set of registries. The task is well within the capabilities of a consortium of financial institutions, e.g., Identrus offers a similar service. Establishing a global root is within the scope of current business structures and avoids non-extensible stovepipe solutions

Explicit Quality Attributes within Certificates

The greatest potential for financial loss without means of recovery in a PKI occurs when ambiguity exists with respect to what a certificate in fact represents, or who in fact is making the representation. Managing the risk of ambiguity within PM representations requires a reliable means to quantify the quality of the representations, (e.g., determine whether a certificate can be “taken to the bank”) Determining the quality of a certificate must be possible within the automated context of the e-commerce transaction. Furthermore, this must be possible across enterprises (and across business sectors) and must support business transactions with “almost strangers”.

All certificates are not created equal. Yet, the consumer of certificates must have a means of determining what a given certificate is good for. More precisely, the certificate consumer must be able to establish automated constraints on which certificates are acceptable for which business processes. For example, some certificates could be issued from extremely secure platforms, with a high degree of assurance that the resulting certificate represents an informed decision by a responsible (and liable) party. Other certificates are generated with relatively little concern for security. The former could be used to authorize a ten million dollar payment, the latter to rent a video. While CA's typically publish “certificate practice statements” intended to describe what their certificates are good for, these certificate practice statements are not suitable for automated processing and become complex to manage as the number of CA's grows large. Neither a bank nor a registry can safely determine the intended purpose of their certificate's use.

A cumulative assessment of certificate practice statements does not appear practical because such statements are not intended for such a purpose. A more scalable approach to assessing the quality of a certificate is to explicitly reflect the quality of each certificate within the certificate itself, enabling a local validation of the suitability of the certificate for a specific business process. Further, if the meaning of such a machine-readable “quality attribute” is cumulative over the entire chain of certificates (from the root to the end-user certificate), then the issuer of a certificate can place constraints on the representations that can be made within subordinate certificates. From a user or administrative standpoint, this enables certificate consumers to consider the certificate chain as a single “composite certificate,” by which we mean a single manageable certificate representation that preserves the liability allocated to the issuers of each certificate within the chain.

Inclusion of an explicit quality attribute in each certificate makes it possible for administrators to define “validation profiles” for users and Internet components (e.g., a VPN gateway) that consume certificates. These profiles would precisely constrain which certificates are acceptable for a particular business purpose in terms of the certificate attributes. Consider for example, a corporate security policy that defines two distinct sensitivities of information: public and proprietary. To enforce such a policy, systems would be administered by defining “validation profiles” in terms of the policy, e.g., this VPN gateway can only send information to systems whose quality attribute allows for the receipt of proprietary information. Only the administrators would have to be aware of the mechanics of the “validation profile” definitions, and individual users and developers of such Internet components would generally not have to concern themselves with the details.

Insurable Platforms

The quality of a certificate is to a large extent constrained by the security strength of the platform that generated the certificate. Some platforms and operating systems are better than others for these purposes. For example, if a CA platform like Microsoft NT is subverted through a professional attack, the attacker can cause the CA to generate bogus certificates that are indistinguishable from legitimate certificates. The end-user and their company have no way of knowing the difference. So, if organizations are to be liable for representations made in certificates they issue, then there must be a way to measure and quantify the associated risk. For businesses, a reasonable measure of risk is whether insurance can be purchased to mitigate the risk. Insuring a platform against deliberate hostile attack (e.g., via malicious software) requires that there be an objective metric of the strengths of the protection mechanisms whose failure would result in loss from transactions involving forged certificates.

There are international standards that quantify the assurance of protection mechanisms, and there are government-sanctioned evaluations of platform protection mechanisms against these objective standards. For example, today's German Digital Signature Law defines the minimum assurance of CA's in terms of these standards. Though potential insurers of platforms may not be able to evaluate platform protection mechanisms themselves, they can depend on evaluations performed by objective and qualified third parties.

By using platforms whose protection mechanisms have a quantifiable level of assurance, organizations can bound risk associated with issuing. Furthermore, if this quantified assurance were part each certificate quality attribute, then an organization can bound the risk associated with the certificates they accept for various business processes. For example, a validation profile could constrain a particular business process to only accept certificates issued by CA's implemented on high assurance platforms. Similarly a validation profile might constrain acceptable certificates to those whose associated private key is suitably protected from compromise.

Explicit quality attributes in certificates enable consumers of certificates to locally validate the applicability of a certificate for a particular purpose without having to reference an external authority at the time of validation. But, what happens when the issuer of a certificate wants to retract the representations made within a certificate?

Certificate Revocation

An often-raised PKI issue is the revocation of certificates. Many PKI strategies are built around the ability to generate and maintain “certificate revocation lists” that are dynamically referenced in the course of validating certificates. For e-commerce between enterprises, this is less of an issue than it might appear, particularly if the PM does a reasonable job of reflecting normal business processes. When an employee leaves an enterprise, the employee generally does not “take” the secret associated with the certificate. The secret stays with the platform owned by the enterprise or with the physical token issued to the employee. Strategies that require an enterprise to be aware of the comings and goings of its trading partner's employees are not likely to scale well. It is preferable to utilize validation profiles defined in terms of acceptable attributes (e.g., “accept certificates from purchasing agents of any company of this particular type”). This validation profile can also reflect the protections afforded the secrets associated with the certificates, thereby preventing the acceptance of certificates for parties that do not meet minimal requirements for protecting their secrets.

Summary

Two groups are involved in the mechanics of a PM: issuers of certificates and consumers of certificates. Issuers make representations within certificates, and issuers may be materially liable for these representations. Business models require that issuers of certificates only be liable for those things that they control. Consumers of certificates make decisions based on representations made within certificates and require an ability to administratively define validation profiles for specific business applications. Elements of a secure e-commerce framework that meets these requirements include:
A liability-assuming global root
Explicit quality attributes within certificates that are processed as a chain yielding a cumulative quality of the entire chain.
Use of insurable platforms whose protection properties have a quantified level of assurance.

All three of the above PM framework elements are necessary to achieve an e-commerce solution that is secure, pervasive, and globally interoperable.

The Quality Attribute—A Business Rationale

This section describes a certificate attribute that enables PKI architectures to meet the technical and administrative requirement of scalability while meeting business needs for liability allocation, as articulated by the Black Forest Group (BFG). The format for this quality attribute is an X.509 Version 3 compliant extension that Novell, Inc., defined and introduced in the PKI architecture for their Netware 5 product. This section gives a rationale for business use of this attribute, especially for Business-to-Business electronic commerce. The rationale is presented as a series of steps containing a progression of intermediate hypothetical architectures, leading to a final architecture that has the desired business properties.

Step 1: Certificate Quality Attribute and Validation Profiles

This step introduces a certificate Quality Attribute and corresponding Validation Profiles. The Validation Profile allow certificate consumers to set constraints on which certificates are acceptable in terms of the allocation of liability associated with the certificate.

A business decision that a consumer of certificates must reflect via its PKI usage for a given application is the constraint over which certificates are acceptable for the particular business process. Establishing such a constraint requires answers to two questions: (1) what representations are made by the certificate, and (2) who is making (viz., is liable for) the representations?

For business purposes today's models of certificate validations do not scale well and are not secure. Multiple distinguishable groupings of certificates are necessary, e.g., to define communities of interest. In today's models, this is accomplished by having multiple root certificates with different roots serving different purposes (e.g., representing different communities of interest). In the typical model today, if a Certificate Authority (CA), for example Verisign, makes representations within a certificate, then a certificate consumer (e.g., another business) can validate that the certificate is in fact from Verisign, rather than from a root representing a different community. In fact, Internet browsers commonly distribute four distinct roots just for Verisign (for what Verisign terms four “Classes” of certificates), in order to distinguish differing purposes. This validation of the applicable community of interest is a side effect of validating the certificate itself. This technique for validation does not scale well. When a certificate is received, roots must be examined and discarded until the root that properly validates the certificate is found.

An alternative for validation is to include within the certificates themselves explicit attributes that reflect the logical grouping. By defining such machine-readable “quality attributes” within certificates, it becomes considerably more practical to administer the various applications within an enterprise's PKI. In the Verisign example, rather than four Verisign roots, there would be a single root with four different values for the quality attribute to distinguish the four different “Classes” of Verisign issued certificates. Administrators can define “validation profiles” for users and applications (e.g., a VPN gateway) that consume certificates. These profiles would precisely constrain which certificates are acceptable for a particular business purpose in terms of the certificate attributes. Consider for example, a corporate security policy that defines two distinct sensitivities of information: public and proprietary. To enforce such a policy, systems would be administered by defining validation profiles in terms of the policy, e.g., this application can only send information to systems whose quality attribute allows for the receipt of proprietary information. It is important to note that only the administrators would have to be aware of the mechanics of the validation profile definitions. Individual users and application developers would generally not have to concern themselves with the details.

In the above hypothetical model, there is a single issuer of certificates—making liability allocation clear (albeit unrealistic in that this issuer is allocated all the liability for all the certificates). Consumers accept certificates based on explicit attributes encoded within the certificates.

Step 2: Validating Certificate Chains

This step elaborates on the architecture by showing how it is more practical to manage chains of certificates rather than a lot of different root certificates. Nevertheless, consumers of certificates must be able to consider a certificate chain as logically a single composite certificate, while maintaining the visible allocation of liability to each individual CA. This step describes a mechanism for accomplishing that.

The biggest problem with the system presented in step one is that a single CA issues all certificates. This frequently is not practical from a liability standpoint (as well as scalability) because the one CA would be responsible for the cumulative liability of all users. In reality of the business environment, certificate chains are necessary because there will be multiple organizations that are each responsible for the end-user certificates that they issue.

In particular, multiple enterprises, possibly closely related as part of the same business sector, should each be individually responsible for the representations they make within end-user certificates that they issue. The structure of the quality attribute has been carefully. designed to enable this. As detailed in the Annex, the quality attribute is actually structured into five distinct components. The format and meaning for four of these is defined as part of the specification of the attribute, and each CA is liable for the representation it makes about these four components for each certificate it issues. In addition, using the fifth component that the Appendix calls the “BFG Security Label,” each enterprise CA would reflect, and be liable for representations contained in, major constraints on use of the certificate by the user.

Similarly, a CA for the “registry” would issue one or more CA certificates for each of the enterprises, and the registry would be responsible for the representations made in these certificates. However, the registry would not be liable for representations made by the enterprises. The CA certificates issued by the registry for each enterprise would include the name of the enterprise, e.g., “CarCo”. Additionally, attributes about each enterprise would be represented in the quality attribute contained within the CA certificate issued to the enterprise. Consumers of certificates would use these enterprise attributes to decide which certificates are acceptable for which purpose. For example, such an enterprise attribute might constrain the certificate chain for use in naming insurance brokers rather than insurance underwriters. An illustrative certificate hierarchy is shown in FIG. 58, where the certificates included in the certificate chain for this specific example are represented with dashed lines.

A logical composition of the certificates within a chain into one logical certificate would include the quality attribute for the user as well as the quality attribute for the enterprise. Thus, a consumer of a certificate chain could consider the chain as a single certificate that uniquely identifies an enterprise and a user and has attributes for each (e.g., a CarCo HR Manager able to view Business, but. not Proprietary, information). The composite logical certificate for the example chain of FIG. 56 is shown in FIG. 57.

Step 3: Composite Quality Attribute

Liability issues make it attractive to allow enterprises to place constraints on the certificates they issue to users. For example, an automobile manufacturer may have need to issue certificates to users whom should have no benefit from the fact that the company is in fact an manufacturer. Consider the example of FIG. 57 where the certificate is issued to a Human Resources manager whose responsibilities are not related to the fact that the company is an automobile manufacturer. The company may wish to not include the manufacturer attribute within this user's logical composite certificate. However, it is the registry that issues the certificate containing this attribute. For this and other similar reasons, it is convenient to include fields for the attributes of both users and enterprises in each of the certificates within the chain. Then, by defining the logical composition of multiple certificates in the chain as being the least of all the certificates in the chain, an enterprise can, for selected users, effectively negate attributes assigned to the enterprise by the registry.

FIG. 58 redraws the certificate hierarchy of FIG. 56, but with both user and enterprise attributes in each certificate within the chain. Note that the Human Resources manager does not inherit the “manufacturer” attribute assigned to the company by the registry because the company does not enable this attribute within the certificate it issues to the user. Composing a logical certificate by taking the least of the attributes of the certificates within the chain preserves the intent of the entities that make the representations. For example in FIG. 58, the registry represents the “ACME Axels” enterprise to be parts supplier, not a manufacturer. Even if ACME put the manufacturer attribute in the certificate of one of its users, the “least of all certificates in the chain” rule would result in a composite quality attribute for the certificate that has no manufacturer attribute. Thus, the consumer sees what the registry intended and liability allocation is preserved.

Step 4: Business Implications for Length of Chain

The BFG examination of business needs has concluded that liability allocation considerations indicate a certificate hierarchy with at least four levels of certificates in each chain provides a balance between business needs and demands on technology.

Step 2 described how the Quality Attribute of each certificate would contain a BFG Security Label, and Step 3 identified that this label would include a full security label field for each level with distinct liability in the hierarchy. How many levels must there be in a certificate chain? As it turns out, four levels meet most business requirements for allocation of liability. Each level is summarized below in terms of what it is that they are liable for.
Root: Liable for protecting its secret key and providing a unique identifier for each registry. The Root CA actually issues two certificates that are in each certificate chain: The Root is also liable for any representations made about the registry (e.g., that it is an authorized key-escrow registry).
Registry: There is a different registry for each major collection of enterprises that have significant requirements to exchange goods and services. Registries can be defined based on a set of business relationships where top-tier enterprises purchase goods and services from a common set of lower-tier enterprises. An example registry for the automotive industry might be ANX. Registries are liable for protecting their secret key. A significant representation made by registries is the identification of enterprises (i.e., within the standard X.509v3 certificate). For example, the registry represents that the certificate is issued for CarCo. Additionally, the registry is responsible for ensuring that enterprises are provided with unique (within the registry) identifiers. The registry is also responsible for any representations made about the enterprise (e.g., Manufacturer vs. Parts Supplier). Finally, the registry is responsible for protecting its private key.
Enterprise: Each enterprise is liable for representations made within certificates issued to each of their end-users, and for the protection of the enterprise's private keys. This includes liability for their representation of the identity of the user in the certificate.
User: Each user is accountable for their use of the certificate (or more precisely, their use of the associated private key). The user has only an end-entity certificate, i.e., not a CA certificate. There is, of course, no notion of liability for representations made, since the user does not issue certificates.

The above has direct implications about the properties of the certificate chain. Several of the more significant properties are summarized below:
a. Uniform Attribute Format. The format template of the quality attribute is identical for every certificate in the chain. In particular the BFG Security Label component of the quality attribute has a separate element representing the constraints on each level in the hierarch with distinct allocation of liability.
b. Three Explicit Constraint Components. Although there are four levels to the hierarchy, as identified above, there are only three separate constraints in the quality attribute format for the BFG Security Label. This is to avoid unnecessary data in all certificates, since the constraints on the Root can be implicit. There are two primary reasons this choice is reasonable. First, the Root issues a self-signed CA certificate that is intended to be used globally, and it is essential that this Root certificate contain the same quality attribute. However, this certificate is not a primary means of distributing information about the Root itself, since everyone uses this same certificate with a chain under this root. Second, since the Root also issues the CA certificate to each registry, it can represent in these certificates any constraints on its liability in those certificates.
c. Chains Can Have More than Four Certificates. The quality attribute cannot fully support allocation of liability to more than four levels of the CA hierarchy. However, this does not restrict certificate chains to a length of four. Any level can distribute its responsibility, or delegate of portion of it, to another peer level by issuing a CA certificate to that peer level.
d. Short Chains are Supported. Although the BFG has concluded that the most common business contexts will benefit from allocating liability to four levels as described, in particular situations this liability can be combined as desired—even to the extent of having the Root directly issuing user certificates and assuming all the liability for the representations in those certificates. The primary reason this is possible is because the format of the quality attribute in every certificate is exactly the same as the format for the logical composite attribute derived from any certificate chain of any length.
   Step 5: Interoperability Constraints

The certificate hierarchy defined in Step 1 through Step 4 is intended to support business processes between enterprises within a registry. Step 1 introduced the concept of a “validation profile” that is used by certificate consumers to set constraints on which certificates are acceptable for which business purposes.

For example, within an enterprise a specific application (e.g., a VPN gateway) can be configured via a profile to accept certificates only from users within the HR department. As an example of interaction across enterprises within a single registry, a specific application might have a profile that accepts certificates only from Insurance Resellers. Such a profile is meaningful because the registry defines a policy that includes representations of the attributes of the enterprises within the registry, so Parts Suppliers can be reliably distinguished.

Examples of interoperability across registries are a bit more of a challenge because each registry defines their own interpretation of the BFG Security Label. In practice, it should be relatively straightforward for an enterprise in one registry to define a validation profile based on a subset of the policy defined by an external registry. For example, a particular application within an automaker's enterprise could have a profile defined in terms of the policy of the registry representing insurance companies (e.g., for purposes of purchasing health insurance for the employees of the auto manufacturer). The unique identifiers assigned to each registry provide a basis for separating automaker registry policy components from insurance registry policy components.

Use of the quality attribute to manage liability allocation and interoperability across registries benefits from a root that is common to each of registries. The most straightforward solution is a single liability-assuming root. The strongest reason for a single high integrity root is the high assurance that is gained by placing the root in hardware as part of the manufacturing process. When new registries (e.g., business sectors) need to be recognized, the high integrity root would certify (sign) the registry's certificate. Significantly less assurance is achieved if mechanisms must be in place to distribute and receive new registry root certificates.

The use of multiple registry roots also adds considerable management complexity. Consider the mechanical problem of deciding to accept a new registry within a set of validation profiles. If there is a common root, the solution is as straight forward as identifying the new registry ID within the target protection profiles. If there is no common root, the certificate for the new registry itself must be distributed and reliably installed on each target platform.

Clearly, a hardware based high integrity root is the most advantageous solution. Placing a high integrity root certificate in hardware at manufacturing time is well within the capabilities of current manufactures of hardware-based cryptographic modules.

The CA Hierarchy

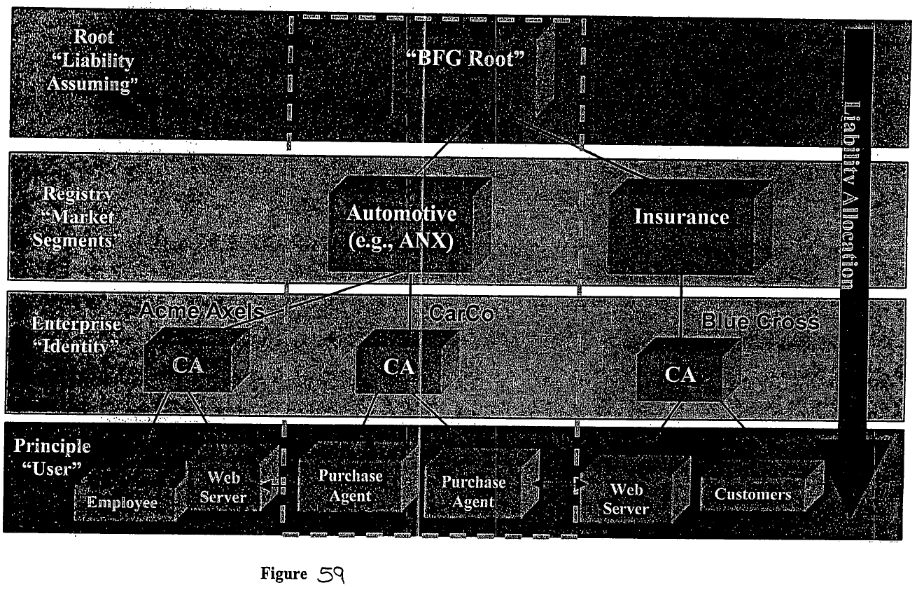

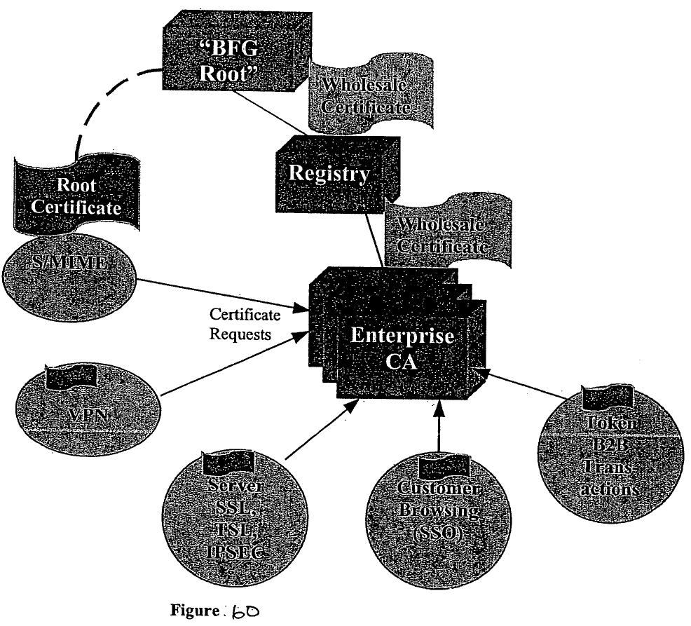

FIG. 59 illustrates the hierarchy of CA's that results from steps one through five. The figure reflects two business sectors and three enterprises. FIG. 60 illustrates the core CA structure in the context of a set of applications that request and consume certificates.

Structure of the Quality Attribute

The Black Forest Group (BFG) spent considerable effort investigating the properties of security labels as they relate to a PK.I useful for business-to-business transactions. They found that an X.509 v3 certificate extension defined in: Novell Certificate Extension Attributes—Novell Security Attributes™, was already in use within the industry for similar purposes and largely met their needs. Rather than create a new and different extension, the BFG has committed to use this extension, under the conditions imposed by Novell, namely that they agree to abide by the definitions and comply with the defined syntax and semantics. This appendix provides a BFG interpretation for the certificate extension attribute.

Many of the attribute components defined in the document referenced above are fixed, and have no need for interpretation. This appendix generally focuses on those components that specification dictates as requiring an interpretation for a particular use or environment—in this case the BFG environment. In particular this business environment relates to the PKI liability allocation issues that are the significant focus of the BFG framework.

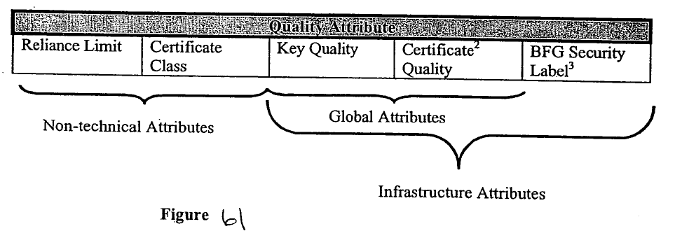

The quality attribute has five fields as illustrated in FIG. 61. Quality Attribute

Non-technical Attributes

The first two fields are not part of the infrastructure that enables interoperability and are therefore not discussed here. The referenced document fully describes the Reliance Limit and Certificate Class fields.

Global Attributes

The two global attributes, Key Quality and Crypto Process Quality, have semantics that are globally defined. These attributes do not require interpretation. They are defined as follows:

Key Quality

An initial, static quality of the keys reflecting the environment in which the key pair for the certificate was produced. Initial Key confidentiality (protection from disclosure, guessing, etc.) is the primary concern. The key quality component is itself composed of:
1. CompuSec Strength: The strength of the computer information security policy enforcement, viz., the Trusted Computing Base, of the platform responsible for generating the keys. This value has two parts:
   a. Identification of the computer security criteria being used (e.g., TCSEC, ITSEC, etc.)
   b. Rating of the TCB per that computer security criteria (e.g., B3, E5, etc.)
2. Crypto Strength: The strength of the cryptographic module implementation used to generate the keys. This value has two parts:
   a. Identification of the crypto criteria being used (e.g., FIPS 140-1)
   b. Rating of the crypto module per the criteria (e.g., Level 3).
3. Key storage quality indicator: an indication of what kind of medium is used to securely store the key (e.g., a password-encrypted file on a removable floppy disk, a tamper-proof smart card, a smart card with biometric access control, etc.).
4. EnforceQuality Indicator: an indication of whether or not the keyQuality and/or the cryptoProcessQuality criteria are to be or have been enforced by the operating system.
5. Algorithm Type: This is not an explicit value within the attribute, rather a value is derived by performing a table lookup on the value required to be contained within the main body of the standard X.509 certificate. The derived value is included within the GLB calculation.
6. Key Length: associated with the private or secret key. This is not an explicit value within the attribute, rather a value is derived by performing a table lookup on the value required to be contained within the main body of the standard X.509 certificate. The derived value is included within the GLB calculation.
   Certificate Quality

A commitment regarding the environment in which the certificate keys will be used (e.g., to sign objects). The primary purpose is to provide an indication of a “trusted path,” so that a relying party can have some degree of confidence that what the user intended to sign is actually what was signed. In the vernacular of trusted computing systems, a “trusted path” refers to the connection or path between the user's keyboard and the trusted portion of the operating system, and likewise between the operating system and the display screen, so that the user can be assured that what he types is going to be entered correctly, and that “what you see is what you get” (WYSIWYG). Without some degree of integrity controls it is difficult to make such a statement with any assurance. In addition, the continuing controls over confidentiality (e.g., key leakage), provided by the Key Quality attributes are also provided. Certificate Quality is itself composed of
1. CompuSec Strength: The strength of the computer information security policy enforcement, viz., the Trusted Computing Base, of the platform on which the certificate keys are used (e.g., to sign objects). This is primarily a reflection of the strength of the trusted path utilized by the user to sign objects. This value has two parts:
   a. Identification of the computer security criteria being used (e.g., TCSEC, ITSEC, etc.)
   b. Rating of the TCB per that computer security criteria (e.g., B3, E5, etc.)
2. Crypto Strength: The strength of the cryptographic module implementation within the platform on which the certificate keys are used. This value has two parts:
   a. Identification of the crypto criteria being used (e.g., FIPS 140-1)
   b. Rating of the crypto module per the criteria (e.g., Level 3).
3. Key Storage Quality Indicator: an indication of what kind of medium is used to securely store the key (e.g., a password-encrypted file on a removable floppy disk, a tamper-proof smart card, a smart card with biometric access control, etc.);
4. EnforceQuality Indicator: an indication of whether or not the keyQuality and/or the cryptoProcessQuality criteria are to be or have been enforced by the operating system.¹
5. Algorithm type: This is not an explicit value within the attribute, rather a value is derived by performing a table lookup on the value required to be contained within the main body of the standard X.509 certificate. The derived value is included within the GLB calculation.
6. The key length associated with the private or secret key. This is not an explicit value within the attribute, rather a value is derived by performing a table lookup on the value required to be contained within the main body of the standard X.509 certificate. The derived value is included within the GLB calculation.
   BFG Security Label

The BFG Security Label is a set of representations about the users to whom the certificate is issued, and representations about the issuers of certificates within the chain. The semantics of the BFG Security Label is localized to a given registry. The BFG Security Label is composed of three fields as shown in Table 1. Each of the three fields has levels and categories as illustrated in Table 2A.

TABLE 1
Three fields of the BFG Security Label
BFG Security Label

| | | |
|---|---|---|
| Registry Label | Enterprise Label | User Label |

¹ The meaning of the enforceQuality attribute is as follows: If TRUE, the keyQuality explicit attributes compusecQuality, cryptoQuality, and keyStorageQuality, plus the implicit attributes algorithmType and keyLength must be enforced at all times by the TPM.

TABLE 2A
Each of three fields of the BFG Security Label

| La | Lb | Ca | Cb | SCa-1 | . . . SCa-16 | SCb-1 | . . . SCb-16 |
|---|---|---|---|---|---|---|---|
| 1-255 | 1-255 | 1, | 1, | Singleton | Singleton | Singleton | Singleton |
| | | 2 . . . 96 | 2 . . . 64 | Range | Range | Range | Range |

The table heading abbreviations are as follows:
La: hierarchical level a, having values from 1-255
Lb: hierarchical level b, having values from 1-255
Ca: non-hierarchical Category set “a” containing 96 categories
Cb: non-hierarchical Category set “b” containing 64 categories
SCa: Singleton Category range set a (there are sixteen ranges in each set, SCa-1 through SCa-16) range values are 0-2″63-1
SCb: Singleton Category range set b (there are sixteen ranges in each set, SCb-1 through SCb-16) range values are 0-2\hat{0}63-1

Singleton values of 0 and 2\hat{0}63-1 are used to disable and enable a singleton category and thu, are not valid singleton category values.

The intended use of the three label fields within the BFG Security Label is described below.

TABLE 2B
BFG Security Label of Registry Certificate

| Registry Label | Enterprise Label | User Label |
|---|---|---|
| Enable Global Policy; | Enable Enterprises | Enable User Policy |
| Registry Attributes; Unique | Policy | |
| Registry ID | | |

Semantics of the BFG Security Label within a Registry Certificate

The root issues the registry certificate, and may choose to place constraints on any of the three labels (e.g., reserve some set of categories or singletons). The root uniquely names the registry within the Registry Label, and makes representations about the registry (e.g., is a key-escrow registry). In general, the root makes very little in the way of representations about the registry, and for that reason, the Registry Label is used rather that adding a fourth field to the BFG Security Label. The root is liable for providing each registry with a unique identifier, and for any other representations made about the registry within the Registry Label of the Registry Certificate. BFG Security Label of Enterprise Certificate.

TABLE 2C
BFG Security Label of Enterprise Certificate

| Registry Label | Enterprise Label | User Label |
|---|---|---|
| Registry Self-constraints; | Enable Enterprises | Enable User Policy |
| Enterprise Attributes; Unique | Policy | |
| Enterprise ID | | |

Semantics of the BFG Security Label within a Enterprise Certificate

The registry issues the Enterprise Certificate and is responsible for representations made about the enterprise within the Registry Label (using fields not reserved by the root for its representations of the registry), including a unique identification of the enterprise. Such representations may include attributes such as being an “insurance underwriter,” or an “insurance broker”.

The registry may limit its own liability by setting constraints within the Registry Label. For example, in the Registry Certificate, the root may have represented the registry as being a “key-escrow” registry. For some set of enterprises, the registry may want to negate that representation, and could do so within the Registry Label of the Enterprise Certificates issued to those enterprises.

By contract with the enterprise on whose behalf the certificate is issued, the registry may set constraints within the Enterprise Label or the User Label. For example, an enterprise may include several largely independent business units. The enterprise could generate unique IDs for each business unit (e.g., through the use of a singleton category) and contract with the registry to issue a different Enterprise Certificate for each business unit. In this example, the registry is not responsible for naming the business units—it is simple responsible for setting some set of values defined in a contract. The enterprise would be responsible for the identity of the business units, and responsible for issuing end-user certificates under the appropriate Enterprise Certificate (based on the business unit to which the user belongs.

Also, the registry may constrain parts of the Enterprise Label or User Label (e.g., by reserving categories) for its own future use.

TABLE 2D
BFG Security Label of User Certificate

| Registry Label | Enterprise Label | User Label |
|---|---|---|
| | Enterprise self-constraints; | User clearance internal to |
| | Unique User ID; User | enterprise |
| | Attributes (across | |
| | enterprises) | |

Semantics of the BFG Security Label within a User Certificate

The enterprise issues the User Certificate and is responsible for representations made about the user within the Enterprise Label, including a unique identifier for the user. The Enterprise Label contains those user attributes that have semantics outside of the enterprise (e.g., the unique user identifier). For example, if the user wishes to represent the user to the outside world as being an insurance agent, the Enterprise Label would be used. On the other hand, if the enterprise wishes to reflect the user has access to internal proprietary information that attribute would be reflected in the User Label.

Composition of a Certificate Chain into a Logical Composite Certificate

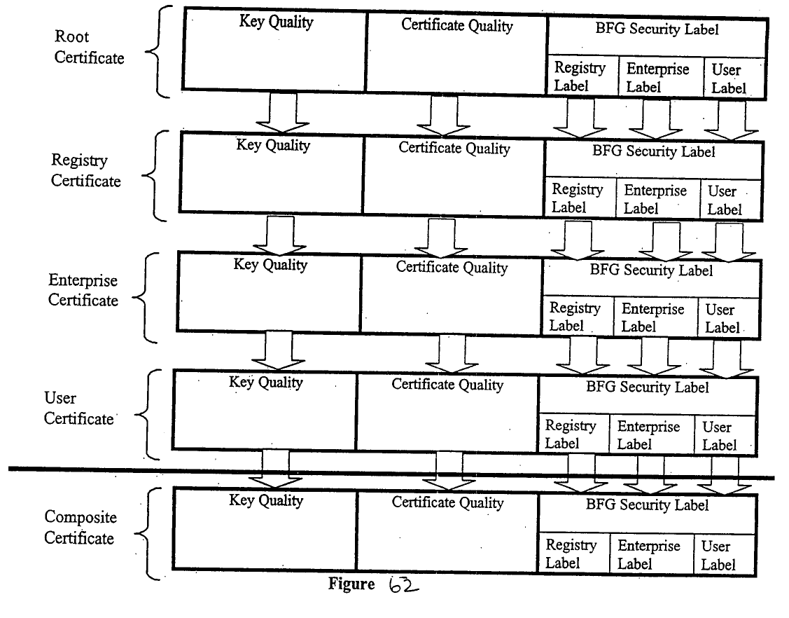

FIG. 62 illustrates the composition of the four levels of certificates within a chain into a single logical composite certificate. The resulting composite certificate contains fields whose values are the least of any corresponding field within any of the certificates within the chain. For example, where field values are represented as integers, the numeric minimum is taken. Where fields are literal sets of bits, a logical AND operation is performed such that only those bits that are “on” at a given position within each and every certificate in the chain will also be “on” in the composite certificate. For example, for a category of “Human Resources” to be “on” in the User Label field of the composite certificate, it must also be on in the User Label field of each of the four certificates.

Application of the Quality Attribute

This section describes a corporate information security policy for a hypothetical automaker, “CarCo” in terms of the sensitivity of information and constraints placed on users. Additionally, a hypothetical policy for the overall automotive industry is presented. The intent of the industry-wide policy is to identify a specific framework to enable automated business-to-business transactions between enterprises within the automotive industry (e.g., the purchase of assembly parts from a first tier supplier). The details of these policies are hypothetical and have not been subject to thorough review by experts in the automotive industry.

Information Security Policies

Different information has different sensitivity, requiring different levels of protection. Information security policies provide a means to identify the sensitivity of information, and to identify which users have access to which information. The identification of the sensitivity of information is referred to as the information's “classification”. The identification of what information a user is authorized to access is referred to the user's “clearance”. A user's clearance reflects the maximum sensitivity of the information the user can access.

Classifications of information and clearances of users both have the same representations and semantics. The reason is to enable a precise comparison between a user's clearance and the information's classification to determine the user's authorization to access the information.

Organizations of any size or scale must be able to identify information in a way that is global and persistent across the enterprise. Even though the information may be transformed or processed, it is important that the classification of the information persists to ensure its continued protection. Such an information security policy is referred to as a “mandatory access control policy”. Typically, such policies are defined by a managing entity and are not left to the discretion of individual users.

Some information is more sensitive than other information. This is usually reflected by an indication of a hierarchical level with a resulting ordering. For example, a user with a clearance at a relatively high level (e.g., “Proprietary”) can observe information having a classification at a relatively low level (e.g., “Public”). On the other hand, some information classifications are not comparable. For example, some information might be restricted to an Engineering organization while other information is restricted to Human Resources. Neither classification represents more sensitivity than the other does. Access to one type does not imply access to the other type. They simply are not comparable. This type of classification is made in terms of a non-hierarchical set of “categories”. For example, “Human Resources” might be one category and “Engineering” another. Within an organization, some user clearances may include neither, or one, or both of the categories.

The combination of hierarchical levels and non-hierarchical categories is referred to as a “security level” (though strictly speaking, they are not always levels, e.g., two levels can be non-comparable).

Security Labels

The security level of the classification of information and the security level of user clearances can both be represented as a “security label”. A security label is a physical representation of a security level. Security labels are processed by machines and thus are designed for efficient comparisons. Hierarchical levels are represented as integers. Each level is assigned an integer reflecting the ordering of the levels. A security label that contains a hierarchical secrecy level in Table 3.

TABLE 3
Security Label Containing a Secrecy Level
Secrecy Level
Value 0-255

In addition to hierarchical levels, many security policies include non-hierarchical categories. These categories are typically represented within a label by a set of bits, each of which represents a distinct category. Some policies require a very large number of categories, where any given security label includes very few of the many categories. In such cases, integers can be used to indicate the positions of the bits within the large virtual set that are to be “on”. These are referred to as “singleton categories”.

An Enterprise Information Security Policy

The policy definitions presented in this section reflect decisions made by the enterprise, CarCo, as a whole, as well as decisions made by individual business units within CarCo. These policies are generally local to the enterprise and their business units. Policies for which a common format can benefit the overall automotive industry are described in the subsection titled: “Automotive Industry Information Security Policy”. For example, even though CarCo (or a business unit) would determine a user's unique identifier, that policy aspect is described in the automotive industry-wide sub-section because interoperability can be enabled through the use of a common format for identifying individual users across enterprises.

Hierarchical Secrecy Level

Each security level within the CarCo information security policy includes a hierarchical secrecy level. Three such secrecy levels are defined in the policy as follows:
Public
Business
Proprietary
Where: Public<Business<Proprietary. The symbol “<” represents a “less than” relationship as in, “Public information is less sensitive than is Business information.

Table 3 shows a security label that reflects a hierarchical secrecy level.

User Roles

Users are assigned roles that are defined as membership in a set of groups. The policy defines two unordered sets of groups; one set that constrains a user's ability to view information and another that constrains a user's ability to modify information. The groups of which the user is a member defines the user's role. Two singleton categories are used to represent the groups to which the user belongs. The group identifiers are unordered values that represent the group names. Examples of groups include: accounts payable, human resources, auditor, and quality assurance. Table 4 shows the security label extended to reflect the user's role in terms of membership in two groups.

TABLE 4
Label Reflecting Secrecy Level and
User Group Membership (Roles)

| Secrecy Level | Group 1 | Group 2 |
|---|---|---|
| Level Value 0-255 | Unique Category | Unique Category |

Signing Limits

Each user has an associated per-transaction dollar value constraint. This is not a cumulative limit; it represents the limit on each individual action. The BFG Quality Attribute includes a “reliance limit” field external to the security label to reflect this value. This value will not be treated as part of the security label.

Automotive Industry Information Security Policy

This section proposes an automotive industry-wide information security policy. These policy components include attributes that may be useful to enterprises outside of CarCo (e.g., automotive part manufacturers). The intent is to allow the automotive industry to benefit from a common format. These policy components are representations made about CarCo, its business units and employees to external enterprises. Some of these representations are made by CarCo, while the registry that is responsible for the automotive industry makes other representations.

Representations Made by CarCo

The policy representations described in this subsection are determined by CarCo, but using a format common across the automotive industry. This use of a common format is intended to promote interoperability. Some of the policy components (e.g., User Identification) might also have a common format across business sectors.

User Identification

The CarCo security policy requires authenticated identification of individual users (e.g., as a basis for individual accountability) where users might be policyholders, employees, or agents. Because each user is assigned a security label, it is convenient to add a unique user identifier to each user's security label. Even if the policy does not classify information based on individual user identity, it remains convenient to use the same security label for both users and information. A unique user identifier is defined in addition to the “distinguished name” that is part of the X.509v3 standard because the distinguished name format does not necessarily meet the needs for automated processing. To reflect a unique identifier within a security label, each user is assigned a unique category. The position of the category in the set represents the user. Because the number of users is potentially quite large, a singleton category is used. Note that there is no ambiguity if the same unique identifier value is used for different users in different business entities because it is qualified by the unique identity of each entity that is also (elsewhere) in the quality attribute.

Industry Role

Each user may serve a role that is recognized across the automotive industry (e.g., purchasing agent). The industry role is defined by membership in two sets of groups: one set that constrains a user's ability to view information and another that constrains a user's ability to modify information. Two singleton categories are used to represent the groups to which the user belongs. The group identifiers are unordered values that name the groups. Examples of industry role groups include: purchasing agent, customer, employee, corporate officer, and sales agent.

Customer Privacy Election

Anticipated regulations require that a customer's privacy selection (viz., whether the customer chooses to prohibit the sharing of personal data, e.g., for marketing purposes) be reliably and consistently honored by a self-defined business entity. For example, if CarCo decides that the business entity is CarCo-wide (rather than the individual business units), then customer information can be shared across CarCo business units regardless of the customer's privacy selection. However, that decision makes CarCo responsible for honoring a customer's choice as expressed to any business unit to not share personal information outside of CarCo, even if the customer previously permitted such sharing when registering with another CarCo business unit (e.g., a car rental agency owned by CarCo).

The customer privacy selection and CarCo's choice of what constitutes the business entity (CarCo-wide or individual business units) is represented by two non-hierarchical categories. The “Customer Share” category is present for customers who have selected to share their information outside of the business entity. The “Primary Privacy Scope” category is present when the entity that is the basis for the election is the “primary” business entity, e.g., CarCo, rather than the “secondary” individual business units. These two categories are used to represent three different states as shown in Table 5.

TABLE 5
Customer Privacy Policy Representation

| Customer | Primary | Constraints on |
|---|---|---|
| Share | Privacy Scope | Sharing Customer Data |
| Absent | Absent | No sharing outside the |
| | | business unit |
| Absent | Present | Sharing only with other |
| | | CarCo business units |
| Present | Don't Care | Global sharing permitted |

Representations Made by the Registry

The policy representations described in this section are made about the enterprise (e.g., CarCo) by the registry that represents the automotive industry. The registry is generally liable for the accuracy of these representations (though this liability may be more precisely defined through a contract with the enterprise). In general, representations made by the registry are based on an agreement between the registry and the primary business identified as described below in the paragraph titled: “Enterprise Identification”. Any agreement between the registry and a secondary business (e.g., an CarCo business unit) is limited to policy aspects described above in the section titled: “Representations Made by CarCo”.

Enterprise Identification

Each enterprise has a unique identifier having two parts: a primary identifier (e.g., “CarCo”), and a secondary identifier, (e.g., “RentaCarCo”). The primary identifier names the highest-level business entity that has a relationship with the registry. The secondary identifier names the lowest level business entity that has a relationship with the registry (e.g., a business unit within a conglomerate). Note that “CarCo” is a valid value for the secondary identifier as well as for the primary identifier.

Industry Type

This identifies the type(s) of automotive industry functions performed by the enterprise named by the Enterprise Identification (primary and secondary) described above. This is represented by the presence of one or more of the following categories:
Manufacturer
Dealer
Parts Supplier
Rental Agency
   Primary Privacy Scope,

It is expected that the registry will be responsible for accurately reflecting the primary privacy scope choice made by the enterprise (e.g., CarCo) as is described above in section 0, “Customer Privacy Election.”

Key Quality and Certificate Quality

It is expected that CarCo, as the primary business entity, will establish an agreement with the registry that constrains the services that the registry will provide to the individual business units. In particular, it is expected that this agreement will prohibit the registry from issuing wholesale certificates to business units having a Key Quality or Certificate Quality values other than those specified by CarCo for that particular business unit. CarCo will determine the Key Quality and Certificate Quality appropriate for each business unit and this will be part of the agreement between the registry and CarCo. The normal business audit processes will then be used by CarCo to ensure that the business units meet the requirements established by the registry agreement.

Example Assignment to the BFG Security Label

The following tables depict the representation of the security policies described in the preceding sections. Three tables are presented to describe the User Label, the Enterprise Label, and the Registry Label. For exposition purposes, the level and category label fields are presented as rows. The columns represent the values for each certificate in the chain: root; registry; enterprise and user. Thus, the User Label table reflects the values of the User Label contained within each certificate within the chain. The abstract composite label value for a given level or category label field is obtained by taking the greatest lower bound of the value in each certificate within the chain. For example, the composite value of the User Label hierarchical level field “La” is obtained by computing the greatest lower bound of each column of the La row within the User Label table depicted in the tables that follow.

It is anticipated that the root will reserve a subset of the label for global policies. For example, in the tables below, the root reserves categories CA96 and CB64 in each of the three label components. Also, in the registry label, the root reserves categories CA93 through CA96 and CB61 through CB64 for its own use (e.g., to reflect certificate version numbers or to identify one of multiple root certificates).

Additionally, in the registry label and the enterprise label, SC10 is used to reflect whether an entity is a recognized “key escrow”. This use is consistent with the assignment of values made by Novell in their Novell Certificate Extension Attributes—Novell Security Attributes™.

TABLE 6
USER LABEL

| | | Registry | Enterprise | |
|---|---|---|---|---|
| | Root Cert | Cert | Cert | User Cert |
| La | Enabled | Enabled | Enabled | Secrecy Lvl |
| | | | | (See Table below) |
| Lb | Enabled | Enabled | Enabled | Reserved |
| Ca 1-93 | Enabled | Enabled | Enabled | Reserved |
| Ca 94 | Enabled | Enabled | Disabled | |
| Ca 95 | Enabled | Disabled | | |
| Ca 96 | Disabled | | | |
| Cb 1-61 | Enabled | Enabled | Enabled | Reserved |
| Cb 62 | Enabled | Enabled | Disabled | |
| Cb 63 | Enabled | Disabled | | |
| Cb 64 | Disabled | | | |
| SCa-1 | Enabled | Enabled | Enabled | User Role (secrecy) |
| SCa-2: | Enabled | Enabled | Enabled | Reserved |
| SCa16 | | | | |
| SCb-1 | Enabled | Enabled | Enabled | User Role (integrity) |
| SCb-2: | Enabled | Enabled | Enabled | Reserved |
| SCb-16 | | | | |

TABLE 7
Secrecy Level Assignments

| CarCo Secrecy Level | BFG Level Value |
|---|---|
| Public | 40 |
| Business | 80 |
| Proprietary | 120 |

TABLE 8
ENTERPRISE LABEL

| | | Registry | Enterprise | |
|---|---|---|---|---|
| | Root Cert | Cert | Cert | User Cert |
| La | Enabled | Enabled | Enabled | Reserved |
| Lb | Enabled | Enabled | Enabled | Reserved |
| Ca 1 | Enabled | Enabled | Enabled | Customer Privacy |
| Ca 2-9 | Enabled | Enabled | Enabled | Reserved |
| Ca 10 | Enabled | Enabled | Escrow | |
| Ca 11-93 | Enabled | Enabled | Reserved | Enabled |
| Ca 94 | Enabled | Enabled | Disabled | |
| Ca 95 | Enabled | Disabled | | |
| Ca 96 | Disabled | | | |
| Cb 1-6, 1 | Enabled | Enabled | Enabled | Reserved |
| Cb 62 | Enabled | Enabled | Disabled | |
| Cb 63 | Enabled | Disabled | | |
| Cb 64 | Disabled | | | |
| SCa-1 | Enabled | Enabled | Enabled | Industry Role |
| | | | | (secrecy) |
| SCa-2: | Enabled | Enabled | Enabled | Reserved |
| SCa16 | | | | |
| SCb-1 | Enabled | Enabled | Enabled | Industry Role |
| | | | | (integrity) |
| SCb-2 | Enabled | Enabled | Enabled | User Identifier |
| SCb-3: | Enabled | Enabled | Enabled | Reserved |
| SCb-16 | | | | |

TABLE 9
REGISTRY LABEL

| | Root Cert | Registry Cert | Enterprise Cert | User Cert | |
|---|---|---|---|---|---|
| La | Enabled | Enabled | Reserved | | |
| Lb | Enabled | Enabled | Reserved | | |
| Ca 1 | Enabled | Enabled | Privacy Scope | | |
| Ca 2 | Enabled | Enabled | Manufacturer | | |
| Ca 3 | Enabled | Enabled | Dealer | | |
| Ca 4 | Enabled | Enabled | Parts Supplier | | |
| Ca 5 | Enabled | Enabled | Rental Agency | | {close oversize brace} Industry |
| Ca 6-9 | Enabled | Enabled | Reserved | | |
| Ca 10 | Escrow | | | | |
| | | | | | {close oversize brace} Type |
| Ca 11-91 | Enabled | Reserved | Enabled | | |
| Ca 92 | Enabled | Disabled | | | |
| Ca 93-96 | Disabled | | | | |
| Cb 1-59 | Enabled | Enabled | Reserved | | |
| Cb 60 | Enabled | Disabled | | | |
| Cb 61-64 | Disabled | | | | |
| SCa-1: | Enabled | Enabled | Enabled | | |
| SCa16 | | | | | |
| SCb-1 | Enabled | Registry ID | | | |
| SCb-1 | Enabled | Enabled | Enterprise Id (Primary) | | |
| SCb-2 | Enabled | Enabled | Enterprise Id (Secondary) | | |
| SCb-2: | Enabled | Enabled | Reserved | | |
| SCb-16 | | | | | |

A Basis for Insurable Systems
Introduction to Auditable Protection

Potential insurers of public key infrastructures (PKI's) should reconsider what they know about security risks, as value-laden Business-to-Business exchanges evolve into E-Commerce transactions. Electronic transactions that are worth insuring will draw well-planned attacks unlike anything now making press. An entire class of hostile activity by organized professionals becomes economically feasible once payoffs exceed hacker ego boosts, political statements and a few hundred dollars lost at an on-line auction. Dependence on the security behavior of platforms that underlie today's PM products represents a massive risk once real money becomes the motive for attack.

A PKI uses cryptography to protect the integrity and secrecy of communications as well as to authenticate the identity of remote parties. However, these mechanisms entirely fail if their underlying platforms are subverted. Adding crypto hardware can move (or even exacerbate) the problem, but it does not solve the problem. Given that computer security is a chain that is only as strong as its weakest link, how resilient are computer platforms to subversion?

Methods Depend on Motives

Information technology professionals get only half the story, even from their own industry press. Today's reporting on security risks mostly covers frontal attacks that exploit either poor system administration or the latest hole that is not yet patched. Frontal attacks are inexpensive to mount, and akin to a mugger in a dark alley not knowing if his next victim has any money or worse, a gun. A professional seeking big money is not likely to use such methods given the unknown payoff and chances of being caught. Builders of viruses take a little less direct approach by planting hostile code, but are still amateurs with limited motives and means. A well-planned, carefully executed hostile attack is more expensive, requiring investment, research and time. These attacks do not get press because they are not mounted against low value assets, and when big money disappears neither the thief nor the victim rush to announce it.

Big money is a big motive, as is information that can be sold for big money. From the time of Caesar's legions, valuable military information has been protected in transmission by encryption. More recently, banks recognized the value of encrypting their monetary transmissions to protect their integrity. Beginning decades ago, the military began to implement protections for information within computer systems and networks. When assessing the security of those early systems, analysts succeed in their attacks by first exploiting security flaws and using these to insert malicious software that in turn gave them continuing illicit access to systems the vendors claimed were secure. It was 30 years ago that military computer systems were found vulnerable to well planned attacks using the same techniques now emerging against commercial system with value worth insuring. The good news is that the military developed and perfected technology to counter such deliberate, hostile attacks, and this technology is now available to protect commercial systems. However, do not look for this technology in the next versions of Windows, NT or UNIX. Look to systems with auditable security.

Methods of a Professional

The well-motivated attacker will invest and plan. A system identical to the target will be obtained so it can be prodded and probed without worrying about firewalls or intrusion detection systems. Attack methods will be tested and perfected. The actual attack will take one of three forms. Insurers must protect against all three, presented below in order of difficulty of both mounting and countering:
Find and exploit a flaw in the system through a direct attack. Flaws found by suitably motivated professionals are typically more subtle than those reported by emergency response teams. You cannot test to see if a system has flaws. Because subtle flaws may be exploited using an esoteric and complex set of circumstances, the likelihood of discovering most, let alone all, of them through testing is infinitesimally small.
Insert malicious software called a “Trojan Horse” into the system applications to compromise information. This is essentially what the more sophisticated recent viruses do. Because an authorized user may be tricked into introducing the Trojan Horse into the system, this type of attack eliminates the attacker's exposure to discovery.
Insert a “trap door” into the system to avoid the system's normal control features. Early military penetration testing and repeated testing over the years demonstrated the practicality and ease of inserting a small trap door so undetectable that the manufacture's personnel could not find the clandestine code, even when they were told it existed and how it worked. Trap doors invoked by complex triggering mechanisms (e.g., a secret key) are effectively impossible to detect through testing.

Protection from direct attacks requires designs without flaws. The threat of malicious software requires that internal partitions be established to control information and limit damage from Trojan Horses. Protection from trap doors requires further safeguards. One key approach is to implement systematic controls over the development process to limit an individual's ability to insert a trap door, similar to the procedural controls used in the operation of banks. But that is not enough. You also need a method to instill an ability to conduct an audit that there are no trap doors, including a systematic mapping of each source line to a specification proven to be secure. This is analogous to building an accounting system that is auditable.

An Insurable Solution

Products are available to stop professional attacks. These insurable systems are designed and built from the very start to have the necessary properties:
Designed to have no exploitable security flaws
Enforce security policies on information flow, bounding the damage of malicious software (e.g., Trojan Horses).
Built to be subject to third party inspection and analysis to confirm the protections are correct, complete and do nothing more than advertised (i.e., no trap doors).

These observations are based on decades of experience with threats from well-motivated attackers, and the solutions that work to counter these threats.

Insurable products must be demonstrably resilient to penetration and subversion, with assurances beyond mere vendor assertion. These products must be built to technically proven criteria that ensure the result can be subjected to inspection and analysis. Fortunately, the challenge is not new. Criteria exist that have been successfully applied over the past 15 years to numerous systems that protect sensitive military and diplomatic secrets. Governments of the U.S., Europe, and others offer evaluations to these criteria, providing an objective metric of a product's security properties and associated assurance.

Well-planned attacks by professionals can be stopped, but it takes high assurance technology that results in systems in which the security properties of the delivered product are objectively auditable by independent third parties.

Technical Foundations for Protection

The remainder of this paper describes technical foundations for insurable computer platforms and networks, herein referred to as “insurable systems”. A determination that a system is “insurable” is, of course, a business decision. The purpose of this technical note is to describe technology that allows an objective third party to reach firm conclusions about the protection mechanisms of a system. This third party evaluation can then serve as a responsible basis by which an insurer can obtain sufficient confidence to insure these protection mechanisms against failure—even in the face of hostile attack.

A insurable system must be both resilient to malicious software and free of exploitable security flaws. Such properties are not testable, but they can be confirmed by inspection and analysis of the security protection mechanisms of the system. To be subject to analysis and inspection, the protection mechanism of a system must be relatively small, conceptually simple and have a clear and complete specification. Furthermore, the system must be explicitly built to be subject to inspection and analysis, with architectural properties that are categorically missing from most commercial software. The security properties of insurable systems must be auditable, viz., there must be evidence supporting an after-the-fact security assessment of a delivered system. Proven standards exist that provide criteria for building such systems, with a number of real world examples. Independent third party evaluations are available for systems that are built to these criteria to confirm that the system completely and correctly meets its security specification—and does nothing more (e.g., contains no trap doors).

If a system demonstrably incorporates suitable technology, then there can be a basis for assuming risk. However, it is not practical for insuring agents themselves to evaluate such technology. On the other hand, objective third parties capable of performing such evaluations do not insure systems. What is needed is a means by which insurers can depend upon evaluations conducted by qualified objective third parties.

High value business processes and information requires computer platforms and networks that are evaluatable by third parties, thereby providing the basis for customers and users of the platforms to responsibly self-insure or possibly separately obtain insurance against failure of protection mechanisms.

Risks Require High Assurance

The primary risks addressed by a insurable system are:
1) Security flaws exploitable by attackers even though a system may have been built in a controlled environment and is considered free of malicious software;
2) Malicious software (e.g., a Trojan Horse) designed by capable and motivated professionals to exploit authorizations of unsuspecting users and administrators; and,
3) Trap doors allowing attackers to render ineffective the system's normal control features.

An insurable system needs a high assurance that its security properties are correct, complete and allow for nothing beyond their specification. This must be the case right out of the box, and cannot be “tweaked” after the first round of bug reports, which could well be accompanied by the loss of hundreds of millions of dollars. By “high assurance” we mean that technical statements about the system security properties have a theoretically sound, and logically complete, technical foundation. By implication, the statement that a system is “insurable” has a precise engineering definition, and the correctness of the statement may be objectively demonstrated by third parties. Moreover, the demonstration by third parties can occur after-the-fact because the security properties are auditable, viz., evidence exists to support a security assessment of a delivered system.

Simple Enough to Analyze

Given the well-known scientific fact that interface (e.g., black box) testing can only demonstrate the existence, but not the absence of security flaws, assurance must be confirmed through inspection and analysis. Therefore, the ability to insure a system depends greatly on the ability of an objective third party to inspect and analyze the system's security design and implementation. The challenge however, is that most operating systems (e.g., NT or UNIX) are too large and complex to meaningfully inspect. Indeed, such systems have no definition of correctness—that is, no clear specification of exactly how the software should and should not behave in order to adequately protect information. To be subject to analysis and inspection, the protection mechanism of a system must be relatively small, conceptually simple and have a clear and complete specification.

There must exist a security policy that possesses properties such that whether a given system enforces those properties can be determined with a high degree of assurance. By “security policy,” we mean the properties of the system that are being insured. Given a well-defined security policy, and a security perimeter to protect the mechanisms that enforce the policy, then there is a basis for making assumptions about the behavior of functions outside the security perimeter. Viewed another way, if an operating system does not manage the hardware as advertised, it is difficult to conclude that applications will work as advertised.

If a system is “properly constructed,” it is possible to insure against the failure of the system to enforce its security policy. What is meant by “properly constructed” is the focus of this technical note and will be discussed further below. A key factor is the protection mechanism must be simple enough to be analyzed.

Which Properties can be Insured?

Not all system properties are good candidates to be a well-defined security policy. Some properties, such as “reliability,” “safety” or “availability” cannot be dependably determined, and though they are nice properties to have, they are not considered here as being insurable. System properties such as confidentiality and integrity are insurable because they can be precisely defined, global and persistent. The characteristic ability to specify properties for a particular system in a manner that allows one to positively know that they are enforced is known in the jargon of computer science as “being computable”. Some properties, e.g., “availability,” are simply known to be non-computable.

In addition to being non-computable, properties such as “availability” frequently do not represent the primary opportunities for major losses. For example, failed hardware can be replaced, and in the case of denial of service attacks, it is typically known when they occur, and they are typically recoverable and do not involve permanent loss. This is in contrast to attacks against information confidentiality or integrity where information is disclosed or modified as part of a concerted attack: it is typically not known that the attack has succeeded, and the adverse impact persists long after the attack. For example, the forging of PKI certificates used for value-laden transactions may not be discovered until the money is gone.

The security properties considered herein as “insurable” are a set of behaviors at the security perimeter. It must be possible to construct a formal model of these properties. For example, there is a proven and well-used model of an access control policy known as the Bell-LaPadula model. The model includes active subjects and passive objects, each of which have an associated label that reflects the authorizations of the subject and the sensitivity of the object. Using mathematics and set theory, the model precisely defines the notion of a secure state, fundamental modes of access, and the rules for granting subjects specific modes of access to objects based on their associated labels. Finally, a theorem is proven to demonstrate that the rules are security-preserving operations, so that the application of any sequence of the rules to a system that is in a secure state will result in the system entering a new state that is also secure. This theorem is known as the Basic Security Theorem.

It must be possible to map the security behavior at the security perimeter to the formal model. If it can be shown that all operations at the security perimeter correspond to rules in the model, then by a transitive argument the system can be considered secure with respect to the security policy. In other words, the system can be shown to maintain the properties for which it is being insured over all operations at the security perimeter. The hardware and software of a relatively simple protection mechanism that enforces a well-defined access control policy and protects itself within a security perimeter is called a security kernel.

Consider a network server that has such a security kernel. It would be possible for VARs or OEMs to construct applications that leverage the insurable properties for a variety of applications. The power of the insurable system is that it maintains a secure state (relative to the policy) independent of the applications built upon it.

Consider also a network client (e.g., a Windows workstation) that contains such a security kernel running on a plug-in processor board having a network interface. The security kernel could then enforce a security policy for data sent and received over the network—independent of the behavior of either the applications or the workstation OS (e.g., Windows). Furthermore, if the kernel controls the keyboard and display immediately subsequent to booting, then a variety of authentication and identification mechanisms can be implemented within protected domains established by the kernel. With such an underlying base, it is relatively straight forward to construct a system that maintains user accountability over the course of a workstation session. The critical factor is that these security properties will be maintained in the face of malicious software in either the application or the workstation OS. In this example, the power of insurable systems allows a secure session (e.g., over the Internet) with a completely insecure operating system, such as Windows.

Insurable Internet Applications

Two classes of applications are considered below. The first class entirely derives their security properties from the underlying security kernel. The second class extends the kernel's security perimeter to perform specific supporting security policy functions.

The first class of application makes use of the security kernel's underlying controls Wand does not require any added security functions. However, building such applications on a insurable platform is not simply a matter of porting software to yet another operating system. The application must be designed to take advantage of the underlying platform functions. An illustrative example of such an application is a relational database management system (RDBMS). Research into the question of secure databases, (performed about a decade ago by Gemini Computers, Inc. and SRI as part of the SeaViews project), yielded an understanding of how an entire security policy can be enforced by the underlying platform, with no security dependencies within the RDBMS itself. The Trusted Oracle RDBMS, for example, is designed to have two “modes” of security: one in which the RDBMS itself enforces the policy, and the other in which the RDBMS depends on the underlying operating system.

An example Internet application that derives its security functions from the underlying platform is a high assurance web server. Commercial web servers have recurring problems of intruders modifying content, requiring many days of down-time while content and scripts are rebuilt. Using a high assurance web server, authoritative copies of content and programs are not modifiable by intruders. Therefore, while the server could be disrupted in a variety of ways (e.g., by intruders), a simple restart of the platform restores it to a correct state. The security administrator of such a system can configure the system such that processes running on behalf of the system console have a high integrity (i.e., the ability to modify the content and scripts), and processes running on behalf of clients on the network have a relatively low integrity. This allows a Web-Master to define and modify content without having any impact on the enforcement of the security policy. It is therefore possible to insure that whatever decisions are made by the Security Administrator are in fact enforced.

Another example of an Internet application in which the security policy is enforced by the underlying platform is a Directory Service. Directory Services implementations on a insurable platform must address very much the same issues as those that were addressed when solving the RDBMS problem. It is not expected that any new techniques will be required to support a basic set of directory services.

Extending the Security Perimeter

The second class of Internet applications requires an expansion of the security perimeter to include additional, precisely defined, security functions. Most applications or so called “appliances” that provide security related services will fall into this class. For example, a Virtual Private Network (VPN) must provide encryption of communications between a node in a network and a server. Here, security functions that must be enforced include the ability to read transmissions arriving at the server, and send information in a way that cannot be read during transmission. The most common mechanism for achieving this is IPSEC, which includes integrity and confidentiality. This extension of the security perimeter requires insuring against failure of an additional part of the system, namely the keys must be protected and the correct cryptographic algorithm must be invoked The keys used to encrypt and decrypt information must be protected against modification and disclosure. Typically, users and application processes should not have access to the keys. If the application had access to the key, there would be no effective way of protecting the key. The security perimeter must be extended to include key management functions that can be used by untrusted processes to encrypt and decrypt information by identifying keys without exposing the keys.

Also, there must be no way to send information unless it is encrypted using the proper algorithm and key. And the integrity of received information must be confirmed through use of the proper algorithm and key.

Another example Internet application requiring an expansion of the security perimeter is a Certificate Authority. Certificates must be generated by functions within the security perimeter. The certificate must be signed using an appropriate key, and if the certificate is to have a high quality, the fields within the certificate must be confirmed by a user through a trusted path.

These extensions to the security perimeter can be done in one of two ways. The brute force way is to modify the security kernel, but this requires careful re-examination of the entire new kernel. However, some kernels support “TCB subsets” that allow extending the perimeter with no change to the kernel. This is a far more efficient way to make the expansion.

Visible Design

Assuming we have a security kernel (and possibly additions to the security perimeter), we still must be able to inspect and analyze its design and implementation. This, however, is not simply a matter of producing source code and documentation—no matter how well commented and complete. The system must be specifically designed from the very start to be inspectable and subject to complete analysis. Methods that pass for “good software engineering” are not sufficient. It is not enough to gather some amount of empirical evidence that the system might be secure. We need much more than an informed and experienced judgment that most of the usual flaws encountered in the past in the designs of purportedly secure systems have apparently been avoided in the system under review. Indeed, the greatest risks to a system can occur when it is inspected and found free of flaws, for that is when managers trust systems despite a lack of technical foundations.

Proven methods exist for building computer systems and networks such that they can be subjected to such a careful inspection and analysis. These methods, though technically complex and demanding, have been reduced to practice (at least for skilled practitioners). What makes such an undertaking possible is that the theoretical concepts underlying the technology are relatively easy to understand, although very challenging to build in a practical way.

Design Process and After-the-fact Security Assessment

Building an insurable computer system requires both a sound design process and an ability to perform a security assessment to confirm that a delivered system has the desired security properties.

In order for a design and development to result in technology that provides a basis for insuring it must include at least:
An information security policy
A formal mathematical model of the security policy
A formal top level specification (FTLS), having a precise syntax and well defined semantics, that accurately and completely describes the security perimeter in terms of exceptions, error messages and effects
A design that uses a complete, conceptually simple protection mechanism with precisely defined semantics
An implementation that makes effective use of abstraction, layering and information hiding.

For a system's security to be “auditable,” the development process provides evidence necessary for an effective after-the-fact security assessment including at least:
A formal proof that the FTLS implements the security policy model. Such a proof can be repeated by third parties. This is in contrast to a descriptive top level specification, which would require third party participation in the design process to conclude the specification implements the model.
A mapping of all source code within the security perimeter to the FTLS. It is the design process, particularly the production of a formal specification and a layered implementation that incorporates information hiding that makes this possible. This provides evidence that the implementation is free errors; including trap doors.
A demonstration that the implementation is consistent with the FTLS
Functional testing in which the advertised features of a system are tested for correct operation, and it is confirmed
An information flow analysis of the FTLS
Configuration management supporting a reliable rebuilding of the security mechanisms. This requires configuration management for hardware, software, firmware, formal specifications and all tools used to rebuild the system. There must exist a protected master copy of all material used to generate the TCB.
Trusted distribution allowing confirmation that a given instance of the security mechanisms matches an authoritative reference point
   A Standard Criteria

Historically, various bodies including European and U.S. Governments have recognized the need for standard security criteria. The resulting evaluation criteria have been successfully used for over fifteen years to evaluate numerous commercial products, with results that are publicly available. Examples are the highest classes defined in the Trusted Computer System Evaluation Criteria (TCSEC), often referred to as the “Orange Book,” from the U.S. (which is the most widely recognized international standard in the world) and the Information Technology Security Evaluation Criteria (ITSEC) from Europe. The development of these criteria, particularly the TCSEC, was based on worked examples. These are widely known open standards specifically intended for the evaluation of commercial products.

Objective Evaluation

Assuming a system is built to a criteria such that it can be subject to complete analysis, the remaining step is for the insuring agent to confirm that the system does in fact completely and correctly enforce its specified security policy, and does nothing more. However, the evidence supporting such an evaluation is typically highly proprietary, and vendors may be reluctant to make the evidence available to every potential insuring agent. In addition, a single system may require multiple insuring agents for different customers. Given the combination of the proprietary nature of the design evidence necessary for such an analysis, the considerable technical expertise needed to conduct such an analysis, and the potential for multiple insuring agents to consider the same system, a great deal can be gained by an independent third party evaluation of the system. Independent commercial labs could not assume the liability associated with such technical determinations. Thus, it is not practical for insuring agents to perform evaluations, nor is it practical for independent commercial evaluators to insure systems. What is needed is an independent evaluator trusted by vendors to protect proprietary information, and trusted by insuring agents to offer a sound and unbiased evaluation. The government has a proven record of protecting vendor proprietary information, and is the best candidate for performing independent, objective evaluations that insuring agents can depend upon. In fact, all major evaluations today are under the auspices of Governments.

Building PM Applications on Insurable Platforms

The single most important point to be made here is that the hosting of applications on insurable platforms is more than just a port. Applications do not inherit security by running on high assurance platforms. Applications systems must be restructured to leverage the security properties of the underlying platform. Significant effort is required to separate the security critical from the non-security critical functions. Also, critical design choices may impact the resulting system performance, particularly when managing resources (e.g., processes and memory) having multiple security levels.

1. A method for finalizing an electronic fund transfer that is matched to an invoice for payment to be made from a first party having a financial account at a first agent to a second party having a financial account at a second agent using a network transfer system that is in electronic communication with the first party, the second party, the first agent and the second agent, the method comprising:
generating at the first party a document which authorizes the payment of the invoice;
signing the document using a first digital certificate in accordance with a certificate authority in communication with the transfer network system;
sending the signed digital document from the first party to the network transfer system;
authenticating via the certificate authority the authority of the signer of the signed document to assent to payment of the invoice;
storing a copy of the signed digital document in a database associated with the transfer network system;
sending a payment authorization request from the network transfer system to the first party;
signing the payment authorization request using a second digital certificate in accordance with the procedure of the certificate authority;
sending the signed payment authorization request from the first party to the network transfer system electronically;
authenticating via the certificate authority the authority of the signer of the signed payment authorization request to assent to the transfer of funds from the financial account of the first party at the first agent to the financial account of the second party at the second agent;
storing a copy of the signed payment authorization request in the database associated with the transfer network system;
sending a copy of the signed payment authorization request to the first agent;
creating an electronic payment instruction verifying the transfer of finds out of the financial account of the first party at the first agent;
sending this electronic payment instruction from the first agent to the transfer network system;
forwarding the electronic payment instruction to the second agent;
creating an electronic payment receipt verifying the transfer of funds into the financial account of the second party at the second agent; and
sending the electronic payment receipt from the second agent to the transfer network system.

2. A secure messaging system for supporting financial transactions with finality between a first client having an account at a first financial institution and a second client having an account at a second financial institution, the secure messaging system comprising:
a transfer network system comprising a messaging server configured to send and receive messages from a communications medium and further comprising an audit database;
a first client system connected to the transfer network system via the communications medium, the first client system being associated with the first client;
a second client system connected to the transfer network system via the communications medium, the second client system being associated with the second client;
a validation server in communication with the transfer network system, the validation server configured to provide authentication of the identity of at least one individual user of the first client having authority to assent to the payment of funds from an account of the first client to an account of the second client,
a first financial institution client system connected to the transfer network system via the communications medium and associated with a first financial institution, the first financial institution having an account holding funds of the first client;
a second financial institution client system connected to the transfer network system via the communications medium and associated with a second financial institution, the second financial institution having an account holding funds of the second client.

3. A handshaking system for secure message routing, comprising:
sending a digitally signed message and first authentication certificate from a first party to a network transfer system;
verifying a digital signature of said digitally signed message and validating said first authentication certificate;
sending a primary authorization request from said network transfer system to said first party;
sending a signed primary authorization response and second authentication certificate from said first party to said network transfer system;
verifying a digital signature of said signed primary authorization response and validating said second authentication certificate;
sending a first confirmation request to a second party;
sending a signed confirmation response and third authentication certificate from said second party to said network transfer system;
verifying a digital signature of said signed confirmation response and validating said third authentication certificate;
sending a secondary authorization request to said second party;
sending a signed secondary authorization response and fourth authentication certificate from said second party to said network transfer system; and
verifying a digital signature of said signed secondary authorization response and validating said fourth authentication certificate.

4. The method of claim 1, further comprising sending a first acknowledgement to said first party when said first confirmation request is sent to said second party.

5. The method of claim 1, further comprising sending a second conformation request to said first party upon verifying said digital signature of said signed secondary authorization response.

6. The method of claim 1, further comprising sending a second conformation request to said second party upon verifying said digital signature of said signed secondary authorization response.

7. The method of claim 1, further comprising sending a second conformation request to said first party and a third confirmation request to said first party upon verifying said digital signature of said signed secondary authorization response.

8. The method of claim 1, further comprising logging each message received from said first party and from said second party in an audit file.

9. The method of claim 1, further comprising logon of one or more workstations used by said first party to send messages to said Network Transfer System, where said logon includes validation of said logon using an out-of-band channel.

10. The method of claim 1, further comprising logon of one or more workstations used by said second party to send messages to said Network Transfer System, where said logon includes validation of said logon using an out-of-band channel.

11. The method of claim 1, wherein said first party comprises a first user and a second user, wherein said first authentication certificate is personal to said first user and said second authentication certificate is personal to said second user.

12. The method of claim 1, wherein said second party comprises a first user and a second user, wherein said third authentication certificate is personal to said first user and said fourth authentication certificate is personal to said second user.

13. The method of claim 1, wherein said first party receives said first authentication certificate when said first party performs a login to a computer that has performed a logon to the Network Transfer System.

14. The method of claim 13, wherein said first authentication certificate is received in when said first party performs a login to the Network Transfer System.

15. The method of claim 1, further comprising:
logging each message received from said first party and from said second party in a system audit file maintained by said Network Transfer System;
logging each message received from said Network Transfer System in a workstation audit file maintained by a workstation of said first party; and
detecting security breaches by comparing records in said system audit file with records in said workstation audit file.

16. The method of claim 1, further comprising logon of a workstations used by said first party to send messages to said Network Transfer System, where said logon includes validation of said logon using an out-of-band channel.

17. The method of claim 16, wherein said logon creates a secure VPN-like connection between said workstation and said Network Transfer System.

18. The method of claim 16, wherein said secure VPN-like connection provides one or more secure messaging services.

19. The method of claim 18, wherein said one or more secure messaging services includes instant messaging.

20. The method of claim 18, wherein said one or more secure messaging services includes document transfer.

21. The method of claim 18, wherein said one or more secure messaging services includes transfer of forms.

22. The method of claim 21, wherein said one or more secure messaging services includes transfer of forms, and wherein said Network Transfer System verifies data in fields of said forms.

23. A method for secure message transmission, comprising:
performing a workstation logon to a network transfer system using an out-of-band channel to validate said workstation;
performing a user login a said workstation, said user receiving a credential at login, said credential provided by said network transfer system;
create a message to be sent;
create a message audit file;
send said message audit file to said network transfer system;
attach said credential to an attribute field of a digital signature and digitally sign and encrypt said message to create an encrypted message;
send said encrypted message to said network transfer system as a received message;
compare said message audit file and said received message to validate said received message;
create a validation response; and
send said validation response to said workstation.

24. A method for restructuring authenticity and authorizations used for control of electronic processes and electronic message handling, comprising;
identifying a digital certificate corresponding to a digital signature, said digital certificate comprising at least one signature attribute;
locating an attribute identity component of said signature attribute;
comparing said attribute identity component with a certificate distinguished name;
comparing said attribute identity component with a family of certificate attributes;
extracting named critical attribute values corresponding to said distinguished name and critical identity names and attributes
recombining said named critical attribute ordered according to associated identities of said named critical attributes to produce recombined attributes;
signing said recombined attributes to produce a recombination signature; and
sending and reserving said recombination of attributes for additional authorizations

25. The method of claim 24, further comprising attributing an attribute to an individual user.

26. A method for electronic message handling, comprising:
identifying a digital certificate corresponding to a digital signature having correspondence, said digital certificate comprising at least one signature attribute;
identifying a digital certificate Family Distinguished Name corresponding to a digital signature having correspondence with said digital certificate and said digital signature, said digital certificate comprising at least one signature attribute;
corresponding attribute components belonging to the signature attribute with hierarchical attribute components belong to said digital certificate Family Distinguished Name as represented in a hierarchical taxonomy;
constraining electronic Business Processes and electronic controls associated with said Family Business Process and Family electronic controls to the electronic Business Processes and electronic controls of the individual
associating and constraining Business Process policies of the Family to controls on the individual.

27. The method of claim 26, further comprising attributing an audit trail of Business Processes to said individual.

28. The method of claim 26, further comprising locating an attribute identity component of said signature attribute.

29. A method for abuse management in a secure messaging system, comprising:
real-time auditing of messages sent between a network transfer system and a user, comprising:
assigning a quality-of-logon attribute to a digital signature used by a user workstation based on a security level of said user workstation;
validating portions of a digital signature associated with said messages;
authenticating a user certificate attached to said messages; and
checking fields of said message to detect modification of fixed fields;
and audit trail auditing of said messages by at least comparing message audit files maintained by a user workstation with audit files maintained by said network transfer system to identify discrepancies in said audit file.

30. The method of claim 29, further comprising: using an out-of-band channel to validate a said user workstation each time said workstation performs a logon to the network transfer system.

31. The method of claim 29, further comprising: assigning said user certificate to said user each time said user performs a login to the network transfer system.

32. A method for establishing and maintaining an secure message transfer system, comprising:
using digitally-signed software to run on the system;
disallowing systems to perform transactions beyond their level of trust;
disallowing users to perform actions that exceed their authority;
securing messages by encryption;
comparing messages with audit records;
comparing sent messages with received messages;
repairing breaches in integrity;
halting forward progress when integrity has been breached;
alerting users and administrators to integrity breaches; and
generating profiles from previous breaches for detection and protection from future breaches.

33. The method of claim 32, further comprising establishing level of trust for components of the system.

34. The method of claim 32, further comprising establishing the level of trust in a client system based on the level of trust of the hardware, security implementation, and policies and procedures of the client.

35. A Network Transfer System, comprising:
a Gateway configured to store and forward messages between one or more remote clients or servers and the Network Transfer System;
a Validation Server configured to authenticate users that are sending information using the Network Transfer System;
a Workflow Engine configured to script activity and provide exchange of internal messages between components of the Network Transfer System; and
an End-to-End Transaction Manager configured to manage secure message routing between users of the Network Transaction System.

36. The Network Transfer System of claim 35, further comprising an Abuse Server configured to detect abuse of the Network Transfer.

37. The Network Transfer System of claim 35, further comprising a Message Server configured to provide instant messaging authorized participants through the Network Transfer System according to a level of authority for each participant.

38. The Network Transfer System of claim 35, further comprising an Audit Server configured to audit data transactions in the Network Transfer System.
